(19) United States
(12) Patent Application Publication
(10) Pub. No.: US 2022/0005253 A1
(43) Pub. Date: Jan. 6, 2022

(54) Apparatus utility, input (image sensor GPU integrates - inferential reasoning metric - pixel value as a spherical, infinity (dp) infimum, making the sensor GPU source input output values, function, alternatively in a certain way related to) output

(71) Applicant: Rennie Roy Domshy, Mayerthorpe (CA)

(72) Inventor: Rennie Roy Domshy, Mayerthorpe (CA)

(21) Appl. No.: 16/946,725

(22) Filed: Jul. 2, 2020

(51) Int. Cl. G06T 15/00; G06F 11/36; G06F 8/30

(52) U.S. Cl. CPC G06T 15/005; G06F 8/315; G06F 11/3688; G06F 11/3692

(57) ABSTRACT

Preamble—(embodiment)—[implies—an “apparatus utility” method (Process) software—source input to an Image Sensor and/or Graphic Processor source input-output values and/or any ‘source’, of an induced plane used by methods, apparatus and systems], of an application comprising instructions for generating the bounding nodes of eight children centered with the unit-utility-47 ⋅, of/as the holomorphic-100 ⋅, dimensional pixel, ( [symbol] )-37 ⋅, of methods, means and claims, comprising the steps of a unit-utility code segment and/or segments apparatus for processing an image. The fore-mention sets forth the series of acts/steps performing this desired function in accomplishing the intended result of the, —

The method (Process) software—with series of acts/steps performing this desired function in accomplishing the intended result of, the method as set forth . . . ,
what is Claimed (1), #⋅15 ⋅ unit-utility, (Source Input). An apparatus utility,
   1; wherein; an application comprising instructions to a method and means apparatus novice unit-utility-function-110 ⋅; (Input), computing of predictive and adaptive techniques of an “information processing system apparatus”, processing information and performing calculations of the programme to perform sequences of mathematical and logical operations, the method comprising of receiving a list of code segments, (unit-utilities), of an application comprising instructions for, —newPlane-97 ⋅ as, display, layer, dpixel value-94 ⋅, geometry of 2-dimensional figures inherent with spatiotemporal-81 ⋅, coherence-82 ⋅, property having dimensions/time/mass/cognitive content.
   2; where, comprising the steps of—in-part; the FUNCTION methods, what differs is the executable novice architectures and methods for dpix-utility Driver-112 ⋅,
      1 . . . where, further comprising of a unit-utilities-16 ⋅, of the dpix-utility Driver-112 ⋅; herein the pleadable OS for the assets unit-utility-function-110 ⋅,
   3; wherein; facilitating the method processing of the image acquired comprising the first part of FIG. 1 illustration (Input), implemented at least in part by a computing device, an application comprising instructions to a method and means apparatus novice unit-utility-function-110 ⋅; (Input).

The method (Process) software—with series of acts/steps performing this desired function in accomplishing the intended result of, the method as set forth . . . ,
what is Claimed (2), #⋅146 ⋅ unit-utility, (Source Output). An apparatus utility,
   1; where, comprising the steps of in-part, bounding nodes of eight children centered with the unit-utility-47 ⋅,
   2; wherein; facilitating the method processing of the image acquired, the method as set forth in Claimed (1), #⋅15 ⋅ unit-utility, further comprising the method as set forth in Claimed (2), #⋅146 ⋅ unit-utility, second part of FIG. 2 illustration (Input), implemented at least in part by a computing device, an application comprising instructions to a method and means unit-utility-function-110 ⋅; (Output).
   3; wherein; in a preferred embodiment, computing of predictive and adaptive techniques of an “information processing system apparatus”, processing information and performing calculations of the programme to perform sequences of mathematical and logical operations, the method comprising of receiving a list of code segments, of an application comprising instructions for: —generating the bounding nodes of eight children centered with the unit-utility-47 ⋅.

The method (Process) software—with series of acts/steps performing this desired function in accomplishing the intended result of, the method as set forth . . . ,
what is Claimed (3), #⋅149 ⋅ unit-utility, (analogous Output). An apparatus utility,
   1; wherein; facilitating the method processing of the image acquired, the method as set forth in Claimed (2), #⋅146 ⋅ unit-utility, generating the bounding nodes of eight children centered with the unit-utility-47 ⋅, and further comprising the method as set forth in Claimed (3), #⋅149 ⋅ unit-utility, the third part of FIG. 3 illustration (Output), implemented at least in part by a computing device, an application comprising instructions to a method and means unit-utility-function-110 ⋅, comprising of receiving a list of code segments, for outputting the holomorphic-100 ⋅, dimensional pixel.
   2; wherein; implement graphic Driver-116 ⋅, display-output, the dimensional pixel in accordance with one or more embodiments of the invention.

### DESCRIPTION—BACKGROUND OF INVENTION

Preamble—(embodiment)—[implies—an “apparatus utility” method (Process) software—a source input to an Image Sensor and/or Graphic Processor source input-output values and/or any ‘source’, of an induced plane used by methods, apparatus and systems], of an application comprising instructions for generating the bounding nodes of eight children centered with the unit-utility-47 ⋅, of/as the holomorphic-100 ⋅, dimensional pixel, ( [symbol] )-37 ⋅, of methods, means and claims, comprising the steps of a unit-utility code segment and/or segments apparatus for processing an image. The fore-mention sets forth the series of acts/steps performing this desired function in accomplishing the intended result of the,—

The method (Process) software—with series of acts/steps performing this desired function in accomplishing the intended result of, the method as set forth . . . ,
what is Claimed (1), #⋅15 ⋅ unit-utility, (Source Input). An apparatus utility,
   1; wherein; an application comprising instructions to a method and means apparatus novice unit-utility-function-110 ⋅; (Input), computing of predictive and adaptive techniques of an “information processing system apparatus”, processing information and performing calculations of the programme to perform sequences of mathematical and logical operations, the method comprising of receiving a list of code segments, (unit-utilities), of an application comprising instructions for, —newPlane-97 ⋅ as, display, layer, dpixel value-94 ⋅, geometry of 2-dimensional figures inherent with spatiotemporal-81 ⋅, coherence-82 ⋅, property having dimensions/time/mass/cognitive content.
   2; where, comprising the steps of—in-part; the FUNCTION methods, what differs is the executable novice architectures and methods for dpix-utility Driver-112 ⋅,
      1 . . . where, further comprising of a unit-utilities-16 ⋅, of the dpix-utility Driver-112 ⋅; herein the pleadable OS for the assets unit-utility-function-110 ⋅,
   3; wherein; facilitating the method processing of the image acquired comprising the first part of FIG. 1 illustration (Input), implemented at least in part by a computing device, an application comprising instructions to a method and means apparatus novice unit-utility-function-110 ⋅; (Input).

The method (Process) software—with series of acts/steps performing this desired function in accomplishing the intended result of, the method as set forth . . . ,
what is Claimed (2), #⋅146 ⋅ unit-utility, (Source Output). An apparatus utility,
   1; where, comprising the steps of in-part, bounding nodes of eight children centered with the unit-utility-47 ⋅,
   2; wherein; facilitating the method processing of the image acquired, the method as set forth in Claimed (1), #⋅15 ⋅ unit-utility, further comprising the method as set forth in Claimed (2), #⋅146 ⋅ unit-utility, second part of FIG. 2 illustration (Input), implemented at least in part by a computing device, an application comprising instructions to a method and means unit-utility-function-110 ⋅; (Output).
   3; wherein; in a preferred embodiment, computing of predictive and adaptive techniques of an “information processing system apparatus”, processing information and performing calculations of the programme to perform sequences of mathematical and logical operations, the method comprising of receiving a list of code segments, of an application comprising instructions for: —generating the bounding nodes of eight children centered with the unit-utility-47 ⋅.

The method (Process) software—with series of acts/steps performing this desired function in accomplishing the intended result of, the method as set forth . . . ,
what is Claimed (3), #⋅149 ⋅ unit-utility, (analogous Output). An apparatus utility,
   1; wherein; facilitating the method processing of the image acquired, the method as set forth in Claimed (2), #⋅146 ⋅ unit-utility, generating the bounding nodes of eight children centered with the unit-utility-47 ⋅, and further comprising the method as set forth in Claimed (3), #⋅149 ⋅ unit-utility, the third part of FIG. 3 illustration (Output), implemented at least in part by a computing device, an application comprising instructions to a method and means unit-utility-function-110 ⋅, comprising of receiving a list of code segments, for outputting the holomorphic-100 ⋅, dimensional pixel.
   2; wherein; implement graphic Driver-116 ⋅, display-output, the dimensional pixel in accordance with one or more embodiments of the invention.

### FIELD OF THE INVENTION—BENEFIT

Where the referent apparatus unit-utility-function-110 ⋅ (Input) returns a still frame, (capture original-plane-121 ⋅) and impose an action of a real time step capture rate-optic-120 ⋅,
1; further comprising; composed using graphic dimensional values where the apparatus novice unit-utility takes of the pixel value^{ref}-94 ⋅ referent and returns a dpixel value-94 ⋅ outputting the dimensional pixel,
2; further comprising; in accordance with one or more embodiments of the invention, as, conditional expectation composition-72 ⋅,
3; further comprising; the Unit-utility of; [dpix-93 ⋅; dpixel-92 ⋅; dpixelive-92 ⋅; dspixel-92 ⋅]-[semantics-68 ⋅; phrase-71 ⋅; collectivity-73 ⋅],
4; further comprising; without the need of an added edit graphic program/app, thus
5; further comprising; the fore implied embodiment of the invention application unit-utility, to be issued displays “useful” as a formal requirement, having only the “mere scintilla” of usefulness required, thereof, as would be understood by one skilled in the art, distinctive and without equal to the dpix-93 ⋅, dpixel value-94 ⋅ of the capture original-plane-121 ⋅, with the assembly in accordance with the embodiment of the invention;
6; further where, by an experiment could be setup to evaluate filing for expedited examination of applications relating to green technology outputs, (funded carbon dioxide sequestration technologies and other emissions limiting tec), such as to take a microscope still frame, a (capture original-plane-121 ⋅) of carbon to test the values,
   1 . . . wherein further of the real/v/programmed, and impose an action to the same, of a real time step capture rate-optic-120 ⋅, composition-72 ⋅ using graphic dpix-93 ⋅ values where the apparatus novice unit-utility may be able to project the carbon outcome,
7; further where, where one or more conversance embodiments relating to green technology programs which will allow small entity research action affordable and theory probability development of mechanical hardware experiment more cost effective such as in
   1 . . . wherein further the field of scrubbers, converting CO2 into a solid state.

### RELATED APPLICATIONS

This patent application utility, (except as reference of the invention text embodiment for understanding human language technology and/or natural language information), claims no priority to, nor, bear no-claims of methods already commonly known . . . , . . . prior to;
1; upLoad-Driver-137 ⋅ (I/O port)—Run/driver/unit-utility/sensor/display/output, capture original-plane-121 ⋅—
2; components of the methods of interaction—making the image sensor output values function alternatively in a certain way related to “the viewing/display optic-133 ⋅”,
3; Note, after a polling query, for a device of the herein claim of the invention text embodiment, (this patent application utility), no acceptable polling querying was or could be found.

The apparatus novice unit-utility-function, here detailed in-part,
1; . . . bear no-claims of methods already commonly known;
   1 . . . wherein the expression, are best termed in the following;
      1 . . . CA (1) CA2478666C, 2018 Apr. 10 and Families Citing this family;
      2 . . . US (4) U.S. Pat. No. 8,411,151B2, EP (1) EP1493127A1,
      3 . . . AU (1) AU2003219906A1,
      4 . . . WO (1) WO2003085598A1
         where in-part as, in terms of, “as would be understood by one skilled in the art”,
1; further where; —the in-part as, CA2478666C, extrapolation; “(the software created by the software development kit; [an apparatus unit-utility-function-110 ⋅; “software created”, by the dpix-utility Driver-112 ⋅, “software development kit” ], and the main processor by any one of the software created by the software development kit and the reprogrammable coprocessor on the basis of a decision made by the reprogrammable coprocessor, the software created by the software development kit or the main processor regarding the acquired image for facilitating the processing of the image by the main processor)”.
2; the where; —the above means in-part;
   ‘software development kit’ term is the FUNCTION,
   1 . . . wherein further as the same with dpix-93 ⋅ apparatus unit-utility-function-110 ⋅ version,
3; however, the functions are different as each is described,
   but the ‘asset’, (hardware) is of similarity expression, with the FUNCTION.
4; where therefore; —what differs is the executable novice architectures and methods for dpix-utility Driver-112 ⋅—the assets; dpixelens-142 ⋅, and doppler-49 ⋅ in concert, embodiments.

### OBJECTS OF THE INVENTION—BRIEF SUMMARY OF THE INVENTION

The invention pertains to; an apparatus unit-utility-function-110 ⋅, dpix-utility Driver-112 ⋅ and in-part,—
1; wherein; implies—a source input instrument—making the image sensor output values/GPU source input output values, function, alternatively in a certain way related to “the viewing/display optic”,
2; wherein; where the scope of the appended claims and functional equivalents thereof,
   1 . . . where; would be understood by one skilled in the art, distinctive and without equal to dpix-93 ⋅ assembly in accordance with the embodiment of the invention process flow diagram of the herein implied drawings,
      1 . . . ; FIG. 1—(Input), what is Claimed (1); #⋅15 ⋅; (Source Input);
         . . . 1 . . . shows a diagram illustrating, an apparatus utility,
         . . . 1. here implies, doppler shift (Source Input) plane architecture, for,
   2 . . . ; FIG. 2—(Output), what is Claimed (2); #⋅146 ⋅; (Source Output); shows a diagram illustrating, an apparatus utility,
      . . . 1 . . . here implies, for bonding various element architectures in accordance with one or more embodiments of the invention, apparatus novice unit-utility, for,
   3 . . . ; FIG. 3—(Output); what is Claimed (3); #⋅149 ⋅; (analogous Output);
      . . . 1 . . . more specifically comprised herein; an apparatus utility,
         . . . 1. here implies, display optic, projector or print

In a preferred embodiment, (1), method of claim; #⋅15 ⋅, “(Source Input)” computing of predictive and adaptive techniques of an “information processing system apparatus”, processing information and performing calculations of the programme to perform sequences of mathematical and logical operations, the method comprising of receiving a list of code segments, (hereinafter also known as, unit-utilities-#) of an application comprising instructions for, —newPlane-97 ⋅ as, display, layer, dpixel value-94 ⋅, geometry of 2-dimensional figures inherent with spatiotemporal-81 ⋅, coherence-82 ⋅, property having dimensions/time/mass/cognitive content.
1; FIG. 1—(Source Input),
   1 . . . implies a capture device is used to/for light amplification by stimulated emission, to a pixel imaging sensor optic, to a focal-plane, by methods and means of an apparatus and systems including at least one hardware processor, at least one tangible storage medium (memory), and at least one input/output (I/O) interface of the ‘optical computing system’, and . . . ,

In a preferred embodiment, (2), method of claim; #⋅146 ⋅, (Source Output)” computing of predictive and adaptive techniques of an “information processing system apparatus”, processing information and performing calculations of the programme to perform sequences of mathematical and logical operations, the method comprising of receiving a list of code segments, (hereinafter also known as, unit-utilities-^{#}) of an application comprising instructions for: —generating the bounding nodes of eight children centered with the unit-utility-47 ⋅.
1; FIG. 2—(Source Output),
   1 . . . implies the capture device used to/for a pixel imaging sensor optic, to a focal-plane, is captured as an original-plane, and transposed to a layer-composed “new-Plane”, squared, which through using ‘method and means’ will preview,

In a preferred embodiment, (3), method of claim; #⋅149 ⋅; (analogous Output)” computing of predictive and adaptive techniques of an “information processing system apparatus”, processing information and performing calculations of the programme to perform sequences of mathematical and logical operations, the method comprising of receiving a list of code segments, (hereinafter also known as, unit-utilities-^{#}) of an application comprising instructions for: —generating the bounding nodes of eight children centered with the unit-utility-47 ⋅, inclusive the embodiment method of unit-utility-150 ⋅, facilitating the processing of the captured image as the holomorphic-100 ⋅, dimensional pixel.
1; FIG. 3—(analogous Output),
   1 . . . where; on a display optic-monitor or other preview display optic, as projector or print matter.

The above described and many other features and attendant advantages of the present invention will become apparent as the invention becomes better understood by reference to the following description when considered in conjunction with the accompanying drawings, defined here-in;

### SUMMARY BRIEF OF THE DRAWINGS

Within this brief description of the preferred embodiments of the invention with reference to the accompanying drawings is as follows:

FIG. 1

Where, “what is Claimed (1) is; #⋅15 ⋅; (Source Input)”, first part of three;

FIG. 1—(Source Input),—

an apparatus novice unit-utility-function-110 ⋅, dpix-utility Driver-112 ⋅,
1; wherein; implies a capture device is used to/for light amplification by stimulated emission, to a pixel imaging sensor optic, to a focal-plane,
2; wherein; by methods and means of an apparatus and systems including at least one hardware processor, at least one tangible storage medium (memory), and at least one input/output (I/O) interface of the ‘optical computing system’, however,
   1 . . . where; also implied, are any multi-functional assets such as; scan, FAX, copy, capture device, which are also a capture device user sensor activity,
3; wherein; all are equivalent to a pixel imaging sensor optic action,
4; wherein; however, in this embodiment, a simple format camera is presumed to be the implied venue to the first part of three that captures the pixel imaging sensor optic, to a focal-plane, of the preferred embodiments of the invention for bonding various element architectures in accordance with one or more embodiments of the invention, apparatus novice unit-utility-function-110 ⋅, dpix-utility Driver-112 ⋅ and in-part,—
   1 . . . where; implies—in this preferred embodiment, is the referent asset of the unit-utility-function dpix-93 ⋅—[Capture], sensor Driver-115 ⋅, that also collects the system settings, sensor spec info, capture-input-119 ⋅, of the sensor that detects and conveys the information that constitutes an image, used in electronic imaging devices which include
      1 . . . where; digital cameras, camera modules, medical imaging equipment, night vision equipment such as thermal imaging devices, radar, sonar, and others.
1; wherein; By default, generally, the novice unit-utility—dpix-93 ⋅; as listed in-part here are,
   1 . . . where; instantiation of the shapes as vector outlines, and/or other venues of the same, protect a dpix-93 ⋅ particular characteristic by code that produces them,
   2 . . . where; designed for general support of the processes of a computerized source input to an Image Sensor and/or Graphic Processor source input output values—composed of pieces of equipment connected to or part of the structure and designed to provide the “novice-utility” function, upLoad-Driver-137 ⋅, and,

FIG. 2

Where, “what is Claimed (2) is; #⋅146 ⋅; (Source Output)”, second part of three;

FIG. 2—(Source Output)—

an apparatus novice unit-utility-function-110 ⋅, upLoad-Driver-137 ⋅,
1; wherein; implies the capture device used to/for a pixel imaging sensor optic, to a focal-plane, is captured as an original-plane, and transposed to a layer-composed “new-Plane”, squared, which through using ‘method and means’ will preview on a display optic-monitor or other preview display optic, such as projector,
2; wherein; by default, generally, the novice unit-utility-function—dpix-93 ⋅, upLoad-Driver-137 ⋅;
3; wherein; as listed but not limited to the aberration-80 ⋅, phrase(d)-71 ⋅, collectivity-73 ⋅ outlines, and/or other venues of the same, protect a dpix-93 ⋅ particular characteristic by code that produces them, designed for general support of the processes of a computerized source input to an Image Sensor and/or Graphic Processor source input output values—
   1 . . . where; composed of one or more pieces of equipment connected to or part of the structure and designed to provide the “novice-utility” function . . . ,
      1 . . . where; input to the image Graphic Processor integrates—inferential-76 ⋅ reasoning metric-45 ⋅—pixel values as a sphere-55 ⋅—orb-like-39 ⋅, “infinity-36 ⋅ ( [symbol] )-37 ⋅ infimum-38 ⋅”,
4; wherein; that link with the in-part supplementals and FIG. 2—(Source Output)—as a layer-display retrieve-129 ⋅ output to pixel value^{ref}-94 ⋅ as per; −ƒ(x)·φ·π·r·, ∴=spherical-56 ⋅ object/objective of “infinity-36 ⋅ ( [symbol] )-37 ⋅ infimum-38 ⋅”/“mark-48 ⋅ doppler-49 ⋅ shift-50 ⋅”, a [symbol] -baseline, primal-52 [symbol] =zenith-nadir÷by a horizon line: 360/180°/or/orb-like-39 ⋅, spherical angle (∠=AOB=180°) symmetry)),
   1 . . . where; meaning descriptive statistics typically used as a preliminary step before more formal inference-75 ⋅ are drawn—where φ·π·r·; (radians, radius, radii), mark-48 ⋅ the primal-52 ⋅ of the “infinity-36 ⋅ ( [symbol] )-37 ⋅ infimum-38 ⋅”—sphere-55 ⋅—orb-like-39 ⋅, object/objective to mark-48 ⋅, symmetry·dc-63 ⋅ . . . , the metric-45 ⋅,
   2 . . . where; a system of related measures that facilitates the quantification of a dpix-93 ⋅ particular characteristic, wherein the dpixel-92 ⋅ particular characteristic
5; wherein; the apparatus novice unit-utility, [0027] bear no claims/methods commonly known,
   1 . . . where; in contrast, the apparatus novice unit-utility takes a pixel value^{ref}-94 ⋅ referent and returns a dpixel value-94 ⋅ related to “the viewing/display optic” methods software coding, decoding methods of a source input to an Image Sensor and/or Graphic Processor source input output values and/or any ‘source’ of an induced plane, the asset value output for comprising the novice—apparatus unit-utility-function-110 ⋅; upLoad-Driver-137 ⋅ (I/O port)—Run/driver/unit-utility/sensor/display/output, layer-display retrieve-129 ⋅—
   2 . . . where; thereafter, components of the methods of interaction—expressed in part as following; —dpix-93 ⋅ (dpixelive-92 ⋅, dspixel-92 ⋅, dpixel-92 ⋅)—“infinity-36 ⋅ ( [symbol] )-37 ⋅ infimum-38 ⋅”,
   3 . . . where; and the numeric formulas and numbers of—metric-45 ⋅—metric-fluency-46 ⋅ that facilitates the quantification of a subset-42 ⋅ calculus-43 ⋅, in the process within this abstract patent application,
      1 . . . where; the novice-claim resides with the methods or arrangements for coding, decoding, —wherein the novelty, dpix-93 ⋅ particular characteristic as composed, subjectively, within this abstract of content and images of the patent application;

FIG. 3

Where, “what is Claimed (3) is; #⋅149 ⋅; (analogous Output)”, third part of three;
1; wherein; outputting the Unit-utility of holomorphic-100 ⋅, returns a dpixel value-94 ⋅, dimensional pixel,
   1 . . . where; on a display optic-monitor or other preview display optic, as projector or print matter.

FIG. 3—(analogous)

an apparatus novice unit-utility-function-110 ⋅, execute-Driver-117 ⋅,
1; The third part of three—inclusive combines;
   1 . . . An apparatus unit-utility-function-110 ⋅ (Input)—the first part of three;
   2 . . . An apparatus unit-utility-function-110 ⋅ (Output)—the second part of three;
   3 . . . An apparatus unit-utility-function-110 ⋅ (Output-/-Display/Print/Preview)—the third part of three—the analogous of outputting the Unit-utility of holomorphic-100 ⋅, returns a dpixel value-94 ⋅, dimensional pixel, in accordance with one or more embodiments of the invention,
2; for “promises of utility—mere scintilla” of usefulness
   compliments the artifact-70 ⋅ (software development), of novice architectures and methods securing the—comprising unit-utilities-#of; —apparatus novice, dpix-utility Driver-112 ⋅,
   1 . . . in relation to surroundings or circumstances, of the venue, dpix-93 ⋅, in preparation-44 ⋅ of dissonance, for AI Logic, conflict opinions, actions/characters with, Object Recognition, Similarity and Matching, (RSM), intersecting points between successive—dpix-intracellular-98 ⋅, images, (aka, RSM-object), datum,
3; using ‘method and means’ as compare progressive for “non-zero dimension”,
   1 . . . for mark-up and index formatting, attach a tag or label to, detect and remember,
      1 . . . where; “mark-48 ⋅ doppler-49 ⋅ shift-50 ⋅”, versus—
         “infinity-36 ⋅ ( [symbol] )-37 ⋅ infimum-38 ⋅”, moved tolerance [symbol] -doppler-49 ⋅ shift-50 ⋅ [symbol] , having a bearing on or connection
4; with the subject at issue . . . ,
   1 . . . dpix-93 ⋅ Whatis-data/-/dpix-93 ⋅ Whereis-data/-/dpix-93 ⋅ Whois-data . . . ,
      1 . . . where; cognition collectivity-73 ⋅ embodiment, AI Logic; —(cognition collectivity-73 ⋅ result in perception, learning and reasoning), —the analogous of outputting the dimensional pixel,

### DESCRIPTION DETAILED

The apparatus novice unit-utility-function-110 ⋅, in-part, —implies—a source input-/output value function, alternatively in a certain way related to output in an analogous method.
further expanded here represented by a group of dpix-93 ⋅ derivatives-74 ⋅, composition-72 ⋅, collectivity-73 ⋅;
1; wherein; further comprising the unit-utilities-#of, ‘method and means’, here implies, of the use relating to green technology outputs, such as carbon count in the field of scrubbers, converting CO2 into a solid state//also//salt, mineral, etc, in water ref; —comprising the unit-utilities-#of—Σ(∇ƒ=⇒)Π-17 ⋅; as, pleadable-26 ⋅ principles-83 ⋅,)
2; wherein; further comprising the regarding an acquired image of inference-75 ⋅, a droplet of water, H₂O,
3; wherein; further comprising the subject of the composition-72 ⋅, and the regarding an acquired image of inference-75 ⋅, table salt and barium oxide, are NaCl and BaO. respectively, and therefore are differently represented by a group of dpix-93 ⋅ —derivatives-74 ⋅, collectivity-73 ⋅; however; —collectivity-73 ⋅;
4; wherein; further regarding an acquired image of inference-75 ⋅, [the understanding], understanding human language technology and/or natural language information . . . ,
   1 . . . where; regarding an acquired image of inference-75 ⋅, the/a datum information point derived, H₂O, and NaCl and BaO, could therefore represent salt water by a single or group of dpix-93 ⋅—derivatives-74 ⋅, collectivity-73 ⋅; a ‘pertaining’ that is derived from another ‘pertaining’, composition-72 ⋅,
5; wherein; further comprising regarding an acquired image of inference-75 ⋅, biological sequence listing . . . , subjectivity, it would stand to reason the same could be applied as was applied to;
   where; green technology outputs, and/or logic as described above as [collectivity-73 ⋅], AI Logic.
6; wherein; further comprising the unit-utilities-#of, dpix-93 ⋅ tangible—An artifact is one of many kinds of tangible by-products produced during the development of software,
   1 . . . where; help describe the function, architecture, and design of software—
      1 . . . where; by a single or group of dpix-93 ⋅—derivatives-74 ⋅, collectivity-73 ⋅;
         . . . 1 . . . where; a ‘pertaining’ that is derived from another ‘pertaining’, composition-72 ⋅,

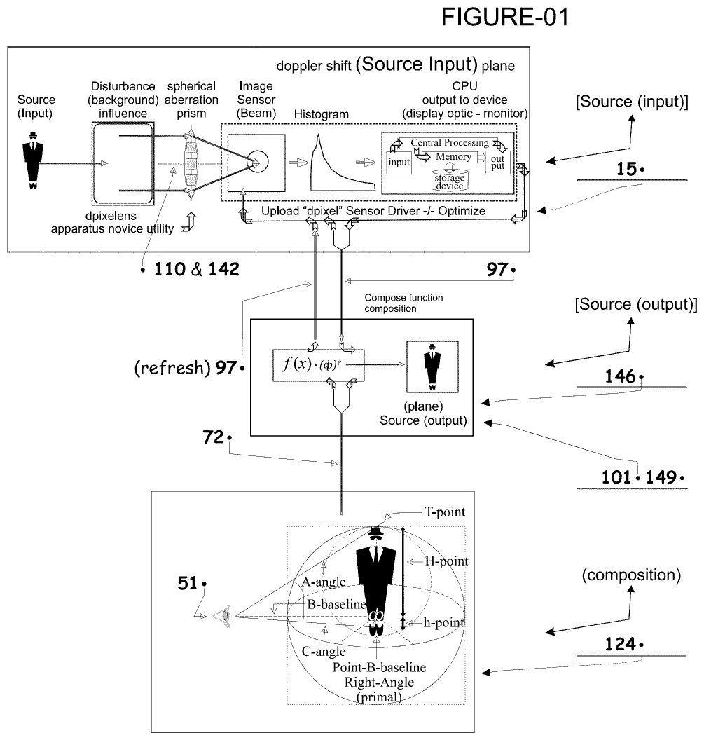

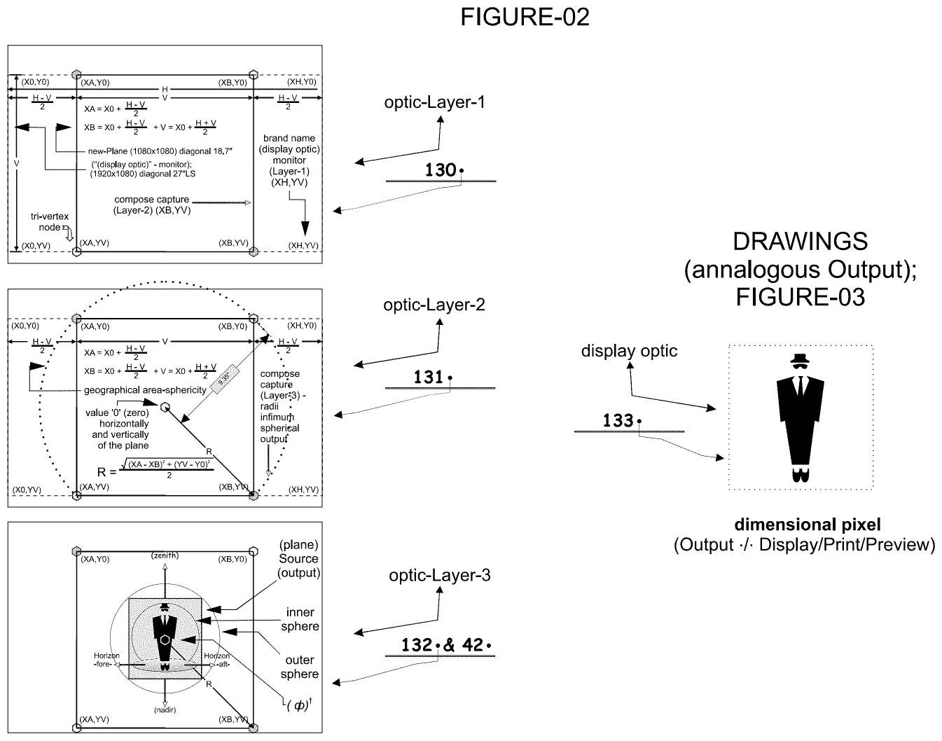

An apparatus unit-utility-function-110 ⋅, dpix-utility Driver-112 ⋅,

where the descriptive part of a patent application for “promises of utility”—inferences, inference-75 ⋅, inferential-76 ⋅;
1; wherein; herein the reference verbiage for a ruling patent's need only the “mere scintilla” of usefulness required of “utility” as would be understood by one skilled in the art, distinctive and without equal to the dpix-93 ⋅, dpixel value-94 ⋅ of the capture original-plane-121 ⋅, with the assembly in accordance with the embodiment of the invention, are implied as follows:
   1 . . . where; annotate; reference verbiage, are cross referenced with references, and/or cross references indexed numbers/numerics/words that bears the same immanent “meaning”, subjective always herein to interpretation of the applicant and not to be construed as errors and omissions by the reader;
      1 . . . where; listed in-part but not limited to, nor required once referenced with drawings, FIG. 1—(Source Input), FIG. 2—(Source Output), FIG. 3—(analogous Output).

the method of unit-utility-150 ⋅; here; [154: 1-3] as, inclusive in-part or whole; where content or symbolized is within, Proprietary Property or/and Proprietary Privilege.

source input instrument, dpixelens-142 ⋅,

in-part; dpixelens-142 ⋅, [collectivity-73 ⋅], AI Logic;
1; wherein; the apparatus novice unit-utility, here detailed for measuring, recording, or controlling, expressed in terms of fundamental quantities like time, mass and length—implies—a source input instrument—
   1 . . . where; making the image sensor output values/GPU source input output values, function, alternatively in a certain way related to “the viewing/display optic”—the point2point doppler-49 ⋅ shift-50 ⋅—ddp-m2m-pri⋅-107 ⋅ in preparation-44 ⋅ of dissonance, for AI Logic, conflict opinions, actions/characters with,
      1 . . . where; Object Recognition, Similarity and Matching intersecting points between successive—dpix-intracellular-98 ⋅, images or
      2 . . . where; hereinafter (aka, RSM-object datum,
2; wherein; hereinafter may be referenced as ‘RSM-o’) using ‘method and means’ for mark-up and index formatting, “mark-48 ⋅/doppler-49 ⋅/shift-50 ⋅”, versus “infinity-36 ⋅ ( [symbol] )-37 ⋅ infimum-38 ⋅”, moved tolerance [symbol] -doppler-49 ⋅ shift-50 [symbol] , having a bearing on or connection with the subject at issue within . . . ,
   1 . . . where; dpix-93 ⋅ Whatis-data/-/dpix-93 ⋅ Whereis-data/-/dpix-93 ⋅ Whois-data . . . , cognition collectivity-73 ⋅ embodiment,
   2 . . . where; applicable for dpixelens-142 ⋅, AI Logic; —(cognition collectivity-73 ⋅ result in perception, learning and reasoning)—FIG. 1—(Source Input),
   3 . . . where; spherical-56 ⋅ aberration-80 ⋅ replace lens with dpixelens-142 ⋅
3; wherein; apparatus novice unit-utility is the in-part, subject of claim of FIG. 1, capture retrieve-plane-122 ⋅, by default for (Output);
   1 . . . where; (annotate; replace lens with dpixelens-142 ⋅ is not a requirement of this apparatus unit-utility-function-110 ⋅, dpix-utility Driver-112 ⋅, but is suggestive as a source input instrument asset to further enhance this apparatus unit-utility-function-110 ⋅)

First part of three, [what is Claimed (1) is; #⋅15 ⋅], inclusive;
1; of an application comprising instructions for, —newPlane-97 ⋅ as, display, layer, dpixel value-94 ⋅, geometry of 2-dimensional figures inherent with spatiotemporal-81 ⋅, coherence-82 ⋅, property having dimensions/time/mass/cognitive content.

FIG. 1—(Source Input)
1; wherein; an apparatus unit-utility-function-110 ⋅, dpix-utility Driver-112 ⋅, newPlane-97 ⋅;
   1 . . . where; Sensor Driver-115 ⋅, system settings, sensor spec info, capture-input-119 ⋅.
2; wherein; an image sensor or imaging sensor, aka: imager, capture sensor optic-123 ⋅ is a sensor that detects and conveys the information that constitutes an image. It does so by converting the variable attenuation of light waves, as they pass through or reflect off objects, into signals, small bursts of current that convey the information.
3; wherein waves can be light or other electromagnetic radiation. Image sensors are used in electronic imaging devices of both analog and digital types,
   1 . . . which include digital cameras, camera modules, medical imaging equipment, night vision equipment such as thermal imaging devices, radar, sonar, and others.
4; As technology changes, digital imaging tends to replace analog imaging. [Reference: in-part—https://en.wikipedia.org/wiki Image_sensor, aka, capture sensor optic-123 ⋅]

Generally, the novice unit-utility—dpix-93 ⋅; as listed in-part, but not limited to the aberration-80 ⋅, phrase(d)-71 ⋅, collectivity-73 ⋅ unit-utility herein comprised,
1; where instantiation of the shapes as vector outlines, and/or other venues of the same, protect a dpix-93 ⋅ particular characteristic by code that produces them,
   1 . . . designed for general support of the processes of a computerized source input to an Image Sensor and/or Graphic Processor source input output values—
   2 . . . composed of one or more pieces of equipment connected to or part of the structure and designed to provide the “novice unit-utilities” function . . . ,
2; where the apparatus novice unit-utility input to the image sensor output values integrates—inferential-76 ⋅ reasoning metric-45 ⋅—pixel values as a sphere-55 ⋅-orb-like-39 ⋅, “infinity-36 ⋅ ( [symbol] )-37 ⋅ infimum-38 ⋅”,
3; where making the processor function alternatively in a certain way related to output;
   1 . . . (Input—Output—(I/O) interface), that achieves a presuppose—focal-plane-126 ⋅ —capture original optic-118 ⋅ archived as “background”,
   2 . . . implies—a source input to an Image Sensor and/or Graphic Processor source input output values and/or any ‘source’,
      1 . . . inclusive of; Import/Load/Open, of an induced plane used by methods, apparatus and systems including;
         . . . 1 . . . at least one hardware processor,
         . . . 2 . . . at least one tangible storage medium (memory), and
         . . . 3 . . . at least one input/output (I/O) interface of the ‘optical computing system’ . . . ,
   3 . . . further implies—execute-Driver-117 ⋅ upLoad-Driver-137 ⋅ (I/O port)—Run/driver/unit-utility/sensor/display/output, capture original-plane-121 ⋅
      1 . . . where thereafter, components of the methods of interaction—making the image sensor output values function alternatively in a certain way related to “the viewing/display optic”, digital/raster, as in; camera, cell phone, tablet, display monitor and/or televised screen, monitor, AR (Augmented Reality), VR (Virtual Reality) and/or projection display methods, . . . with digital dpixel-analog conversion, ddp-ac-105 ⋅, as listed in-part but not limited to the declared utilities to where—sensor Driver-115 ⋅, [system settings], sensor specifications information is stored with the pixel value^{ref}-94 ⋅ referent;
         . . . 1 . . . where to integrate adaptively for inferential-76 ⋅ reasoning metric-45 ⋅ —that link the FIG. 1—(Source Input) capture original optic-118 ⋅ output to pixel value^{ref}-94 ⋅
         . . . 1. as per; ƒ(x)φ·π·r·∝=a sphere-55 ⋅—orb-like-39 ⋅,
         . . . 2. object/objective of preparation-44 ⋅,
         . . . 1 . . . “infinity-36 ⋅ ( [symbol] )-37 ⋅ infimum-38 ⋅”—
         . . . 2 . . . “mark-48 ⋅ doppler-49 ⋅ shift-50 ⋅”,
         3. a [symbol] -baseline, primal, and a sphere,
         1 . . . inclusive with a zenith and nadir divided by a horizon line-360/180 degree,
4; where meaning descriptive statistics typically used as a preliminary step before more formal inference-75 ⋅ are drawn—
   1 . . . which are used to adaptively optimize a “source” in a real time step capture rate-optic-120 ⋅, captures;
      1 . . . where φ·π·r·; (radians, radius, radii), mark-48 ⋅ the primal-52 ⋅ of the “infinity-36 ⋅ ( [symbol] )-37 ⋅ infimum-38 ⋅” sphere-55 ⋅ orb-like-39 ⋅, object/objective to mark-48 ⋅, symmetry-dc-63 ⋅ . . . ,
   2 . . . where the metric-45 ⋅, a system of related measures that facilitates the quantification of a dpix-93 ⋅ characteristic of dpixel-92 ⋅, dpixelive-92 ⋅ dspixel-92 ⋅, infimum-38 ⋅,—
   3 . . . wherein the dpix-93 ⋅ particular characteristic differ . . . , see “[0003] Related Applications”
5; wherein contrast, the apparatus novice unit-utility takes a pixel value^{ref}-94 ⋅ referent and returns a dpixel value-94 ⋅ related to “the viewing/display optic”],
   1 . . . where software coding, decoding methods of a source input to an Image Sensor and/or Graphic Processor source input output values and/or any ‘source’ of an induced plane . . . the asset value output for comprising the novice—apparatus unit-utility-function-110 ⋅,
   2 . . . where adaptively optimizing a “source” in a real time step capture rate-optic-120 ⋅, —precomprised (display optic)—the viewing/display optic—capture screen optic-124 ⋅ . . . ,
   3 . . . where the apparatus aberration-80 ⋅ phrase(d)-71 ⋅ novice unit-utility, bear no claims of methods already commonly known,
   4 . . . where further there are no claim to numeric formulas individually herein expressed, (except as reference of the invention text embodiment for understanding human language technology and/or natural language information) . . . , . . . prior to;
      1 . . . upLoad-Driver-137 ⋅ (I/O port)—Run/driver/unit-utility/sensor/display/output—
   5 . . . where thereafter, components of the methods of interaction expressed in part as following; —dpix-93 ⋅ (dpixelive-92 ⋅, dspixel-92 ⋅, dpixel-92 ⋅)-“infinity-36 ⋅ ( [symbol] )-37 ⋅ infimum-38 ⋅”,
   6 . . . and the numeric formulas and numbers of—metric-45 ⋅—metric-fluency-46 ⋅ that facilitates the quantification of a subset-42 ⋅ calculus-43 ⋅,
      1 . . . where also in the process within this abstract patent application are to express explanation content herein used.
6; wherein the novice claim resides with the methods or arrangements for coding, decoding,—
   1 . . . wherein the novelty, dpix-93 ⋅ particular characteristic as composed, subjectively, within this abstract of content and images of the patent application, and suggested collectivity-73 ⋅ by definitions marked as aberration-80 ⋅ phrase(d)-71 ⋅,

apparatus novice unit-utility, bear no claims of methods already commonly known, where; —the “already commonly known” means in-part; ‘software development kit’, a term asset of the developing of a FUNCTION
1; however, the functions are different as each is described,
2; but the ‘asset’, (hardware) is of similarity expression,
3; where in-part as, what differs is the executable novice architectures and methods for dpix-utility Driver-112 ⋅—is the OS for the assets;
   1 . . . dpixelens-142 ⋅, and
   2 . . . doppler-49 ⋅ in concert, embodiments.

Drawings, FIG. 1—(Source Input);
newPlane-97 ⋅, dpixel-quadrant-99 ⋅ also referred “capture sensor optic-123 ⋅
(Input-Output) outputting Drawings, (Source Output);

Img.—Source Input

the capture sensor optic-123 ⋅ implies to a layman, some type of digit device, that will capture original optic-118 ⋅ a digital image “Source (Input)”.
1; wherein the Image implied to be capture original optic-118 ⋅ called a “Source (Input)” is the silhouette digit pixel person, suited with hat, tie, shoes.

Img. —Disturbance

the Disturbance (background) influence is subject to the distance between the Source Input from the spherical-56 ⋅ aberration-80 ⋅ prism, usually known as the lens, capture original optic-118 ⋅, the distance more comprised as,
1; wherein “fore (infinity-36 ⋅ ( [symbol] )-37 ⋅ infimum-38 ⋅) aft”, the Disturbance being any environment, the area in which something exists within the capture original optic-118 ⋅,
2; wherein expression-69 ⋅, the sun shining—cloudy—windy, . . . with digital dpixel-analog conversion, ddp-list-104 ⋅—fore-ground and aft-ground or background of the Source (Input).

Img.—spherical aberration prism

the spherical-56 ⋅ aberration-80 ⋅ prism in-part comprises capture original optic-118 ⋅, deviates a beam of an image through an optical lens or assembly of lenses used in conjunction with a body capture sensor optic-123 ⋅ apparatus.
1; Img.—the spherical-56 ⋅ aberration-80 ⋅ prism, replace lens with; dpixelens-142 ⋅-[apparatus novice unit-utility] is the in-part, subject;
   1 . . . of capture-input-119 ⋅ (retrieve-plane-122 ⋅) plane by default (Output);
   2 . . . wherein annotate; replace lens with dpixelens-142 ⋅ is not a requirement of this apparatus unit-utility-function-110 ⋅, dpix-utility Driver-112 ⋅,
   3 . . . but is suggestive as a source input instrument asset to further enhance this apparatus unit-utility-function-110 ⋅,

Img.—Image Sensor (Beam)

the Image Sensor Beam photons that hit the photodiode, are captured by, (sample, CMOS·/·APS·/·AGP·/GPU), the pixel imaging sensors, processing circuit apparatus—capture sensor optic-123 ⋅ to a graphics processor.

Img.—Histogram

the Histogram becomes the part end result of the Image Sensor Beam captured by the apparatus, Image Sensor, to the graphics processor, output.

Img.—CPU, output to device, (display optic)

the CPU—passes the pixel image sensors, with;
1; GPU sample given 128×128 (Pixel Array) pixels, that are used as part of a focal-plane-126 ⋅ image processing circuit to the CPU unit-utility.

Img.—CPU—output to device (display optic-monitor);

the CPU—performs logical operations of data, capture sensor optic-123 ⋅,
1; according to programmed instructions in order to obtain the required information of the Source input sensor beam quality to adaptively optimize the optical system at a real time step capture rate-optic-120 ⋅ rate temporarily held in-memory for output to a device,
2; that generally is understood to be a type of memory to monitor that will display the capture sensor optic-123 ⋅ image, followed by refreshing the image until the CPU is instructed to capture sensor optic-123 ⋅ image,
   1 . . . generally “executed” by a physical action of a mechanical function, or electronic functional action taken,
   2 . . . upon the action “executed”, the captured sensor optic-123 ⋅ image is stored on/within a physical device means and the process is repeated,
      1 . . . which later, the image, can be retrieved upon request to/from (I/O) the CPU physical hardware or other storage device.

Img.—output-/-CPU

the output-/-CPU—passes the pixel image sensor,
1; GPU sample given, 128×128 (Pixel Array) pixels, that is used as part of a presuppose focal-plane-126 ⋅ image processing transition from/to the viewing display optic-graphic-134 ⋅, as in; camera, cell ph., tablet or display monitor and/or other users of the sensor image processing circuit and/or passes the asset value output, back to the CPU, dpixel-92 ⋅ apparatus novice unit-utility,
2; wherein comprising . . . with digital dpixel-analog conversion, ddp-ac-105 ⋅—a system of related measures that facilitates the quantification of some particular characteristic (evolvements) of the dpixel-92 ⋅—the asset value output, as target or request of the dpixel-92 ⋅ apparatus novice unit-utility.

Img.—Optimize—upLoad-Driver-137 ⋅

the asset value apparatus unit-utility-function-110 ⋅ dpixel-92 ⋅ upLoad-Driver-137 ⋅ may be uploaded through the output/input/CPU port, also known as an I/O port,
1; wherein the “Optimize” meaning identifies a viewing display optic.
   1 . . . where Img.—Update-/-Optimize—or—Next input (Plane; Capture; Sphere)
      1 . . . where . . . for the novice unit-utility dpixel-92 ⋅ execute-Driver-117 ⋅ to request
         Next input (Plane; Capture; Sphere) to be processed.

Img.—(Input-Output)—newPlane-97 ⋅;

Source input, variant (disturbance influence), of real time optical control
1; wherein the sensor captures a based beam quality metric to adaptively optimize the optical system at a real time step capture rate-optic-120 ⋅ for output.

Img.—(Input-Output)—retrieve-plane-122 ⋅;

Img.—Image Sensor

the Image Sensor Beam photons that hit the photodiode, are captured by the;
1; wherein (CMOS⋅/⋅APS/⋅AGP·/⋅GPU), pixel imaging sensors, processing circuit apparatus—capture sensor optic-123 ⋅ processing.
2; wherein this is identified by the following characterizing;
   1 . . . Img. —The Image implied, Source (Input)
      1 . . . is a silhouette digit pixel person, suited with hat, tie, shoes.
   2 . . . Img.—128×128 (Pixel Array)
   3 . . . Img.—10b Column Parallel ADC-/-Row Registers
   4 . . . Img.—graphics processor (Image Sensor) Source (input/output);
   5 . . . Img.—graphics processor (brand name) if available;

Img.—(Output)—capture—retrieve-plane-122 ⋅;

Img.—compose function composition, [(fog), function composition-72 ⋅]

The asset value apparatus unit-utility-function-110 ⋅ dpixel-92 ⋅ upLoad-Driver-137 ⋅,
1; wherein is designed to search for the, (CMOS⋅/⋅APS⋅/⋅AGP⋅/⋅GPU), pixel imaging data information to retrieve
   1 . . . where the Img.—128×128 (Pixel Array)—graphics processor (brand name) if available,
   2 . . . and whether the pixel metric is portrait or landscape orientation,
      1 . . . where the vertical sides are longer than the horizontal sides or visa-versa focal-plane-126 ⋅,
   3 . . . where upLoad-Driver-137 ⋅, (output) capture retrieve-plane-122 ⋅, that maps values of ·(x)· to ƒ·ƒ(x)·function of ·(x)·compose function composition-72 ⋅, capture to the sensor⋅/⋅CPU utilities directory, by normal program I/O unit-utility tool program venues of the apparatus used.
2; wherein compose function composition-72 ⋅ request by means of . . . ,
   1 . . . where the asset value apparatus novice unit-utility dpixel-92 ⋅ execute-Driver-117 ⋅, by evaluating the layer-captured-plane-127 ⋅
   2 . . . where and focal-plane-126 ⋅, the graphics processor optic Image, processed pixel value^{ref}-94 ⋅ referent
   3 . . . and processing the results into a squared dimension around the captured image,
      1 . . . where then based on the squared image captured, a sphere-55 ⋅ will encompass the squared image captured which
         . . . 1 . . . becomes the result for the aberration-80 ⋅ phrase-71 ⋅ (output),

Img.—original-plane—original-plane-121 ⋅; capture (retrieve-plane-122 ⋅);

Img.—capture (retrieve-plane-122 ⋅) Output; uses; (original-plane-121 ⋅)

Input-Output; the optical image processed pixel value^{ref}-94 ⋅
1; wherein referent to adaptively optimize inferential-76 ⋅ reasoning metric-45 ⋅
   1 . . . for a—layer-captured-plane-127 ⋅, Source (output) to for viewing display optic, digital/raster, as in; camera, cell phone, tablet, display monitor and/or television screen monitor, AR (Augmented Reality), VR (Virtual Reality) and/or projection display methods,
   2 . . . with digital dpixel-analog conversion, ddp-ac-105 ⋅, as listed in-part but not limited to the above,
2; wherein inclusive comprised here in-part not in detail below; if, dpixelens-142 ⋅, AI Logic; The apparatus novice unit-utility, here detailed for measuring, recording, or controlling, expressed in terms of fundamental quantities like time, mass and length,
3; wherein implies—a source input instrument, with an Image Sensor and/or Graphic Processor source input output values,
   1 . . . for an induced plane—making the image sensor/GPU source input output values, function,
      1 . . . alternatively in a certain way related to “the viewing display optic”, employed by contrivances methods for the apparatus novice instrument comprised here in-part not in detail as follows;—
4; wherein if, the dpixelens-142 ⋅ links optical translucent-lase-59 ⋅ vision to the transparent dome shaped anterior portion of the outer covering of the semi-orb-convex; it's simulation;
   1 . . . where covers the pupil, iris, cornea to retina and is continuous with the sclera, thus the dpixelens-142 ⋅
5; wherein is iris-tissue homogenous (of the same), herein referred in-part as dpixelens-142 ⋅.
6; wherein and include, advanced capture (eg. camera) features like electronic pan, tilt, zoom, applications requiring motion detection, target tracking,
   1 . . . where inclusive hologram capture and/or projections, synergistic packages that enhance imaging, system-on-chip (SOC) device sensors providing benefits like anti-shake compensation that corrects blurring from subject motion or an unsteady lens,
   2 . . . where via horizon 360/180 degree dpixelens-142 ⋅, point2point doppler-49 ⋅ shift-50 ⋅—ddp-m2m⋅pri⋅-107 ⋅ in preparation-44 ⋅ of dissonance, for AI Logic, conflict opinions, actions/characters; (still)-[fixed/v/unfixed]-(motion), (repeat conflict), through a predetermined cashe and/or page swap file, repeat,

implies Tangent optic—the optical image processed; the—optical image sensor captures the Tangent optic generally, using ‘method and means’ offered if available.

Within many modern utilities of the capturing device apparatus are available methods and systems that identify such things as red eye, auto focus, microphones capturing sound, as per ddp-list-104 ⋅, light filtering, subject distance metering focusing, etc., as listed in-part but not limited to the above,
1; wherein inclusive comprised here in-part not in detail; when the dpix-utility Driver-112 ⋅ detects a means of using one of the capturing device apparatus utilities to employ capturing the Tangent optic by default or employs a second means, the simple Tangent formula is invoked subjectively as comprised below, capture (retrieve-plane-122 ⋅) (Output)-(Tangent).

Img.—capture (retrieve-plane-122 ⋅)

Img.—Tangent
1 . . . Img.—A=Tan+a×D
2 . . . Img.—A=Tan−b×D
3 . . . Img.—Height=A+B
4 . . . Img.—mark doppler shift ( [symbol] )-37 ⋅ via [ [symbol] -baseline, primal, sphere].
5 . . . Img.—via [symbol] -line of site

Img.—baseline—( [symbol] -BL)
1; wherein via line of site, the to be layer-captured-plane-127 ⋅ Source,
2; with the point above and below line of site,
3; with a zenith and nadir divided by a horizon line,
4; wherein as per the Image implied to be captured called a Source (Input),
   1 . . . is a silhouette digit pixel person, suited with hat, tie, shoes.

Img.—mark doppler shift ( [symbol] )-37 ⋅
1; wherein mark doppler shift ( [symbol] )-37 ⋅ via [symbol] -line of site, [symbol] -Baseline . . . mark dpixel-92 ⋅ apparatus novice unit-utility,
   1 . . . the first measured calculation comprising—a system of related measures that facilitates the quantification of some particular characteristic (evolvements) of the dpixel-92 ⋅—the asset value output,
      1 . . . as target or request of the dpixel-92 ⋅ apparatus novice unit-utility.

Img.—infinite spherical-56 ⋅ point

the asset value output, as target or request of the dpixel-92 ⋅ apparatus novice unit-utility.

Img.—inner sphere-55 ⋅ of influence (Input)
1; wherein— [symbol] -baseline- [symbol] -BL, via [symbol] -line of site; —Tangent—(where subject to angle=45 degree, and angle=reversed (x°) degree the point above and below line of site triad [symbol] -baseline to the infer-axiom horizon line, processing the results into a square dimension around the inner sphere of influence image),
   1 . . . wherein as per the Image implied to be capture original optic-118 ⋅ called a Source (input) is a,
      1 . . . silhouette digit pixel person, suited with hat, tie, shoes.

Img.—outer sphere-55 ⋅ of influence (Output)
1; wherein inclusive, the squared dimension, a sphere encompass the squared dimension becoming the in-part result for the (output), of the Image Sensor and/or Graphic Processor source input output values.

Img.—on a given focal-plane-126 ⋅
1; wherein the comprehension is ‘flat’, without influence for dimension in real-time,
   1 . . . the ambiguity of direction of motion due to lack of visual references for depth

Img.—infer-axiom horizon line of a dpixel-92 ⋅ metric-45 ⋅
1; wherein a infer-axiom line, perception is a ‘straight line’.

Img.— [symbol] -BL from here, ‘fore’·>( [symbol] )-37 ⋅<·‘aft’, to here.
1; wherein inferential-76 ⋅ reasoning metric implies line of site,
2; wherein inclusive; of, in, along or relating to a line of instance of visual perception, must travers through an “infinity-36 ⋅ ( [symbol] )-37 ⋅ infimum-38 ⋅”, of ‘fore’ and ‘aft’, —infimum-38 ⋅ metric-45 ⋅, ƒ·>|x:y|<· equates [(ƒ∘g) function composition-72 ⋅].

Img.—(Input) function composition (Output)

Img.—building the dpixel-92 ⋅ metric-45 ⋅—(subset-42 ⋅)
1; wherein the—optical image sensor output values captures the Tangent optic by generally, using ‘method and means’ offered by the utilities of the capturing device apparatus if available.
   1 . . . where within many modern utilities of the capturing device apparatus are available methods and systems that identify such things as red eye, auto focus, microphones capturing sound,
      1 . . . ( . . . with digital dpixel-analog conversion, ddp-ac-105 ⋅), light filtering, subject distance metering focusing, etc.
2; wherein when the dpix-utility Driver-112 ⋅, detects a means of using one of the capturing device apparatus utilities to employ capturing the Tangent optic by default or employs a second means, the simple Tangent formula is invoked subjectively as comprised (Tangent) in-part below.

(Tangent)

Img.—(Tangent)
if angle A=45°
then H=B
height (H+h)
then angle C=x°
mark doppler shift (dp)-37 ⋅
via line of [symbol] -site-51 ⋅

Img.—via [symbol] -line of [symbol] -site-51 ⋅, [symbol] -B-baseline, equates;
1; wherein inner sphere of influence (annotate; site-51 ⋅—primal's physical position in relation to the surroundings)
   1 . . . A-Angle
   2 . . . B-baseline-( [symbol] )-37 ⋅—mark-48 ⋅, doppler-49 ⋅ shift-50 ⋅, and primal-52 ⋅ [symbol]
   3 . . . C-Angle
   4 . . . Point-B-baseline—Right-Angle (primal-52⋅ [symbol] )
   5 . . . T-Point; ref; 1-a)—angle A=450
   6 . . . H-Point; ref; 1-b)—then H=B
   7 . . . h-Point; ref; 1-d)—angle C=x°

(annotate critical comment to “infinity-36 ⋅ ( [symbol] )-37 ⋅ infimum-38 ⋅”

Img.—“mark-48 ⋅ doppler-49 ⋅ shift-50 ⋅”
1 . . . ƒ(x)·π·r∴( [symbol] )-37 ⋅=“mark-48 ⋅ doppler-49 ⋅ shift-50 ⋅” plane output
1 . . . with a zenith and nadir divided by a horizon line—
1 . . . invoked subjectively as comprised, into the Tangent, in-part, subsumption,
   1 . . . the premise of a syllogism that contains the minor term being—(Tangent), for the Tangent, which is the subject of the conclusion.

Img.—newPlaneXsphere-101 ⋅
1; wherein inferential-76 ⋅ reasoning metric imaging output, subset-42 ⋅,
   1 . . . where the greatest element of the containing set that is smaller or equal to all elements within, calculates a “mark-48 ⋅ doppler-49 ⋅ shift-50 ⋅” plane output

Img.—“infinity-36 ⋅ ( [symbol] )-37 ⋅ infimum-38 ⋅” (Output);
1; wherein dimensionality rotational units as within a spatial property's preferred line of [symbol] -site-51 ⋅;

Img.—dimensionality rotational units—holomorphic-100 ⋅
1 . . . Img.—Blue—ij=k
2 . . . Img.—Red—ij=−k
3 . . . Img.—Blue—ij=ji−Red
4 . . . Img.—fore=·>|x:y|<·=aft−[ƒ·>|x:y|<·]

annotate critical—composed ref. FIG. 1—(Source Input)—
1; wherein image sensor, 128×128 (pixel array) metric-45 ⋅ each pixel maps values of ·(x)· to ·ƒ(x)· function of ·(x)·—inclusive of, with—(image).

Img.—holomorphic-100 ⋅

Img.—(the inner sphere marks the tangent Horizion)
1 . . . Img.—The point above the observer
2 . . . Img.—(zenith) [Blue−ij=k]
3 . . . Img.—upLeft-vertex-53 ⋅∠ representative, [Red−ij=−k]−3 pt-perspective component—tri-vertex-54 ⋅ node ∠, (XA,Y0)
4 . . . Img.—upRight-vertex-53 ⋅ ∠ representative, [Red−ij=−k]−3 pt-perspective component—tri-vertex-54 ⋅ node ∠, (XB,Y0)
5 . . . Img.—Horizon-fore—
6 . . . Img.—-fore-‘ellipse’ sphere marks the Horizon
7 . . . Img.—( [symbol] )-37 ⋅ infer-axiom horizon line of a dpixel-92 ⋅ metric-45 ⋅—sphere-55 ⋅
   6 . . . Img.—aft-‘ellipse’ sphere marks the Horizon [Blue−ij=ji−Red]
   5 . . . Img.—-aft-Horizon
   4 . . . Img.—dnRight-vertex-53 ⋅ ∠ representative, [Blue−ij=k]−3 pt-perspective component—tri-vertex-54 ⋅ node ∠, (XA,YV)
   3 . . . Img.—dnLeft-vertex-53 ⋅ ∠ representative—3 pt-perspective component—tri-vertex-54 ⋅ node ∠, (XB,YV)
   2 . . . Img.—(nadir)
   1 . . . Img.—The point below the observer

where therefore the above is allowing the “Img.” controlled/free rotation;

in continuance of [0027], “in concert, embodiments” . . . ,
1; further comprising the unit-utilities-#of; [apparatus novice, dpix-utility Driver-112 ⋅, execute-Driver-117 ⋅, upLoad-Driver-137 ⋅]-[semantics-68 ⋅; phrase-71 ⋅; collectivity-73 ⋅]
2; hereinafter, the subsequent part of this document, statement or matter adhering to Computing—
   1 . . . where development of software achieve virtual object in a digital environment of specified formats
   2 . . . where as well as determine the arrangement of datum, (data), for storage
      1 . . . and display (in computer science) as related to computability,
3; include third party format as/like (UML), Unified Modeling Language, executable—

further comprising the unit-utilities-#of—pleadable-26 ⋅: Σ(∇ƒ=⇒)Π-17 ⋅;
1; as, principles-83 ⋅, conditional expectation composition-72 ⋅;
   1 . . . as, —[apparatus novice, dpix-utility Driver-112 ⋅]-[semantics-68 ⋅; phrase-71 ⋅; collectivity-73 ⋅]—composition-72 ⋅, (principles-83 ⋅), —derivatives-74 ⋅,
      1 . . . where [!Important—calculus-43 ⋅],
2; where—pleadable-26 ⋅; as, [extrapolation];
   1 . . . herein the pleadable-26 ⋅ invention text embodiment for understanding human language technology and/or natural language information . . . ,
   2 . . . where in-part as, for understanding, extrapolation implies or equates the/a datum information point derived,
   3 . . . where in-part as, the/a datum information point derived, is the subject of the composition-72 ⋅, of inference-75 ⋅,
3; where conceptively, the subject of the composition-72 ⋅,
   1 . . . and the regarding an acquired image of inference-75 ⋅,
      1 . . . a droplet of water, H₂O,
         . . . 1 . . . and therefore are represented by a group of dpix-93 ⋅—derivatives-74, collectivity-73 ⋅;
4; which; —differs from the following,
   1 . . . where conceptively, the subject of the composition-72 ⋅, and
      1 . . . regarding an acquired image of inference-75 ⋅, table salt and barium oxide, are NaCl and BaO. respectively,
         . . . 1 . . . and therefore are differently represented by a group of
         . . . 1. dpix-93 ⋅—derivatives-74 ⋅, collectivity-73 ⋅;
5; however; —collectivity-73 ⋅;
6; where conceptively, [the understanding], understanding human language technology and/or natural language information . . . ,
   1 . . . where regarding an acquired image of inference-75 ⋅, the/a datum information point derived, H₂O, and NaCl and BaO,
      1 . . . could therefore represent salt water
         . . . 1 . . . by a single or group of dpix-93 ⋅—derivatives-74 ⋅, collectivity-73 ⋅;
7; where a ‘pertaining’ that is derived from another ‘pertaining’, composition-72 ⋅,
8; where—pleadable-26 ⋅; as, conditional expectation,
   1 . . . a ‘pertaining’ that is derived from another ‘pertaining’, composition-72 ⋅,
      1 . . . as, [apparatus novice, dpix-utility Driver-112 ⋅], —derivatives-74 ⋅, collectivity-73 ⋅; created by arranging several things to form a unified whole, that which something is composed, the spatial property
      2 . . . resulting from the arrangement of parts in relation to each other and to the whole/part/in-part derivatives-74 ⋅, and
9; where as, reference verbiage, are cross referenced with references,
   1 . . . and/or cross references indexed numbers/numerics/words that bears the same immanent “meaning”, subjective . . . ,
   2 . . . always herein to interpretation of the applicant
   3 . . . and not to be construed as errors and omissions by the reader interpretation of the process of conceiving, specifying, designing, programming, documenting, testing,
   4 . . . and bug fixing involved in creating and maintaining applications, frameworks, or other components,
      1 . . . where Software development is a process of writing and maintaining the source code, but in a broader sense, it includes all that is involved between the conception of the desired software through to the final manifestation of the software, sometimes in a planned and structured process.
         . . . 1 . . . Therefore, software development may include research, new development, prototyping, modification, reuse, re-engineering, maintenance, or any other activities that result in software products,
   2 . . . where Software can be developed for a variety of purposes of a specific case with custom software, to meet a perceived need of some set of potential embedded software development, that is, used for controlling required development process to be integrated with the development of the controlled physical product, in the act of describing;
      . . . 1 . . . dpix-93 ⋅—dpixelens-142 ⋅ and, system software underlies applications and the programming process itself,
      . . . 2 . . . and is often developed separately. Critical core pleadable-26 ⋅ of this patent abstract is the output visual tangable-91 ⋅, in the pleadable-26 ⋅ act of describing a process to be integrated with the development of the controlled physical product;
         1. dpix-93 ⋅—dpixelens-142 ⋅, collectivity-73 ⋅;
      . . . 3 . . . where—inclusive; —dpix-93 ⋅; as, —[inclusive; dpix-93 ⋅, dpixel-92 ⋅, dpixelive-92 ⋅, dspixel-92 ⋅], collectivity-73 ⋅; as, —[!Important—calculus-43 ⋅], thus,
      . . . 4 . . . where—inclusive; —output visual tangable-91 ⋅; as, —inclusive; dpix-93 ⋅, collectivity-73 ⋅, in-part referenced as, in the pleadable act of describing; dpix-93 ⋅—dpixelens-142 ⋅, collectivity-73 ⋅;
      . . . 5 . . . where—inclusive; Σ(∇ƒ=⇒)Π-17 ⋅; as, conditional expectation composition-72 ⋅,
10; [inclusive; apparatus novice, dpix-utility Driver-112 ⋅], as, (principles-83 ⋅),
   1 . . . where; —in-part—Σ(∇ƒ=⇒)Π-17 ⋅; as, conditional expectation;
      1 . . . [a ‘pertaining’ that is derived from another ‘pertaining’], composition-72 ⋅,
         . . . 1 . . . where in-part as, Σ; implies;
         . . . 1. where Σ sigma summation—sum of all values in range of series;
         . . . 1 . . . where expression-69 ⋅, Σxi=x1+x2+ . . . +xn
11; where in-part as, [ ]; implies; brackets calculate expression-69 ⋅ inside first; expression-69 ⋅ [(1+2)*(1+5)]=18
12; where in-part as, ( ); implies; parentheses calculate expression-69 ⋅ inside first; expression-69 ⋅, 2*(3+5)=16
13; where in-part as, ∇; implies; nabla/del gradient/divergence operator; expression-69 ⋅, ∇ƒ(x,y,z)
14; where in-part as, ƒ; implies; ƒ function of (x) maps values of x to ƒ(x), ƒ(x)=3x+5 or ƒ(x) probability density function (pdf) P(a≤x≤b)=∫ƒ(x) dx
15; where in-part as, =; implies; implied conditional expectation
16; where in-part as, Π; implies; capital pi product—product of all values in range of series; expression-69 ⋅, Πxi=x1+x2+ . . . +xn

further comprising the unit-utilities-#of; [dpix-93 ⋅];
1; wherein “infinity-36 ⋅ ( [symbol] )-37 ⋅ infimum-38 ⋅”; —[“mark-48 ⋅ doppler-49 ⋅ shift-50 ⋅” ]-[non-zero dimension]; inclusive as, —derivatives-74 ⋅—[collectivity-73 ⋅], [!Important—calculus-43 ⋅] as, pleadable-26 ⋅;
2; wherein—“infinity-36 ⋅ ( [symbol] )-37 ⋅ infimum-38 ⋅”; as, —[mark-48 ⋅ ( [symbol] )-37 ⋅- [symbol] -baseline—primal-52 ⋅ [symbol] -dspixel-92 ⋅/sphere-55 ⋅-collectivity-73 ⋅]-“fore (infinity 36 ⋅ ( [symbol] )-37 ⋅ infimum-38 ⋅) aft”—object/objective [symbol] -baseline horizon±(primal-52 ⋅ [symbol] -∠), [1 . . . ]—inclusive; —dpix-93 ⋅; as, —[!Important—calculus-43 ⋅],
3; wherein—infinity-36 ⋅; as, —line of sight/site-51 ⋅,
4; wherein—( [symbol] )-37 ⋅; as, — [symbol] -baseline—primal-52 ⋅ [symbol] —dspixel-92 ⋅/sphere-55 ⋅-inferential-76 ⋅ reasoning principles-83 ⋅, —metric-45 ⋅—orb-like-39 ⋅—subset-42 ⋅ calculus-43 ⋅ collectivity-73 ⋅, (dspixel-92 ⋅—geographical area of the sphere-55 ⋅) dpix-intracellular-98 ⋅, “fore (infinity-36 ⋅ ( [symbol] )-37 ⋅ infimum-38 ⋅) aft”-object/objective [symbol] -baseline horizon±(primal-52 ⋅ [symbol] -∠)—“mark-48 ⋅ doppler-49 ⋅ shift-50 ⋅”, a [symbol] -baseline, primal-52 ⋅, and a sphere-55 ⋅, inclusive with a zenith and nadir divided by a horizon line,
5; wherein—infimum-38 ⋅; as, —the greatest element of the containing set that is smaller or equal to all elements of the subset-42 ⋅,
6; wherein—orb-like-39 ⋅; as, —[spherical-56 ⋅—(ball)], object/objective to mark-48 ⋅,
7; wherein—orb-40 ⋅; as, —[spherical-56 ⋅—(ball)], object/objective to; subset-42 ⋅,
8; wherein—orb-fluency-41 ⋅; as, —[spherical-56 ⋅—(trajectory)], object/objective to; subset-42 ⋅,
9; wherein—subset-42 ⋅; as, —[dpixel-92 ⋅ metric-45 ⋅—(calculus-43 ⋅)] member set within another set,
10; wherein—calculus-43 ⋅; as, —[(subset-42 ⋅)—(metric-45 ⋅)] with limits, differentiation and integration of functions preparation-44 ⋅,
11; wherein—preparation-44 ⋅; as, —[“infinity-36 ⋅ ( [symbol] )-37 ⋅ infimum-38 ⋅”—(metric-45 ⋅)] is performed according to an order of operations, as, dpixel-92 ⋅-metric-45 ⋅—(subset-42 ⋅) calculus-43 ⋅,
12; wherein—metric-45 ⋅; as, —a system of related measures that facilitates the quantification of a calculus-43 ⋅,
   1 . . . wherein the dpix-93 ⋅, dpixel-92 ⋅, dpixelive-92 ⋅, dspixel-92 ⋅ particular characteristic is composed software coding, decoding methods,
13; wherein—metric-fluency-46 ⋅; as, —a system of related measures that facilitates the quantification of a calculus-43 ⋅,
   1 . . . wherein the dpix-93 ⋅, dpixel-92 ⋅, dpixelive-92 ⋅, dspixel-92 ⋅ particular characteristic is composed software coding, decoding methods of unconstrained, flowing smoothly in movement within an orb/orb-like-39 ⋅, subset-42 ⋅, calculus-43 ⋅,
   2 . . . thus a subjective metric is a system of related measures that facilitates the quantification of some particular characteristic,

further comprising the unit-utilities-#of;
1; wherein [“mark-48 ⋅ doppler-49 ⋅ shift-50 ⋅”]-[semantics-68 ⋅; phrase-71 ⋅; collectivity-73 ⋅]-[non-zero dimension];
   1 . . . where—“mark-48 ⋅ doppler-49 ⋅ shift-50 ⋅”; as, —[inclusive; “mark-48 ⋅ doppler-49 ⋅ shift-50 ⋅” ]-[non-zero dimension]—(for mark-up and index formatting, attach a tag or label to, detect and remember), collectivity-73 ⋅,
      1 . . . where inclusive; —“mark-48 ⋅ doppler-49 ⋅ shift-50 ⋅”: as. —[to the acronym: ( [symbol] )-37 ⋅— [symbol] -baseline, primal-52 [symbol] , sphere-55 ⋅] (orb-like-39 ⋅ ball), objective [symbol] -baseline mark-48 ⋅ via zenith and nadir; (primal-52 ⋅ [symbol] )=zenith-nadir÷by a horizon line: or/if as, a focal-plane-126 ⋅, therefore (360/180°) or/if as, orb-like-39 ⋅, therefore spherical angle (∠=AOB=180°),
2; wherein—mark-48 ⋅; as, —non-zero dimension—(for mark-up and index formatting, attach a tag or label to, detect and remember)—as,
   1 . . . where primal-52 [symbol] ∠; zenith-nadir÷by a horizon; equates the/a datum information point derived measurement or research assignment of an address.
3; wherein—doppler-49 ⋅; as, —[mark-48 ⋅ ( [symbol] )-37 ⋅- [symbol] -baseline—primal-52 ⋅ [symbol] -dspixel-92 ⋅/sphere-55 ⋅]-[acronym: ( [symbol] )-37 ⋅]-[ [symbol] doppler-49 ⋅ shift-50 ⋅ [symbol] , [symbol] -baseline, primal-52 ⋅, sphere-55 ⋅] off-set from primal-52 ⋅ [symbol] L site-51 ⋅;
   1 . . . where progressive for “non-zero dimension”, (for mark-up and index formatting, attach a tag or label to, detect and remember),
      “mark-48 ⋅/doppler-49 ⋅/shift-50 ⋅”,
   2 . . . where ontologies: (computing) a rigorous and exhaustive organization of dpixel-92 ⋅ knowledge domain that usually corresponds to the index hierarchical and contains all the relevant entities and their relations that comprises the external attributes mapping the variable datum item ID that can later be used as
   3 . . . where Output: the set best for “mark-48 ⋅ doppler-49 ⋅ shift-50 ⋅” field attributes, that comprises the external attributes,
   4 . . . where (the acronym; doppler; the datum point that scans the geographical area of the sphere-55 ⋅ for subset-42 ⋅ members and those members within other subsets of a sphere-55 ⋅ of the geographical area),
4; wherein—shift-50 ⋅; as, —attributes mapping the variable datum item ID field attributes that comprises attributes that are used as an off-set from the primal-52 ⋅ site-51 ⋅,
5; wherein— [symbol] -site-51 ⋅; as, —primal's-52 ⋅ physical position in relation to the surroundings, [symbol]
6; wherein—primal-52 ⋅ [symbol] ; as, —serving as an essential component, in an original stage/state,
7; wherein-vertex-53 ⋅∠; as, —point/node of intersection of lines,
8; wherein—tri-vertex-54 ⋅∠; as, —node ∠-3 pt-perspective component—manifolds;
   1 . . . where A set of node-points such as those of a closed surface or an analogue in three or more dimensions,
   2 . . . where node combine or increase several or many times,
9; wherein—sphere-55 ⋅; as, —(dspixel-92 ⋅—dimensional in shape—spherical-56 ⋅ (orb-like-39 ⋅ ball), object/objective to mark-48 ⋅), [dpixel-92 ⋅ metric-45 ⋅ —(calculus-43 ⋅)] that includes the sphere-55 ⋅ and everything inside the sphere-55 ⋅, suggestively; infer-axiom, all points with a distance equates less than ·φ·π·r·—(radians, radius, radii) from the given point, where the fore-implied as a focal-plane-126 ⋅ image, except as otherwise annotate, inclusive, geographical area of the sphere-55 ⋅
10; wherein—spherical-56 ⋅—dspixel-92 ⋅-dimensional in shape, sphere-55 ⋅ (orb-like-39 ⋅ ball)
11; wherein—sphericity-57 ⋅; as, —dspixel-92 ⋅—geographical area of the sphere-55 ⋅, and geographical area sphericity-57 ⋅ [set, mark, draw, boundaries]
12; wherein—as, prelude further comprising the Unit-utility of holomorphic-100 ⋅;

further comprising the unit-utilities-#of; [translucent-lase-59 ⋅, doppler-49 ⋅]
1; where—lase-60 ⋅; as, —acronym for light amplification by stimulated emission,

where—symmetry-61 ⋅; as, —[sphere-55 ⋅], reflection of a primal-52 ⋅ [symbol] , reflection of opposite sides of a primal-52 ⋅ [symbol] , subset-42 ⋅, from within (like a two sided sphere mirror) from without, or reflective as “back to back”,
1; wherein—symmetry-pri-62 ⋅; as, —[ . . . with divergence]—moving away from a common point in an infinite series to; mark-48 ⋅ ·> to/from <· mark-48 ⋅, primal-52 ⋅ [symbol] ,
2; wherein—symmetry-dc-63 ⋅; as, —[ . . . with divergence/convergence]—moving away/to a point in an infinite series resiling to the original position; mark-48 ⋅ ·> to/from <· mark-48 ⋅, primal-52 ⋅, sphericity-57 ⋅, doppler-49 ⋅ shift-50 ⋅,
3; wherein—symmetry-geo-64 ⋅; as, —[geographical area sphericity-57 ⋅]—moving from a point in an infinite series resiling to the original position; mark-48 ⋅ ·> to/from <· mark-48 ⋅, primal-52 ⋅, sphericity-57 ⋅, doppler-49 ⋅ shift-50 ⋅,
4; wherein—symmetry⋅outshpr-65 ⋅; as, —[outer-sphere area sphericity]—moving from a point in an infinite series resiling to the original position; mark-48 ⋅ ·> to/from <· mark-48 ⋅, primal-52 ⋅, sphericity-57 ⋅, doppler-49 ⋅ shift-50 ⋅,
5; wherein—symmetry⋅inshpr-66 ⋅; as, —[inner-sphere area sphericity]—moving away a point in an infinite series resiling to the original position; mark-48 ⋅ ·> to/from <· mark-48 ⋅, primal-52 ⋅, sphericity-57 ⋅, doppler-49 ⋅ shift-50 ⋅,

further comprising the Unit-utility of expression-69 ⋅; as,
1; wherein [phrase-71 ⋅; phrase(d)-71 ⋅] (artifact-70 ⋅) group of mathematical formulation statements/words that are considered as a single unit making a mathematical statement,
2; wherein further comprising the Unit-utility of artifact-70 ⋅; as, [man-made object taken as a whole], adhering to Computing—(software development), one of many kinds of tangible by-products produced during the development of software achieve virtual artifact-70 ⋅; computability, with an object in a digital environment design of software modeling,
3; wherein—phrase-71 ⋅ phrase(d)-71 ⋅; as, —whose meanings cannot be inferred from the meanings of the words that make it up, herein, as artifact-70 ⋅ is one of many kinds of tangible by-products produced during the development of software that help describe the function, architecture, and design of software modeling—executable—execute-Driver-117 ⋅,
4; wherein—composition-72 ⋅; as, —[collectivity-73 ⋅]-[expression-69 ⋅]-[phrase-71 ⋅ phrase(d)-71 ⋅]; as, ‘pertaining’ that is derived from another ‘pertaining’,
5; wherein—collectivity-73 ⋅—[expression-69 ⋅]-[phrase-71 ⋅ phrase(d)-71 ⋅] inclusive as whole/part/in-part derivatives-74 ⋅, as, all the subjective (logic) reason by deduction to complete actions required involving inference-75 ⋅ principles-83 ⋅ of the implied graphic image—FIG. 2—(Source Output), as, the collective sum; aggregate or mass of anything specifiable, —in-part; —the expected number of trials needed to collect a complete set of n different objects when picked at random with repetition, using ‘method and means’ as compare progressive for “non-zero dimension” (for mark-up and index formatting), used in-part reference, a mass of storage information accessible by a ‘search’ method supported with . . . , cognition collectivity-73 ⋅ embodiment, applicable for dpixelens-142 ⋅, AI Logic; —(cognition collectivity-73 ⋅ result in perception, learning and reasoning),
6; wherein—derivatives-74 ⋅—[collectivity-73 ⋅]—inclusive as whole/part/in-part, the result of mathematical differentiation; the instantaneous change of one quantity relative to another; df(x)/dx−(derived function/differential coefficient), dpix-93 ⋅ and its derivatives-74 ⋅, inclusive; —output visual tangable-91 ⋅ collectivity-73 ⋅ as dpix-93 ⋅;
   1 . . . where—inclusive; —result of mathematical differentiation; the instantaneous change of one quantity relative to another; df(x)/dx−(derived function/differential coefficient),
   2 . . . where—inclusive; —subjective-derivatives-74 ⋅ within the mind and modified by individual bias; inclusive, —a ‘pertaining’ that is derived from another ‘pertaining’—(linguistics/derived function/differential coefficient),
7; wherein—inference-75 ⋅; as, —[principles-83 ⋅, collectivity-73 ⋅], reasoning involved in drawing a conclusion or making a logical judgment on the basis of circumstantial evidence and prior conclusions rather than on the basis of direct observation,
8; wherein—inferential-76 ⋅; as, —[metric-45 ⋅], implies in-part as in, —[‘fore’·>( [symbol] )-37 ⋅<·‘aft’, line of site-51 ⋅], as, in, along or relating to a line of instance of visual perception, must travers through an “infinity-36 ⋅ ( [symbol] )-37 ⋅ infimum-38 ⋅”, of ‘fore’ and ‘aft’, —metric-45 ⋅, ƒ·>|x:y|<· equates [(ƒ∘g) function composition-72 ⋅], further, [“inferential-76 ⋅ reasoning”, principles-83 ⋅, inference-75 ⋅, collectivity-73 ⋅] reasoning involved in drawing a conclusion or making a logical judgment on the basis of circumstantial evidence and prior conclusions rather than on the basis of direct observation, thus a subjective metric is a system of related measures that facilitates the quantification of some particular characteristic,
9; where—Unit-utility of-77 ⋅; as, —[inference-75 ⋅, non-defined]; as, [inclusive]
10; where—Unit-utility of-78 ⋅; as, —[inference-75 ⋅, non-defined]; as, [inclusive]
11; where—Unit-utility of-79 ⋅; as, —[inference-75 ⋅, non-defined]; as, [inclusive]
12; wherein—aberration-80 ⋅; as, —[dpix-93 ⋅] markedly different from the norm,
13; wherein—spatiotemporal-81 ⋅; as, —coherence-82 ⋅, relating to space and time together, four-dimensional coordinate system (three dimensions of space and one of time, measured in both resistance and distance) in which physical events are located,
14; wherein—coherence-82 ⋅; as, —[spatiotemporal-81 ⋅] logical, orderly, and consistent relation of parts cohering,
15; wherein—principles-83 ⋅; as, —[in-part of the embodiment] (Source Input)—newPlaneXsphere-101 ⋅=dpixel-quadrant-99 ⋅—(Source Output), as, conditional expectation composition-72 ⋅—as in, apparatus novice, dpix-utility Driver-112 ⋅, as, further, (principles-83 ⋅),
16; wherein; —in-part—Σ(∇ƒ⇒)Π-17 ⋅; as, conditional expectation; [as previously comprised], composition-72 ⋅,
17; wherein—output visual tangable-91 ⋅; as, dpix-93 ⋅, collectivity-73 ⋅, —further in-part referenced as, conditional expectation composition-72 ⋅—[inclusive; apparatus novice, dpix-utility Driver-112 ⋅], as, (principles-83 ⋅),

further comprising the unit-utilities-#of; [dpix-93 ⋅; dpixel-92 ⋅; dpixelive-92 ⋅; dspixel-92 ⋅]-[semantics-68 ⋅; phrase-71 ⋅; collectivity-73 ⋅]—inclusive; dpixel value-94 ⋅;
1; wherein—dpix-93 ⋅; as, —[inclusive; dpix-93 ⋅, dpixel-92 ⋅, dpixelive-92 ⋅, dspixel-92 ⋅], as, transition of the digital pixel aberration convergence as in, dspixel-92 ⋅—dimensional in sphere-55 ⋅ subjective to the term dpix-intracellular-98 ⋅ equates a descriptive value datum,
2; wherein—dpixel value-94 ⋅; as, —[the apparatus novice unit-utility, takes a sensor pixel value^{ref}-94 ⋅, referent and returns—dpixel value-94 ⋅],
   1 . . . where related to “the viewing/display optic”, in digital imaging, a pixel, pel, dots, or picture element is a physical point in a raster image, or
   2 . . . where the smallest addressable element in an all points addressable display device; so it is the smallest controllable element of an (image, picture, display) newPlane-97 ⋅ represented,
   3 . . . where—newPlane-97 ⋅; as, —[display, layer, dpixel value-94 ⋅], geometry of 2-dimensional figures geometry of 2-dimensional figures inherent with spatiotemporal-81 ⋅ coherence-82 ⋅ property having dimensions/time/mass/cognitive content;
   4 . . . where range of what has been perceived, discovered, learned, or hypothetical hypothesis, subjective to cognitive dissonance; conflicting ideas simultaneously, subsequently to capture original optic-118 ⋅,
   5 . . . where upon request of the—apparatus novice, dpix-utility Driver-112 ⋅ through the (I/O), the CPU physical hardware, or memory storage device referred with inferential-76 ⋅ reasoning metric-45 ⋅, (logic) of reasoning;
   6 . . . where proceeding from general premisses to a necessary and specific conclusion, based on interpretation; with/without acronyms; dpix-93 ⋅, dpixel-92 ⋅, dpixelive-92 ⋅, dspixel-92 ⋅ of the digital pixel aberration-80 ⋅ convergence as in—Xsphere [dimensional in sphere-55 ⋅—shape pixel subjective], to the term dpix-intracellular-98 ⋅ body equates an infinity of a body/bodies inside a body of a body descriptive value datum comprised in-part—newPlaneXsphere-101 ⋅=dpixel-quadrant-99 ⋅,
   7 . . . where other applied discipline substance subject matter spatial property related to the visual perceivedness rationality dimensional dpix-intracellular-98 ⋅ bodies,
      1 . . . where as a (ball) sphere-55 ⋅, inclusion, =dpixel-quadrant-99 ⋅, [cube (quadrant)],
      2 . . . will suggest visual perceivedness rationality mark-48 ⋅ dpixel-92 ⋅ datum in one or more methods,
3; wherein—dpix-intracellular-98 ⋅; as, —infinity of body/bodies inside a body of a body,
4; wherein—dpixel-quadrant-99 ⋅; as, —newPlane-97 ⋅ (embodiment), Xsphere—[plane versus face, spatial property is added]; and as, —[no matter squared; calculus-43 ⋅ without a descriptive value datum,
   1 . . . where however is a rationality dimensional dpix-intracellular-98 ⋅ body], Xsphere equates dpixel-quadrant-99 ⋅ [dimensional in sphere-55 ⋅], to the term dpix-intracellular-98 ⋅, an infinity of a body/bodies inside a body of a body embodiment,
   2 . . . where therefore, the dpixel-quadrant-99 ⋅—newPlane-97 ⋅ (embodiment)
   3 . . . where foursquare tri-vertex-54 ⋅; (plane rectangle with four equal sides and four tri-vertex-54 ⋅ angles dimensions or aspects; giving the dpixel-quadrant-99 ⋅ depth) fractioned by a zenith-nadir÷by a horizon asymptote,

where—holomorphic-100 ⋅; as, —newPlaneXsphere-101 ⋅=sphericity-57 ⋅, (dspixel-92 ⋅—geographical area of the sphere-55 ⋅) dpix-intracellular-98 ⋅, “fore (infinity-36 ⋅ ( [symbol] )-37 ⋅ infimum-38 ⋅) aft”, as,
1; complex valued and complex differentiable variables introduce functions of several complex variables;
   1 . . . where functional integrals in definition of a quantum field theorem scalar and gauge observables and correlation approaches to perturbative quantum field theory of a infer-axiom line/lines, perception of a ‘straight line’ within “infinity” vector/tensor/vector generalization of the concept of;
2; a straight line segment whose length is magnitude and whose orientation in space is direction,
3; a variable quantity that can be resolved into components,
4; a chosen course or direction of motion,
5; symbolic representation—something visible that by association or convention represents something else that is invisible,
6; asymptote—a straight line that is the limiting value of a curve, can be considered as tangent at infinity,
7; perturb perturbative—a secondary influence on a system that causes it to deviate slightly, interfere with the usual path, of an electron or atom—“the electrons were perturbed by the passing ion”,
8; cause a celestial body to deviate from a theoretically regular orbital motion, especially as a result of interposed or extraordinary pull, expression-69 ⋅, gravitational pull—“The orbits of these dpixs were perturbed by the passings of a hypothetic-dimensional metrics dpix-intracellular-98 ⋅ body”,
9; (programming) a hypothetic-dimensional metrics, based primarily on surmise rather than adequate evidence as best calculated . . . , cognition collectivity-73 ⋅ embodiment, applicable for dpixelens-142 ⋅, AI Logic; cognition collectivity-73 ⋅ result in perception, learning and reasoning,
10; wherein—newPlaneXsphere-101 ⋅=dpixel-quadrant-99 ⋅; as, —[no matter squared; calculus-43 ⋅ without a descriptive value datum,

where, however is a rationality dimensional dpix-intracellular-98 ⋅ body]; as, —plane versus face, spatial property as; pertaining to, involving or having the nature of space; and,
1; newPlane-97 ⋅; —plane versus face, spatial property as; pertaining to, involving or having the nature of space;
2; and as, dpixel-quadrant-99 ⋅—plane versus face, spatial property is added;
3; and as, newPlaneXsphere-101 ⋅—plane versus face, spatial property is added;
4; and as, (encompassing), Xsphere; —as part of a sphere or territory or in whole,
5; and as, dimensionally perception is a plane, flat, outcome holomorphic-100 ⋅],
6; however, with other applied discipline substance subject matter spatial property is related to the visual perceivedness rationality, as any dpix-intracellular-98 ⋅ body found within another (characteristic of certain dimensionally perception) as a ball (sphere) inclusion cube ((⊕ quadrant).
   1 . . . A quarter of the circumference of a circle/ball (sphere);
   2 . . . Any of the four areas into which a plane/cube/circle/ball/sphere, is divided by two orthogonal coordinate axes;
   3 . . . The area enclosed by two perpendicular radii of a circle/ball (sphere);
   4 . . . A measuring instrument for measuring altitude of bodies,
   5 . . . therefore, mark-48 ⋅—[primal-52 ⋅ [symbol] , ∠] zenith-nadir÷by a horizon asymptote, or (glyph symbolic representation ⊕ zenith-nadir÷by a horizon asymptote,)
   6 . . . more comprised as, “fore (infinity-36 ⋅ ( [symbol] )-37 ⋅ infimum-38 ⋅) aft”, equates the/a datum information point derived measurement or research assignment of an address to the quadrant,

further comprising the Unit-utility of [ddp-list]-103 ⋅; acronyms;
ddp-ac-105 ⋅; ddp-m2m-106 ⋅; ddp-m2m·pri·-107 ⋅; ddp-m2m·1×#⋅108 ⋅;
1; wherein also common to the ddp-list-103 ⋅; asynchronously or (digital communication) pertaining to a transmission technique that does not require a common clock between the communicating devices; timing signals could be derived from special characters in the data/datum stream itself,
   1 . . . where—ddp-list-103 ⋅; as, —collectivity-73 ⋅; ddp-ac-105 ⋅; ddp-m2m-106 ⋅; ddp-m2m-pri·-107 ⋅; ddp-m2m·1×#⋅108 ⋅; and as, 2-transition,
   2 . . . meaning in-part, “to-transition”, as, transition of the digital pixel aberration convergence as in, dspixel-92 ⋅—dimensional in sphere-shape pixel,
2; wherein—ddp-ac-105 ⋅; as, — . . . with digital dpixel-analog conversion,
3; wherein—ddp-m2m-106 ⋅; as, — . . . digital dpixel-pass-through, entity relationship pass-through many-to-many datum-data model,
4; wherein—ddp-m2m-pri·-107 ⋅; as, — . . . with digital dpixel-convergence, an approach of an infinite series to a finite limit, mark ·> to/from <· mark primal-52 ⋅ [symbol] , symmetry-61 ⋅,
5; wherein—ddp-m2m·1×#⋅108 ⋅; as, — . . . with digital dpixel-machine to machine, direct communication between
   1 . . . where composition-72 ⋅ “target {output} or request {input}”, any ‘source’
   2 . . . where and/or Import/Load/Open are interchangeable to a display optic-graphic-134 ⋅, that will display the functional action taken by capture retrieve-plane-122 ⋅,
   3 . . . where upon request through the (I/O), the CPU physical hardware, or memory storage device referred, devices, an implementation of Object Management,

further comprising the unit-utilities-#of; system embedded technology-109 ⋅-dpixelens-142 ⋅, dpix-utility Driver-112 ⋅—[semantics-68 ⋅, phrase-71 ⋅, collectivity-73 ⋅, —derivatives-74 ⋅],
1; wherein—apparatus unit-utility-function-110 ⋅; as, —[“novice-utility” function] asset value apparatus,
   1 . . . where; About System Summary/Hardware Resources/Components/Software Environment;
2; [dpix-93 ⋅ Whatis-data/-/dpix-93 ⋅ Whereis-data/-/dpix-93 ⋅ Whois-data]associated/request inf/ini/dpix-getDisplay;
3; upLoad-Driver-137 ⋅, dpix-utility Driver-112 ⋅—execute-Driver-117 ⋅ . . . ;
4; System/System Information/Find system settings drivers/Hardware Resources/Components/Software Environment; . . .
   1 . . . devices—printers/scanners/PnP-monitors, etc, thus, Software Environment/employs all listed system drivers,
   2 . . . inclusive with OLE Registration Program operative information,
   3 . . . further, system embedded technology-109 ⋅—Object, Recognition, Similarity and Matching intersecting points between successive images or
   4 . . . herein after (aka, RSM-object), may be referenced as ‘RSM-o’, using ‘method and means’ as compare progressive for “non-zero dimension”,
   5 . . . for (mark-up and index formatting, attach a tag or label to, detect and remember) “mark-48 ⋅/doppler-49 ⋅/shift-50 ⋅” versus “mark-48 ⋅ doppler-49 ⋅ shift-50 ⋅”, ‘moved tolerance’ architectures FIG. 1—(Source Input) through FIG. 1—(Source Output ∘ Repeat), respectively, in accordance with one or more embodiments of the invention,

where—system embedded technology-109 ⋅; as, —asset dpixelens-142 ⋅—
1; wherein [collectivity-73 ⋅, —derivatives-74 ⋅]—AI Logic, similarity and matching intersecting points between successive—dpix-intracellular-98 ⋅, images or
   1 . . . hereinafter (aka, RSM-object datum, hereinafter may be referenced as ‘RSM-o’)
2; wherein using ‘method and means’ as compare progressive for “non-zero dimension” (for mark-up and index formatting, attach a tag or label to, detect and remember)
   1 . . . “mark-48 ⋅/doppler-49 ⋅/shift-50 ⋅”, versus—
      “infinity-36 ⋅ ( [symbol] )-37 ⋅ infimum-38 ⋅”,
   2 . . . ‘moved tolerance’ doppler-49 ⋅ shift-50 ⋅, relevant; —(having a bearing on or connection with the subject at issue)
   3 . . . about System Summary/Hardware Resources/Components/Software Environment . . . ,
   4 . . . [dpix-93 ⋅ Whatis-data/-/dpix-93 ⋅ Whereis-data/-/dpix-93 ⋅ Whois-data]associated/request inf/ini/dpix-getDisplay;
   5 . . . upLoad-Driver-137 ⋅, dpix-utility Driver-112 ⋅—execute-Driver-117 ⋅; System/System Information/Find system settings drivers/Hardware Resources/Components/Software Environment . . . ,
   6 . . . devices—printers/scanners/PnP-monitors, etc, thus, Software Environment/employs all listed system drivers, inclusive with OLE Registration Program operative information,
3; wherein—dpix-utility Driver-112 ⋅; as, —[utility dpixel-92 ⋅] capture-input-119 ⋅ [(I/O) interface], “target {output} AND request {input}”, uploaded usually from a ROM Drv storage media read-only memory, USB, CD, HD,
4; wherein—dpix-utility sensor-retrieve-113 ⋅; as, —[dpix-utility Driver-112 ⋅] sensor optic-123 ⋅ [(I/O) interface], “target {output} AND request {input}”,
5; wherein—dpix-utility screen-retrieve-114 ⋅; as, —[dpix-utility Driver-112 ⋅] screen optic-124 ⋅ [(I/O) interface], —composition-72 ⋅
   1 . . . where “target {output} AND request {input}”, any ‘source’
   2 . . . where and/or Import/Load/Open are interchangeable to a display optic-graphic-134 ⋅,
      1 . . . where that will display the functional action taken by capture retrieve-plane-122 ⋅ as requested through the (I/O), the CPU physical hardware,
      2 . . . where or memory storage device referred as “target {output} AND request {input}”, —focal-plane-126 ⋅,
6; wherein—Sensor Driver-115 ⋅; as, —[system settings] sensor spec info, (capture-input-119 ⋅),
7; wherein—graphic Driver-116 ⋅; as, —[system settings] graphic spec info, (display-output),
8; wherein—execute-Driver-117 ⋅; as, —[dpix-utility Driver-112 ⋅], layer-captured-plane-127 ⋅,
9; wherein—capture original optic-118 ⋅; as, —[source input]—Image implied captured,
10; wherein—capture-input-119 ⋅; as, —[source input]—implied hardware/software/image,
11; wherein—capture rate-optic-120 ⋅; as, —[1/1 still; 10/1 motion; 32+/1×#vid] captured,
12; wherein—capture original-plane-121 ⋅; as, —[source input—(original)]—Image implied,
13; wherein—capture retrieve-plane-122 ⋅; as, —[source input—(retrieve)]—Image implied—original-121 ⋅ any ‘source’—Import/Load/Open, any induced plane, focal-plane-126 ⋅,
14; wherein—capture sensor optic-123 ⋅; as, —[focal-plane-126 ⋅—pixel imaging sensor],
15; wherein—capture screen optic-124 ⋅; as, —[focal-plane-126 ⋅—graphics processor],

further comprising the unit-utilities-#of; [optic]-[“novice-utility” function] compose, [collectivity-73 ⋅] Object Recognition,
1; wherein hereinafter; (Recognition/Similarity/Matching: aka, RSM-object) datum, may be referenced as ‘RSM-o’;
2; wherein—focal-plane-126 ⋅ presuppose—[capture original optic-118 ⋅]—an original image archived as “background”—
   1 . . . where implies—a source input to an Image Sensor and/or Graphic Processor source input output values and/or any ‘source’ and/or Import/Load/Open, of an induced plane used by methods, apparatus and systems
3; wherein including at least one hardware processor, at least one tangible storage medium (memory), and at least one input/output (I/O) interface of the ‘optical computing system’,
4; wherein prior to; upLoad-Driver-137 ⋅, (I/O port)—Run/driver/unit-utility/sensor/display/output . . . , capture original-plane-121 ⋅,
5; wherein—layer-captured-plane-127 ⋅—[execute-Driver-117 ⋅]—
6; wherein—layer-captured-display-128 ⋅—[display unit-utility output]—display plane
7; wherein—layer-display retrieve-129 ⋅—[source] (inclusive of; Import/Load/Open),

further comprising the unit-utilities-#of; [display optic-133 ⋅]; as,—

focal-plane-126 ⋅—a display novice, dpix-93 ⋅-utility,
1; wherein—display optic-graphic-134 ⋅; as, —focal-plane-126 ⋅—a display unit-utility
2; wherein—display optic-monitor-135 ⋅; as, —focal-plane-126 ⋅—to a monitor
3; wherein—display optic-printer-136 ⋅; as, —focal-plane-126 ⋅—to a printer default

further comprising the unit-utilities-#of; [upLoad-Driver-137 ⋅]—system embedded technology-109 ⋅; as,
1; wherein a novice unit-utility function, compose, [collectivity-73 ⋅] dpix-utility Driver-112 ⋅, inclusive to novice unit-utility function asset value apparatus, dpixelens-142 ⋅,
2; wherein—upLoad-Driver-137 ⋅; as, —[(I/O) interface] prior to; upLoad-Driver-137 ⋅ (I/O port)—Run/driver/unit-utility/sensor/display/output—(Source output)
3; wherein—in-part referenced as, in the pleadable act of describing; dpix-93 ⋅-dpixelens-142 ⋅, collectivity-73 ⋅;
4; wherein—[optic]-[“novice-utility” function] compose, [collectivity-73 ⋅] Object Recognition, hereinafter; aka, RSM-object datum, may be referenced as ‘RSM-o’;

further comprising the unit-utilities-#of; [dpixelens-142 ⋅—AI Logic];
1; an apparatus novice, dpix-utility Driver-112 ⋅—[semantics-68 ⋅; phrase-71 ⋅; collectivity-73 ⋅], (artifact-70 ⋅)—preparation-44 ⋅—derivatives-74 ⋅,—
   1 . . . (annotate; replace lens with dpixelens-142 ⋅ is not a requirement of this apparatus unit-utility-function-110 ⋅, dpix-utility Driver-112 ⋅,
   2 . . . but is suggestive as a source input instrument asset to further enhance this apparatus unit-utility-function-110 ⋅),

where—dpixelens-142 ⋅; as, AI Logic; an asset value apparatus,
1; novice unit-utility, detailed for measuring, recording, and controlling, as needed,
   1 . . . expressed in terms of fundamental quantities like time, mass and length—
   2 . . . implies—a source input instrument—capture original optic-118 ⋅ the image sensor/GPU source input output values, function,
   3 . . . alternatively in a certain way related to “the viewing/display optic”—
   4 . . . the dpixelens-142 ⋅ point2point, doppler-49 ⋅ shift-50 ⋅, —ddp-m2m-pri·-107 ⋅
   5 . . . in preparation-44 ⋅ of dissonance, for AI Logic, conflict opinions, actions/characters,
   6 . . . fixed (one conflict)/v/(motion) unfixed (repeat conflict), through a predetermined cashe and/or page swap file, repeat,
2; further, image implied, FIG. 1 (Source Input), (Input-Output),
   1 . . . see Img, spherical aberration-80 ⋅ prism, replace with dpixelens-142 ⋅,
   2 . . . further, the Image implied, FIG. 1 (Source Input), (Input-Output),
   3 . . . further implies—an apparatus novice unit-utility—dpixelens-142 ⋅
   4 . . . is the subject of novelty of Capture (retrieve) plane,
   5 . . . further comprised as, capture retrieve-plane-122 ⋅;
3; Inclusive—apparatus unit-utility-function-110 ⋅; as, —[“novice-utility” function] asset value apparatus,
4; Inclusive—system embedded technology-109 ⋅; as, —asset dpixelens-142 ⋅-[collectivity-73 ⋅]—AI Logic], Object Recognition, with—[non-zero dimension] mark-48 ⋅ up links,
5; Inclusive with—dpixelens-142 ⋅; as, doppler-49 ⋅; an asset value apparatus. There are factors that algorithms cannot measure, for better or worse,
   1 . . . that are enhanced with the doppler-49 ⋅ asset value apparatus offering some relief from the term, GSP dependance.

Second part of three, [what is Claimed (2) is; #⋅146 ⋅], inclusive;
1; the application comprising instructions for: —generating the bounding nodes of eight children centered with the unit-utility-47 ⋅.

FIG. 2—(Source Output)
1; newPlaneXsphere=dpixel-quadrant (Plane-Layers-1-2-3)—(Source Output)
   1 . . . where—layer-display optic-Layer-1-130 ⋅, —(aka; —Layer-1)
   2 . . . where—layer-display optic-Layer-2-131 ⋅, —(aka; —Layer-2)
   3 . . . where—layer-display optic-Layer-3-132 ⋅, —(aka; —Layer-3)
further comprising—(annotate; novice, unit-utility dpix-93 ⋅)—[Display], graphic Driver-116 ⋅, system settings, graphic spec info, display-output, capture-input-119 ⋅. A graphics processing unit (GPU), aka: capture screen optic-124,
1; is a specialized electronic circuit designed to rapidly manipulate and alter memory to accelerate the creation of images in a frame buffer intended for output to a display device. GPUs are used in embedded systems, mobile phones, personal computers, workstations, and game consoles.
2; Modern GPUs are very efficient at manipulating computer graphics and image processing, and their highly parallel structure makes them more efficient than general-purpose CPUs for algorithms where the processing of large blocks of data is done in parallel.
3; In a personal computer, a GPU can be present on a video card, or it can be embedded on the motherboard or/in certain CPUs-on the CPU die. [Refer: in-part—https://wikipedia.org/wiki/Graphics processing unit, aka, capture screen optic-124 ⋅]

further comprising, the novice unit-utility—dpix-93 ⋅;
1; but not limited to the aberration-80 ⋅, phrase(d)-71 ⋅, collectivity-73 ⋅
2; unit-utility herein comprised, instantiation of the shapes as vector outlines, and/or other venues of the same, protect a dpix-93 ⋅ particular characteristic by code that produces them,
3; designed for general support of the processes of a computerized source input to an Image Sensor and/or Graphic Processor source input output values—composed of one or more pieces of equipment connected to or part of the structure and designed to provide the “novice-utility” function . . . ,
4; where the apparatus novice unit-utility, input to the image Graphic Processor integrates—inferential-76 ⋅ reasoning metric-45 ⋅—pixel values as a sphere-55 ⋅-orb-like-39 ⋅, “infinity-36 ⋅ ( [symbol] )-37 ⋅ infimum-38 ⋅”,
   1 . . . making the processor function alternatively in a certain way related to output of FIG. 2; —implied—layer-display retrieve-129 ⋅;
      1 . . . as . . . , (X0,Y0)-(XH,Y0)-(X0,YV)-(XH,YV) . . . ,

hereinafter implies—FIG. 2—(Output)
1; wherein—layer-display optic-Layer-1-130 ⋅, —the monitor area—optic display (brand name) monitor with an original image archived as “background”—implies—capture screen optic-124 ⋅,
   1 . . . where; (Layer-1), suggests in pixel measurement,
      1 . . . where; (1920×1080) resolution of a monitor display (Layer-1) with 4/90° vertex-53 ⋅
      2 . . . where; ∠: —(X0,Y0)-(XH,Y0)-(X0,YV)-(XH,YV) . . . ,
2; wherein—layer-display optic-Layer-2-131 ⋅, —layer-composed “new-Plane—radii”-herein implies—FIG. 2—(Source Output)—(Layers-1-2), —layer-captured-display-128 ⋅;
   1 . . . where; (Layer-2), suggests in pixel measurement,
      1 . . . where; (1080×1080) resolution of a ‘(new-Plane—radii)’ (Layer-2)—
      2 . . . where; Z: —(XA,Y0)-(XB,Y0)-(XA,YV)-(XB,YV),
      3 . . . where; composed capture—with 4/90° tri-vertex-54 ⋅ node Z, inclusive with a radii sphericity-57 ⋅, geographical area, output,—
      4 . . . where; (annotate critical: see graphic image—
         . . . 1 . . . where FIG. 2—(Source Output)—(Layers-1-2)—radii),
3; wherein—layer-display optic-Layer-3-132 ⋅, —layer-captured-plane-127 ⋅ ‘new-Plane’—herein implies—FIG. 2—(Source Output)—(Layers-1-2), layer-captured-display-128 ⋅,
   1 . . . where; (Layer-3), suggests in pixel measurement;
      1 . . . where; (1080×1080) resolution of a, ‘new-Plane’—(Layer-2)—
      . . . 1 . . . where (XA,Y0)-(XB,Y0)-(XA,YV)-(XB,YV) . . . ,
      . . . 2 . . . where composed capture—with 4/90° tri-vertex-54 ⋅ node Z, inclusive within the geographical area sphericity-57 ⋅, is the subset-42 ⋅, subjectively pre-comprised; the Image implied,
      . . . 3 . . . where FIG. 1 (Source Input), (Input-Output), a silhouette digit pixel person,
   2 . . . where; and projected through to
      1 . . . FIG. 2—(Source Output), (Layer-3)—captured,
      2 . . . similarity of any/all source input output values Graphic Processor and/or Image Sensor and/or any ‘source’ of an induced plane display (output)—
      3 . . . (annotate critical: see graphic image—FIG. 2—(Source Output)
   3 . . . where; prior to; focal-plane-126 ⋅, layer-captured-plane-127 ⋅, execute-Driver-117 ⋅—graphics processor by default through the—(I/O) interface,
   4 . . . where; that achieved the source input from the Graphic Processor—graphic Driver-116 ⋅, system settings, graphic spec info, —display optic-graphic-134 ⋅, focal-plane-126 ⋅, of an original image archived as “background”—
      1 . . . implies—a source input to an Image sensor output values and/or Graphic Processor and/or any ‘source’,
      2 . . . inclusive of; Import/Load/Open, of an induced plane used by methods, apparatus and systems including at least one hardware processor, at least one tangible storage medium (memory), and at least one (I/O) interface of the ‘optical computing system’ . . . ,
         . . . 1 . . . prior to; upLoad-Driver-137 ⋅,
      3 . . . where thereafter, components of the methods of interaction—making the display optic-graphic-134 ⋅,
      4 . . . operate alternatively in a certain way related to “the viewing display optic”, digital/raster, as in; camera, cell phone, tablet, display monitor and/or television screen-monitor, AR (Augmented Reality), VR (Virtual Reality) and/or projection display methods,
      5 . . . with digital dpixel-analog conversion, ddp-ac-105 ⋅, inclusive with ddp-list-103 ⋅,
      6 . . . but not limited to the declared unit-utility to where the—graphic Driver-116 ⋅ [system settings] graphic specifications information stored with the pixel value^{ref}-94 ⋅ referent to integrate adaptively for—inferential-76 ⋅ reasoning metric-45 ⋅,
   5 . . . where; that link FIG. 2—(Source Output)—(Layers-1-2), from—(Source Input);
      1 . . . as a layer-display retrieve-129 ⋅ output to pixel value^{ref}-94 ⋅
      2 . . . as per; −ƒ(x)·φ·π·r·, ∴=spherical-56 ⋅ object/objective of “infinity-36 ⋅ ( [symbol] )-37 ⋅ infimum-38 ⋅”, “mark-48 ⋅ doppler-49 ⋅ shift-50 ⋅”,
      3 . . . a [symbol] -baseline, primal-52 ⋅ [symbol] =zenith-nadir—by a horizon line: 360/180°/or/orb-like-39 ⋅, spherical angle (∠=AOB=180°) symmetry)),
   6 . . . where; as per FIG. 1—(Source Input);
      1 . . . the novice—apparatus unit-utility-function-110 ⋅, adaptively optimizing a “source” in a real time step capture rate-optic-120 ⋅, —precomprised layer-display optic, Layer-1-130 ⋅—the viewing display optic—capture screen optic-124 ⋅ . . . ,
   7 . . . where; the apparatus aberration-80 ⋅ phrase(d)-71 ⋅ novice unit-utility,
      1 . . . further there are no claim to numeric formulas individually herein expressed, (except as reference of the invention text embodiment for understanding human language technology and/or natural language information) . . . ,
      2 . . . prior to; upLoad-Driver-137 ⋅ (I/O port)—Run/driver/unit-utility/sensor/display/output, layer-display retrieve-129 ⋅—
      3 . . . where thereafter, components of the methods of interaction—expressed in part as following; —dpix-93 ⋅ (dpixelive-92 ⋅, dspixel-92 ⋅, dpixel-92 ⋅)—“infinity-36 ⋅ ( [symbol] )-37 ⋅ infimum-38 ⋅”,
      4 . . . and the numeric formulas and numbers of—metric-45 ⋅-metric-fluency-46 ⋅ that facilitates the quantification of a subset-42 ⋅ calculus-43 ⋅,

the apparatus novice unit-utility resides with the methods or arrangements for coding, decoding,—
1; wherein
   1 . . . the novelty, dpix-93 ⋅ particular characteristic as composed, subjectively, within this abstract of content and images of the patent application, and suggested collectively by definitions marked as aberration-80 ⋅ phrase(d)-71 ⋅,
   2 . . . a dpixel value-94 ⋅, for, FIG. 3—(analogous Output), embodiment of the invention is specific oriented,
   3 . . . using part or all the, comprising unit-utilities-#of, compliments the artifact-70 ⋅ (software development), of novice architectures and methods securing the—
   4 . . . caption—apparatus novice, unit-utility-function-110 ⋅, dpix-utility Driver-112 ⋅,
      1 . . . in relation to surroundings or circumstances, of the venue, dpix-93 ⋅,
         . . . 1 . . . inclusive with the principles-83 ⋅ of the (Source Input)—newPlaneXsphere-101 ⋅=dpixel-quadrant-99 ⋅—(Source Output), embodiment, —newPlane-97 ⋅;
   5 . . . as, —[display, layer, dpixel value-94 ⋅],

Drawings, FIG. 2—(Source Output);

herein as, (Input—capture transition from—to display—Output);

Img.—Input—capture transition
1; Img. —where in-part as, the CPU—passes the sensor's pixel image, through to FIG. 2 from FIG. 1;
   1 . . . GPU sample given 128×128 (Pixel Array) pixels of the silhouette digit pixel person, suited with hat, tie, shoes, in part the subset-42 ⋅, that is used as part of a focal-plane-126 ⋅ presuppose image processing capture transition from to a display optic-monitor-135 ⋅ . . . ,
   2 . . . where the display optic-monitor-135 ⋅ is identified by the following aberration-80 ⋅ phrase-71 ⋅ preparation-44 ⋅ in part but not limited of the dpix-93 ⋅ characterizing;
2; wherein as, the CPU—performs logical operations, of data, capture screen optic-124 ⋅, according to programmed instructions required information of the Source input sensor captured to adaptively optimize the optical system at a real time step capture rate-optic-120 ⋅ for output to a display optic-graphic-134 ⋅
   1 . . . where, that generally, is understood to be a type of display optic-monitor-135 ⋅;
   2 . . . where, that will display the functional action taken by capture retrieve-plane-122 ⋅ upon request through the (I/O), the CPU physical hardware, or memory storage device referred as—focal-plane-126 ⋅ . . . ,

Img.—the viewing display optic,
1; wherein, as, the display optic monitor-135 ⋅ whether digital/analog/raster, as in;
   1 . . . where; camera, cell ph., tablet or monitor and/or other users of the sensor image processing circuit,
   2 . . . where; passes the asset value output, back to the CPU, dpix-utility Driver-112 ⋅, comprising—a system of related measures that facilitates the quantification of some particular characteristic (evolvements) of the dpixel-92 ⋅—
      1 . . . where; the asset value output, as target or request of the dpixel-92 ⋅ apparatus unit-utility-function-110 ⋅,
      2 . . . where; simply expressed as monitor, projector, paper, film or other means of a viewing display optic, . . . with digital dpixel-analog conversion, ddp-ac-105 ⋅ deciphering . . . ,

Img. —the dpix-utility Driver-112 ⋅
1; wherein; as, the request—processed and displays all of the metric captured to the display optic-graphic-134 ⋅—
   1 . . . where; display optic-monitor-135 ⋅ a viewing display optic, to adaptively optimize inferential-76 ⋅ reasoning metric-45 ⋅ for a focal-plane-126 ⋅ of the FIG. 1 (Source Input), . . . with digital dpixel-analog conversion, ddp-ac-105 ⋅ deciphering.
   2 . . . where; the Image implied is a silhouette digit pixel person, suited with hat, tie, shoes and projected to FIG. 2—(Source Output), of a viewing display optic,
   3 . . . where; in this content, (Layers-1-2), 1920×1080 pixel, LS—(landscape), resolution in accordance of the compose function composition-72 ⋅ request . . . ,—
   4 . . . where; implies—FIG. 2—(Layer-1)-(X0,Y0)-(XH,Y0)-(X0,YV)-(XH,YV) . . . ,
   5 . . . where; now is the focal-plane-126 ⋅ of the FIG. 1, (Source Input), inclusive of (Input-Output), through to (image), and (output),

Img.—the asset value apparatus dpix-utility Driver-112 ⋅
1; wherein; as, by evaluating the FIG. 2, (Source Output), (Layers-1-2), via, dpix-utility screen-retrieve-114 ⋅, capture screen optic-124 ⋅, layer-display optic Layer-1-130 ⋅ of the FIG. 1, (Source Input), capture sensor optic-123 ⋅ focal-plane-126 ⋅; image, processed pixel value-94 ⋅ referent,
2; wherein; processing the results into a square dimension around the captured image, inclusivity within a dspixel—sphere-55 ⋅—spherical (orb-like ball), object/objective to mark-48 ⋅,
3; wherein; thus the squared image captured becomes the result for the values of ·(x)· to ƒ(x) function of ·(x)· compose function composition-72 ⋅ aberration-80 ⋅ phrase(d)-71 ⋅ preparation-44 ⋅ capture to the graphics CPU utilities directory . . . ,

Img.—as normal program I/O unit-utility tool program
1; wherein; as, venues of the apparatus graphic Driver-116 ⋅ used and displayed—display sensor optic—display optic.
2; wherein; the optical image sensor output values processed pixel value-94 ⋅ referent to adaptively optimize inferential-76 ⋅ reasoning metric-45 ⋅ for a, layer-captured-plane-127 ⋅ Source (output) to the viewing display optic,
3; wherein; projected in FIG. 2, (Layers-1-2) 1920×1080, LS—(landscape), resolution in accordance of the compose function composition-72 ⋅ request that—simulates, dpixelens-142 ⋅ point2point and digital dpixel-analog conversion,
4; wherein; ddp-ac-105 ⋅ deciphering becomes the further result for the values of ·(x)· to ·ƒ(x)· function of ·(x)· compose function composition-72 ⋅, of the
   1 . . . where; silhouette digit pixel person, suited with hat, tie, shoes and
5; wherein; becomes the optic displayed and transposed to (layer-display optic Layer-3-132 ⋅—layer-captured ‘new-Plane’—herein
6; wherein; implies—FIG. 2—(Source Output)—(Layers-1-2), —layer-captured-display-128 ⋅, composed to—
   1 . . . where; suggests in pixel measurement; (1080×1080) resolution of a, ‘new-Plane’—(Layer-2)-(XA,Y0)-(XB,Y0)-(XA,YV)-(XB,YV) . . . , with 4/90° tri-vertex-54 ⋅ node ∠, inclusive within the geographical area sphericity-57 ⋅, is the subset-42 ⋅, subjectively pre-comprised;
7; wherein; the Image implied, FIG. 1 (Source Input), (Input-Output), a silhouette digit pixel person,
8; wherein; and projected through to FIG. 2—(Source Output), (Layer-3)—captured,
9; wherein; similarity of any/all source input output values Graphic Processor and/or Image Sensor and/or any ‘source’ of an induced plane display (output)—
   1 . . . where; (annotate critical: see graphic image—FIG. 2—(Source Output)—(Layer-3)—captured).

Img.—a source input, FIG. 1, (Source Input),
1; wherein; as, inclusive of (Input-Output), through to (image), and (output), —implies—FIG. 2—(Layer-1)-(X0,Y0)-(XH,Y0)-(X0,YV)-(XH,YV) . . . , now is the focal-plane-126 ⋅ of the FIG. 1, (Source Input), inclusive of (Input-Output), through to (image), and (output),

Img.—FIG. 2—(Source Output)—(Layers-1-2)
1; wherein; suggests in pixel measurement (1920×1080-LS) resolution . . . , display optic—monitor—implies—(Layer-1)-(X0,Y0)-(XH,Y0)-(X0,YV)-(XH,YV) . . . ,
   1 . . . where; (Layer-1)—suggests in pixel measurement;
      (X0,Y0)—where (·x·)=0 (·y·)=0
      (XH,Y0)—where (·x·)=horizontal (H) (·y·)=0
      (X0,YV)—where (·x·)=0 (·y·)=vertical (V)
      (XH,YV) where (x)=horizontal (H) (y)=vert. (V)
   2 . . . where; —orientation=(height ·>=width) Portrait: Landscape;
2; wherein; now, compose (1080×1080) resolution of a . . . , “(new-Plane)”—compose capture)—(Layer-2)-(XA,Y0)-(XB,Y0)-(XA,YV)-(XB,YV) . . . ,
3; wherein; as, (Layer-2)—suggests in pixel measurement;
   (XA,Y0)—where (xa=x0 plus H minus V over 2)—90° (tri-vertex node ∠)
   (XB,Y0)—where (xb=x0 plus H minus V over 2 plus V=x0 plus H minus V over 2)—90° (tri-vertex node ∠)
   (XA,YV)—where—90° (tri-vertex node ∠)
   (XB,YV)—where—90° (tri-vertex node ∠)
   1 . . . where; as, parentNode.insert [(XA,Y0), (XB,Y0), (XA,YV), (XB,YV)] value ‘0’ (zero) horizontally and vertically of the plane;
4; wherein; as, (Layer-3)—suggests in pixel measurement; compose capture (Layer-2—new-Plane)—with 4-90° (tri-vertex node ∠), is silhouetted to subset-42 ⋅ with-in a geographical area sphericity-57 ⋅.

Img.—FIG. 2—(Source Output)
1; wherein; as, Source monitor display—(1920×1080) pixel resolution—(Layer-1) 4—90° (vertex ∠): (X0,Y0)-(XH,Y0)-(X0,YV)-(XH,YV)
   1 . . . where; as, Layer-1 optic display (brand name—1920×1080 pixel, diagonal 27″LS) monitor for the Image implied,
   2 . . . where; (the silhouette digit pixel person, suited with hat, tie, shoes) captured by the “Source (Input)”, archived as “background”.
2; wherein; as, Layer-1 optic display, based on the compose function composition-72 ⋅ demonstrate a horizontal (H) measure in the plane and a right angle vertical (V) measure of the plane.
   1 . . . where; as, Layer-1 optic display, based on the compose function composition-72 ⋅ demonstrate,
   2 . . . where; a horizontal (H) measure; —implies—(X0,Y0)-(XH,Y0) . . . ,
   3 . . . where; a vertical (V) measure; —implies—(X0,Y0)-(X0,YV) . . . , of the plane and/or any combination of a horizontal (H) measure and vertical (V) measure thereafter.
3; wherein; as, (new-Plane) display—(1080×1080) resolution—(Layer-2) 4-90° (tri-vertex node ∠): (XA,Y0)-(XB,Y0)-(XA,YV)-(XB,YV)
   1 . . . where; as, the “(new-Plane)”—(Layer-2)—compose capture composition-72 ⋅ —is the first calculus-43 ⋅ for the Image implied,
   2 . . . where; (the silhouette digit pixel person) captured by the “Source (Input)”, archived as “background”,
   3 . . . where; in preparation-44 ⋅ for FIG. 2—(Layers-1-2)—radii geographical area sphericity-57 ⋅ output,
4; wherein; FIG. 2—Layer-2 is the “new composed” captured Layer nodes area of the FIG. 2—(Layer-1), image which is used by FIG. 2—(Layer-2), to adaptively optimize inferential-76 ⋅ reasoning for the (plane) Source (output) in the following method;—
   1 . . . where; compose capture composition-72 ⋅,
   2 . . . where; therefore, the captured is where ƒ(x) maps values of (x) to ƒ(x)—
   3 . . . where; thus the (plane) Source (output), (the silhouette dig it pixel person) captured.
   4 . . . where; as, installation—(asset apparatus unit-utility-function-110 ⋅)—(dpixel-92 ⋅ Sensor Driver-115 ⋅); —upload
5; wherein; as, installation can be done by software update to the image sensor output values—graphics processor hardware/or/program upload device driver for ((display optic)—monitor)—(brand name) software,
   1 . . . where; activated by a—upload composed capture with the dpixel-92 ⋅ Sensor Driver-115 ⋅—
      1 . . . where here implies, pre-loaded instruction of USB drive, activated when plugged into a USB port.

Img.—(Layers-1-2)—radii;

### Implies all of FIG. 2—(Source Output) (Layers-1-2)

1; wherein; and subjectively pre-comprised below as;
   1 . . . where; as, —pre-comprised, (Layers-1-2)
2; wherein; as, —(new-Plane) display—(1080×1080) resolution—(Layer-2) suggests in pixel measurement (display optic—monitor)—(1080×1080) resolution of a composed capture
3; wherein; as, —mark doppler shift infinity prior to spheres; inner, outer, and sphericity;
   1 . . . where; each sphere encompassed into the larger sphere, inclusive of infinity beyond the geo-sphericity influence
   2 . . . where; and inference and/or infer-axiom horizon line plane output . . .
   3 . . . where; with a zenith and nadir divided by a horizon line.
      1 . . . where as, —pixel values as per; ƒ(x), ·π·r, ∴ mark doppler shift [baseline, primal, sphere]=mark-48 ⋅ spherical value ‘0’ (zero) horizontally and vertically
4; wherein; as, —(annotate critical: where φ·π·r·=radians, radius, radii.)
5; wherein; as, —compose capture (1080×1080) pixels)—(Layer-3)—radii—infimum spherical output
6; wherein; as, —(Layer-2)—radii
7; wherein; as, −R=(XA-XB)2+(YV-Y0)2/2
8; wherein; as, —(Layer-2)—(radii) newPlaneXsphere mark—(1080×1080) radii=9.35 inches from the centre to the perimeter geographical area sphericity.
9; wherein; as, —mark value—geographical area sphericity
10; wherein; as, —(value 0=“infinity-36 ⋅ ( [symbol] )-37 ⋅ infimum-38 ⋅”),
11; wherein; as, —dpixel-metric—(in-part) interpolation—extrapolation—inference)
12; wherein; as, —interpolation—calculation of the value of a function between the values already known
13; wherein; as, —extrapolation—calculation of the value of a function outside the range of known values—
   1 . . . where; an inference about the future (or about some hypothetical situation) based on known facts and observations
14; wherein; as, —inference—reasoning involved in drawing a conclusion or making a logical judgment on the basis of
   1 . . . where; circumstantial evidence and prior conclusions
      1 . . . where, rather than on the basis of direct observation
15; wherein; as, —geographical area sphericity
16; wherein; as, —(value 0=“infinity-36 ⋅ ( [symbol] )-37 ⋅ infimum-38 ⋅”), establishes the (value 0, radii), through to the comprised—tri-vertex node ∠-3 pt-perspective component out-corner dpixel node ∠ . . . ,

Img.—(Layer-3)—captured,
1; implies all of FIG. 2—(Source Output) (Layers-1-2),
   1 . . . where; (Layers-1-2)—radii and subjectively pre-comprised;
      1 . . . where; the Image implied, FIG. 1, “Source (Input)”,
         . . . 1 . . . where, a silhouette digit pixel person, and
         . . . 1. where; projected through to FIG. 2—(Layer-3)—captured.

Img.—(Layer-3)—captured, and . . . ,
1; wherein; as, —Graphic Processor and/or Image Sensor and/or any ‘source’ of an induced plane display (output) via—Source . . . , “(capture optic)” . . . ,
   1 . . . where; ((display optic)—monitor)—
      1 . . . where, with 4-90° (tri-vertex node z),
      2 . . . where is silhouetted to subset-42 ⋅
      3 . . . where with-in a geographical area sphericity-57 ⋅,
      4 . . . where composed ref. image sensor, 128×128 pixel array; (metric),
         . . . 1 . . . where each pixel maps values of ·(x)· to ·ƒ(x)· function of ·(x)·—
         . . . 1. where inclusive within (Layer-3).

Img.—geographical area sphericity-57 ⋅,
1; wherein; composed being,
2; wherein; (Layer-1)-(Layer-2)-(Layer-3)—
3; wherein; as above or summarized;
   1 . . . where; as, implies—FIG. 2—
      1 . . . where (Layer-1)-(X0,Y0)-(XH,Y0)-(X0,YV)-(XH,YV) . . . ,
4; wherein; now is the “(new-Plane)”,
5; wherein; aka as the focal-plane-126 ⋅ presuppose of the FIG. 1, (Source Input),
   1 . . . where; inclusive of (Input-Output), through to (image), and (output),
   1 . . . where; through FIG. 2—(Source Output)—(Layers-1-2)
   1 . . . where; —orientation=(height ·>=width) Portrait: Landscape;
   1 . . . where; now, compose (1080×1080) resolution of a . . . ,
      1 . . . where ‘(new-Plane—radii)’—compose capture)—
         . . . 1 . . . where ((Layers-1-2)—radii); (XA,Y0)-(XB,Y0)-(XA,YV)-(XB,YV)
         . . . 2 . . . where . . . , with 4-90° (tri-vertex node Z) with;—
         . . . 1. where as, parentNode.insert [(XA,Y0), (XB,Y0), (XA,YV), (XB,YV)]
         . . . 2. where value ‘0’ (zero) horizontally and vertically of the plane;
         . . . 3. where displaying in-part as, ((Layer-3),
         . . . 4. where herein compose capture is silhouetted to subset-42 ⋅
         . . . 5. where within a radii sphericity-57 ⋅, geographical area, output, influenced by the following;
         . . . 6. where “mark-48 ⋅ doppler-49 ⋅ shift-50 ⋅”—
      2 . . . by association ( [symbol] )-37 ⋅
         . . . 1 . . . where inner sphere of influence
         . . . 2 . . . where outer sphere of influence
      3 . . . geographical (area) sphericity of influence on a given pixel plane with a infinite spherical point—radial orbit//radial symmetry-61 ⋅ orbit intersect as per lobe-projections that are part of the larger convex shape that juts out from the “mark-48 ⋅ doppler-49 ⋅ shift-50 ⋅” ( [symbol] )-37 ⋅—(newPlane-97 ⋅) Source (output) sphere-55 ⋅,
      4 . . . where and “infinity-36 ⋅ ( [symbol] )-37 ⋅ infimum-38 ⋅”;
      5 . . . where and spherical-56 ⋅, “infinity-36 ⋅ ( [symbol] )-37 ⋅ infimum-38 ⋅”, “mark-48 ⋅ doppler-49 ⋅ shift-50 ⋅” newPlane-97 ⋅;
      6 . . . where and with a zenith and nadir divided by a horizon line
1; wherein; FIG. 1—; visual for inferential reasoning of imaging that link the (plane) output, (a subset), the greatest element of the containing set that is smaller or equal to all elements within, that links through FIG. 2—(Source Output),
2; wherein; annotate critical—composed ref. image sensor, 128×128 pixel array; (metric), each pixel maps values of ·(x)· to ·ƒ(x)· function of ·(x)·—
   1 . . . where; inclusive of FIG. 2—(Layer-3)—captured,

Img.—PRINT—FIG. 2—(Source Output),
1; wherein; newPlaneXsphere=dpixel-quadrant
   1 . . . where; (Plane-Layers-1-2-3)—(Source Output)
   2 . . . where; print—Source . . . , “(capture optic)” . . . , ((display optic)—monitor) . . . , (plane)
      1 . . . where by default (Input-Output) to
         . . . 1 . . . where Unit-utility of FIG. 3—(analogous Output)

Img.—Source Input
1; wherein; by default, generally, the “(capture sensor optic)” implies to a layman, some type of digit device, that will “(capture optic)” a digital image “Source (Input)”,
   1 . . . where; the Image implied to be captured called a “Source (Input)” is the silhouette digit pixel person, suited with hat, tie, shoes,
   2 . . . where; print display . . . , does not print metric, does not display metric in Display/Print/Preview, with (analogous Output).

further comprising the Unit-utility of the second part of three;

further comprising the unit-utilities-#of; [apparatus novice, upLoad-Driver-137 ⋅]—[semantics-68 ⋅, phrase-71 ⋅, collectivity-73 ⋅,
1; wherein; hereinafter, the subsequent part of this document, statement or matter adhering to Computing—executable—FIG. 1—(Source Input)
2; wherein; induced to FIG. 2—(Source Output), and adhering to Computing—artifact-70 ⋅ (software development), —execute-Driver-117 ⋅ of novice architectures and methods securing a (Source Input), newPlaneXsphere-101 ⋅=dpixel-quadrant-99 ⋅ (Source Output), embodiment of the invention is specific oriented, using part or all the,
3; wherein; further comprising the Unit-utilities, compliments the artifact-70 · (software development), of novice architectures and methods securing the—apparatus novice, dpix-utility Driver-112 ⋅, in relation to surroundings or circumstances, of the venue, dpix-93 ⋅,
   1 . . . where; inclusive with the principles-83 ⋅ of the (Source Input) being harmonious, (equivalence or correspondence among constituents of an entity, being [Input] or between different entities, being [Input] and [Output]),
   2 . . . where; with newPlaneXsphere-101 ⋅=dpixel-quadrant-99 ⋅—(Source Output), embodiment, —newPlane-97 ⋅ [display, layer],
   3 . . . where; induced from FIG. 1—(Source Input) to FIG. 2—(Source Output);
   4 . . . where; and/or composition-72 ⋅ “target {output} or request {input}”, ‘source’, Import/Load/Open will display the functional action taken by capture plane retrieve-129 ⋅ upon request of the—
   5 . . . where; apparatus novice, dpix-dpix-utility Driver-112 ⋅ through the (I/O), the CPU physical hardware, or memory storage device, further ref; (the principles-83 ⋅)

further comprising the unit-utilities-#of; reduplicate here; [0074]

further comprising the unit-utilities-#of; reduplicate here; [0075]

further comprising the unit-utilities-#of; reduplicate here; [0076]

where—comprising this unit-utilities-#of —[inference-75 ⋅, condition non-defined]

further comprising the unit-utilities-#of; reduplicate here; [0077]
1; wherein—symmetry-61 ⋅; as, —[sphere-55 ⋅], reduplicate here; [0078]

further comprising the unit-utilities-#of; [semantics-68 ⋅]—[expression-69 ⋅ collectivity-73 ⋅] (artifact-70 ⋅)—preparation-44 ⋅—derivatives-74 ⋅—phrase-71 ⋅,
1; wherein—semantics-68 ⋅;
   1 . . . where; as, —[expression-69 ⋅—collectivity-73 ⋅] (artifact-70 ⋅)—preparation-44 ⋅ derivatives-74 ⋅ phrase-71 ⋅—
      1 . . . where; meaning of a word, phrase, sentence, or text are the paraphrase of only to the related matter of—the principles-83 ⋅,
      2 . . . where; description here-in commonly used as a statement that represents something in words, and/or with mathematical formulation, in the act of describing; dpix-93 ⋅, dpixelens-142 ⋅ and,
      3 . . . where; more particularly, to the executable novice architectures and methods of/for dpix-93 ⋅, dpix-utility Driver-112 ⋅, execute-Driver-117 ⋅, adhering to Computing—artifact-70 ⋅ (software development),
      4 . . . where; one of many kinds of tangible by-products produced during the development of software achieve virtual artifact-70 ⋅ computability, with an object in a digital environment design of software modeling—computability,
      5 . . . where; include third party format as/like (UML), Unified Modeling Language, executable—execute-Driver-117 ⋅,
   2 . . . where; —expression-69 ⋅;
      1 . . . where; as, —[phrase-71 ⋅ phrase(d)-71 ⋅] (artifact-70 ⋅) group of mathematical formulation statements/words that are considered as a single unit making a mathematical statement,
   3 . . . where; —artifact-70 ⋅; as, —[man-made object taken as a whole], adhering to Computing—(software development), one of many kinds of tangible by-products produced during the development of software achieve virtual artifact-70 ⋅ computability, with an object in a digital environment design of software modeling
   4 . . . where; —phrase-71 ⋅ phrase(d)-71 ⋅;
      1 . . . where; as, —whose meanings cannot be inferred from the meanings of the words that make it up, herein, as artifact-70 ⋅ is one of many kinds of tangible by-products produced during the development of software that help describe the function, architecture, and design of software modeling—computability,
      2 . . . where; include third party format as/like (UML), Unified Modeling Language, executable—execute-Driver-117 ⋅,
   5 . . . where; —composition-72 ⋅;
      1 . . . where; as, —[collectivity-73 ⋅]—[expression-69 ⋅]—[phrase-71 ⋅ phrase(d)-71 ⋅];
      2 . . . where; as, ‘pertaining’ that is derived from another ‘pertaining’,
   6 . . . where; —collectivity-73 ⋅—[expression-69 ⋅]—[phrase-71 ⋅ phrase(d)-71 ⋅] inclusive as whole/part/in-part derivatives-74 ⋅,
      1 . . . where; as, all the subjective (logic) reason by deduction to complete actions required involving inference-75 ⋅ principles-83 ⋅ of the implied graphic image—FIG. 2—(Source Output)—),
      2 . . . where; as, the collective sum; aggregate or mass of anything specifiable, —here implies in-part; —the expected number of trials needed to collect a complete set of n different objects when picked at random with repetition, using ‘method and means’ as compare progressive for “non-zero dimension” (for mark-up and index formatting),
      3 . . . where; used in-part reference, a mass of storage information accessible by a ‘search’ method supported with . . . , cognition collectivity-73 ⋅ embodiment, applicable for dpixelens-142 ⋅, AI Logic; —(cognition collectivity-73 ⋅ result in perception, learning and reasoning),
   7 . . . where; —derivatives-74 ⋅—[collectivity-73 ⋅]—inclusive as whole/part/in-part, the result of mathematical differentiation;
      1 . . . where; the instantaneous change of one quantity relative to another; df(x)/dx−(derived function/differential coefficient), dpix-93 ⋅ and its derivatives-74 ⋅,
      2 . . . where; inclusive; —output visual tangable-91 ⋅ collectivity-73 ⋅ as dpix-93 ⋅;
         . . . 1 . . . where; inclusive; —result of mathematical differentiation; the instantaneous change of one quantity relative to another; df(x)/dx−(derived function/differential coefficient),
         . . . 2 . . . where; inclusive; —subjective-derivatives-74 ⋅ within the mind and modified by individual bias; inclusive, —a ‘pertaining’ that is derived from another ‘pertaining’—(linguistics/derived function/differential coefficient),
2; wherein; —inference-75 ⋅; as, —[principles-83 ⋅, collectivity-73 ⋅], reasoning involved in drawing a conclusion or making a logical judgment on the basis of circumstantial evidence and prior conclusions rather than on the basis of direct observation,
3; wherein; —inferential-76 ⋅; as, —[metric-45 ⋅], implies in-part as in, —[‘fore’·>( [symbol] )-37 ⋅<· ‘aft’, line of site-51 ⋅], as, in, along or relating to a line of instance of visual perception, must travers through an “infinity-36 ⋅ ( [symbol] )-37 ⋅ infimum-38 ⋅”, of ‘fore’ and ‘aft’, —metric-45 ⋅, ƒ·>|x:y|<· equates [(ƒ∘g) function composition-72 ⋅], further, [“inferential-76 ⋅ reasoning”, principles-83 ⋅, inference-75 ⋅, collectivity-73 ⋅] reasoning involved in drawing a conclusion or making a logical judgment on the basis of circumstantial evidence and prior conclusions rather than on the basis of direct observation, thus a subjective metric is a system of related measures that facilitates the quantification of some particular characteristic,
4; wherein; —Unit-utility of-77 ⋅; as, —[inference-75 ⋅, condition non-defined]
5; wherein; —Unit-utility of-78 ⋅; as, —[inference-75 ⋅, condition non-defined]
6; wherein; —Unit-utility of-79 ⋅; as, —[inference-75 ⋅, condition non-defined]
7; wherein; —aberration-80 ⋅; as, —[dpix-93 ⋅] markedly different from the norm,
8; wherein; —spatiotemporal-81 ⋅; as, —coherence-82 ⋅, relating to space and time together, four-dimensional coordinate system (three dimensions of space and one of time, measured in both resistance and distance) in which physical events are located,
9; wherein; —coherence-82 ⋅; as, —[spatiotemporal-81 ⋅] logical, orderly, and consistent relation of parts cohering,
10; wherein; —principles-83 ⋅; as, —[in-part of the embodiment] (Source Input)—newPlaneXsphere-101 ⋅=dpixel-quadrant-99 ⋅—(Source Output), as, conditional expectation composition-72 ⋅—as in, apparatus novice, dpix-utility Driver-112 ⋅,
   1 . . . where; —in-part—Σ(∇ƒ=—)Π-17; as, conditional expectation;
      1 . . . further comprising the unit-utilities-#of; reduplicate here; [0074: 10-16]
11; wherein; —output visual tangable-91 ⋅;
   1 . . . where; as, dpix-93 ⋅, collectivity-73 ⋅,
      1 . . . further comprising the unit-utilities-#of; reduplicate here; [0079: -17]

further comprising the unit-utilities-#of; [dpix-93 ⋅; dpixel-92 ⋅; dpixelive-92 ⋅; dspixel-92 ⋅]—[semantics-68 ⋅; phrase-71 ⋅; collectivity-73 ⋅]
1 . . . where; —inclusive; dpixel value-94 ⋅;
   1 . . . further comprising the unit-utilities-#of; reduplicate here; [0080: 1-4.3]
2 . . . where; —holomorphic-100 ⋅; as, —newPlaneXsphere-101 ⋅=sphericity-57 ⋅, (dspixel-92 ⋅—geographical area of the sphere-55 ⋅) dpix-intracellular-98 ⋅, “fore (infinity-36 ⋅ ( [symbol] )-37 ⋅ infimum-38 ⋅) aft”, as,
1 . . . where; further comprising the unit-utilities-#of; reduplicate here; [0081: 1-10]

where, however is a rationality dimensional dpix-intracellular-98 ⋅ body]; as, —plane versus face, spatial property as; pertaining to, involving or having the nature of space;
1; newPlaneXsphere-101 ⋅—plane versus face, spatial property as; pertaining to, involving or having the nature of space;
   1 . . . where; further comprising the unit-utilities-#of; reduplicate here; [0081a: 2-6.6]

where—further comprising a Unit-utility of -102 ⋅; [variable non-defined] as:

further comprising the Unit-utility of [ddp-list]-103 ⋅; acronyms;
ddp-ac-105 ⋅; ddp-m2m-106 ⋅; ddp-m2m·pri·-107 ⋅; ddp-m2m·1×#⋅108 ⋅;
1; where; further comprising the unit-utilities-#of; reduplicate here; [0082: 1-5.3]

further comprising the unit-utilities-#of; system embedded technology-109 ⋅-dpixelens-142 ⋅, dpix-utility Driver-112 ⋅—[semantics-68 ⋅, phrase-71 ⋅, collectivity-73 ⋅, —derivatives-74 ⋅],
1; where; —apparatus unit-utility-function-110 ⋅; as, —[“novice-utility” function] asset value apparatus,
2; where; further comprising the unit-utilities-#of; reduplicate here; [0083: 1-4.4]
   5 . . . for (mark-up and index formatting, attach a tag or label to, detect and remember) “mark-48 ⋅ doppler-49 ⋅ shift-50 ⋅”, versus “mark-48 ⋅ doppler-49 ⋅ shift-50 ⋅”, ‘moved tolerance’ architectures FIG. 1—(Source Input) through FIG. 2—(Source Output), respectively, in accordance with one or more embodiments of the invention,

where—system embedded technology-109 ⋅; as, —asset dpixelens-142 ⋅
1; where; further comprising the unit-utilities-#of; reduplicate here; [0083a: 1-15]

further comprising the unit-utilities-#of; [optic]—[“novice-utility” function] compose, [collectivity-73 ⋅] Object Recognition,
1; where; further comprising the unit-utilities-#of; reduplicate here; [0084: 1-7]
8; wherein; —layer-display optic-Layer-1-130 ⋅, —the monitor area-optic display (brand name) monitor with an original image archived as “background”—
   1 . . . where; herein implies—FIG. 2—(Source Output)—(Layers-1-2), —capture screen optic-124 ⋅,
      1 . . . where; (Layer-1), suggests in pixel measurement; (1920×1080) resolution of a monitor display (Layer-1) with 4/90° vertex-53 ⋅ ∠: —(X0,Y0)-(XH,Y0)-(X0,YV)-(XH,YV) . . . ,
         . . . 1 . . . where; (annotate critical: see graphic image—FIG. 2—(Source Output)—(Layers-1-2)),
9; wherein; —layer-display optic-Layer-2-131 ⋅, —layer-composed “new-Plane—radii”—
   1 . . . where; herein implies—FIG. 2—(Source Output)—(Layers-1-2), —layer-captured-display-128 ⋅,
      1 . . . where; (Layer-2), expression-69 ⋅, suggests in pixel measurement; (1080×1080) resolution of a ‘(new-Plane—radii)’ (Layer-2)-(XA,Y0)-(XB,Y0)-(XA,YV)-(XB,YV), composed capture—with 4/90° tri-vertex-54 ⋅ node Z, inclusive with a radii sphericity-57 ⋅, geographical area, output,—
         . . . 1 . . . where; (annotate critical: see graphic image—FIG. 2—(Source Output)—(Layers-1-2)—radii),
10; wherein; —layer-display optic-Layer-3-132 ⋅, —layer-captured-plane-127 ⋅ ‘new-Plane’—
   1 . . . where; herein implies—FIG. 2—(Source Output)—(Layers-1-2), layer-captured-display-128 ⋅,
      1 . . . where; (Layer-3)—suggests in pixel measurement; (1080×1080) resolution of a, ‘new-Plane’—(Layer-2)-(XA,Y0)-(XB,Y0)-(XA,YV)-(XB,YV) . . . , composed capture—with 4/90° tri-vertex-54 ⋅ node Z, inclusive within the geographical area sphericity-57 ⋅, is the subset-42 ⋅, subjectively pre-comprised;
         . . . 1 . . . where; the Image implied, FIG. 1 (Source Input), (Input-Output), a silhouette digit pixel person, and projected through to FIG. 2—(Source Output), (Layer-3)—captured, similarity of any/all source input output values Graphic Processor and/or Image Sensor and/or any ‘source’ of an induced plane display (output)—
         . . . 2 . . . where; (annotate critical: see image—FIG. 2—(Source Output)

further comprising the unit-utilities-#of; [display optic-133 ⋅]; as, —focal-plane-126 ⋅—a display novice, dpix-93 ⋅-utility,
1; where; further comprising the unit-utilities-#of; reduplicate here; [0085: 1-3]

further comprising the unit-utilities-#of; [upLoad-Driver-137 ⋅]—system embedded technology-109 ⋅; as,
1; where; further comprising the unit-utilities-#of; reduplicate here; [0086: 1-4]

further comprising the unit-utilities-#of; [dpixelens-142 ⋅—AI Logic; an apparatus novice, dpix-utility Driver-112 ⋅]—[semantics-68 ⋅; phrase-71 ⋅; collectivity-73 ⋅], (artifact-70 ⋅)—preparation-44 ⋅—derivatives-74 ⋅, —(annotate; replace lens with dpixelens-142 ⋅ is not a requirement of this apparatus unit-utility-function-110 ⋅, dpix-utility Driver-112 ⋅, but is suggestive as a source input instrument asset to further enhance this apparatus unit-utility-function-110 ⋅),
1; dpixelens-142 ⋅; comprising the unit-utilities-#of; reduplicate here; [0087a: 1-5.1]

Third part of three, [what is Claimed (3) is; #⋅149 ⋅], inclusive;
1; the embodiment method of unit-utility-150 ⋅, facilitating the processing of the captured image as the holomorphic-100 ⋅, dimensional pixel.

FIG. 3—(analogous Output)
1; wherein; capture-input-119 ⋅; —image/picture/display/newPlane-97 ⋅
   1 . . . where; represented, screen optic-124 ⋅,
      1 . . . where; applied—“mark-48 ⋅ doppler-49 ⋅ shift-50 ⋅”, ( [symbol] )-37 ⋅, as dpix-93 ⋅,
         . . . 1 . . . where; with metric-fluency-46 ⋅, for an (analogous Output)
   2 . . . where; with further apparatus unit-utility-function supplementals;
      1 . . . where; as, focal-plane-126 ⋅; to a print-default
         . . . 1 . . . where; outputting the holomorphic-100 ⋅, dimensional pixel,

Drawings, FIG. 3—(analogous Output);

where further comprising the Unit-utility of output as,
1; wherein; newPlaneXsphere=dpixel-quadrant;
   1 . . . where; comprising the Unit-utility of layer-display optic-Layer-1-130 ⋅;
   2 . . . where; comprising the Unit-utility of layer-display optic-Layer-2-131 ⋅;
   3 . . . where; comprising the Unit-utility of layer-display optic-Layer-3-132 ⋅;

focal-plane-126 ⋅; to a print-default outputting the dimensional pixel

also referred herein as,
1; (Input—capture transition—to display—Output),
   1 . . . for an (analogous Output) the dimensional pixel

Img.—novice—apparatus unit-utility-function-110 ⋅,
1; wherein; FIG. 2—(Source Output), (Layer-3)—captured,
2; wherein; as, the CPU—passes the sensor's pixel image,
3; wherein; FIG. 1, through to FIG. 2;
   1 . . . where; GPU sample given 128×128 (Pixel Array) pixels of the
   2 . . . where; silhouette digit pixel person, suited with hat, tie, shoes,
   3 . . . where; in part the subset-42 ⋅,
   4 . . . where; that is used as part of a focal-plane-126 ⋅ image,

Img.—further comprising the Unit-utility of output applied
1; wherein; —“mark-48 ⋅/doppler-49 ⋅/shift-50 ⋅”,
2; wherein; ( [symbol] )-37 ⋅ the venue, dpix-93 ⋅,
3; wherein; with metric-fluency-46 ⋅,

Img.—where further comprising the Unit-utility of output as, —pre-comprised, “mark-48 ⋅/doppler-49 ⋅/shift-50 ⋅”, versus—“infinity-36 ⋅ ( [symbol] )-37 ⋅ infimum-38 ⋅”, moved tolerance “mark-48 ⋅/doppler-49 ⋅/shift-50 ⋅”, and applied—metric-fluency-46 ⋅,

inclusive with;
1; wherein; An apparatus unit-utility-function-110 ⋅, dpix-utility Driver-112 ⋅; the first part of three; —FIG. 1—(Source Input);
2; wherein; An apparatus unit-utility-function-110 ⋅, upLoad-Driver-137 ⋅, the 2nd part of three; —FIG. 2—(Source Output)
3; wherein; An apparatus unit-utility-function-110 ⋅,
   1 . . . where; [“mark-48 ⋅/doppler-49 ⋅/shift-50 ⋅⋅”],
   1 . . . where; FIG. 3—(analogous Output); —the third part of three; —metric-fluency-46 ⋅, ( [symbol] )-37 ⋅ the venue, dpix-93 ⋅,

Img.—inclusive—the combine part one, two and three—
1; wherein; for “promises of utility”—mere “scintilla as usefulness” requires,
2; wherein; and adhering to Computing—artifact-70 ⋅—
   1 . . . where; as, [extrapolation]; herein the pleadable-26 ⋅ invention text embodiment for understanding novice—apparatus unit-utility-function-110 ⋅, technology language information . . . ,
   2 . . . where; further comprising the Unit-utility of output; for understanding, extrapolation implies or equates the/a datum information point derived,
   3 . . . where; further comprising the Unit-utility of output; “mark-48 ⋅ doppler-49 ⋅ shift-50 ⋅”; —by association ( [symbol] )-37 ⋅
   4 . . . where; further comprising the Unit-utility of output; inner sphere of influence
   5 . . . where; further comprising the Unit-utility of output; outer sphere of influence
   6 . . . where; further comprising the Unit-utility of output; metric-fluency-46 ⋅, ( [symbol] )-37 ⋅ the venue, dpix-93 ⋅,

upon the action function completed, the captured sensor optic-123 ⋅ image is reset and the process is repeated,—
1; wherein; An apparatus unit-utility-function-110 ⋅
   1 . . . where; (Input)—the first part of three;
2; wherein; An apparatus unit-utility-function-110 ⋅
   1 . . . where; (Output)—the second part of three;
3; wherein; An apparatus unit-utility-function-110 ⋅
   1 . . . where; (analogous Output-/-Display/Print/Preview)—the third part of three—
      1 . . . where; the analogous of outputting the Unit-utility of holomorphic-100 ⋅,
      . . . 1 . . . where; returns a dpixel value-94 ⋅, dimensional pixel, in accordance with one or more embodiments of the invention,
4; wherein; for “promises of utility—mere scintilla” of usefulness

1. The method (Process) software—with series of acts/steps performing this desired function in accomplishing the intended result of, the method as set forth . . . ,
what is claimed (1), #⋅15 ⋅ unit-utility, (Source Input). An apparatus utility,
1; wherein; an application comprising instructions to a method and means apparatus novice unit-utility-function-110 ⋅; (Input), computing of predictive and adaptive techniques of an “information processing system apparatus”, processing information and performing calculations of the programme to perform sequences of mathematical and logical operations, the method comprising of receiving a list of code segments, (unit-utilities), of an application comprising instructions for, —newPlane-97 ⋅ as, display, layer, dpixel value-94 ⋅, geometry of 2-dimensional figures inherent with spatiotemporal-81 ⋅, coherence-82 ⋅, property having dimensions/time/mass/cognitive content.
2; where, comprising the steps of—in-part; the FUNCTION methods, what differs is the executable novice architectures and methods for dpix-utility Driver-112 ⋅,
1 . . . where, further comprising of a unit-utilities-16 ⋅, of the dpix-utility Driver-112 ⋅; herein the pleadable OS for the assets unit-utility-function-110 ⋅,
3; wherein; facilitating the method processing of the image acquired comprising the first part of FIG. 1 illustration (Input), implemented at least in part by a computing device, an application comprising instructions to a method and means apparatus novice unit-utility-function-110 ⋅; (Input).

2. The method (Process) software—with series of acts/steps performing this desired function in accomplishing the intended result of, the method as set forth . . . ,
what is claimed (2), #⋅146 ⋅ unit-utility, (Source Output). An apparatus utility,
1; where, comprising the steps of in-part, bounding nodes of eight children centered with the unit-utility-47 ⋅,
2; wherein; facilitating the method processing of the image acquired, the method as set forth in claimed (1), #⋅15 ⋅ unit-utility, further comprising the method as set forth in claimed (2), #⋅146 ⋅ unit-utility, second part of FIG. 2 illustration (Input), implemented at least in part by a computing device, an application comprising instructions to a method and means unit-utility-function-110 ⋅; (Output).
3; wherein; in a preferred embodiment, computing of predictive and adaptive techniques of an “information processing system apparatus”, processing information and performing calculations of the programme to perform sequences of mathematical and logical operations, the method comprising of receiving a list of code segments, of an application comprising instructions for: —generating the bounding nodes of eight children centered with the unit-utility-47 ⋅.

3. The method (Process) software—with series of acts/steps performing this desired function in accomplishing the intended result of, the method as set forth . . . ,
what is claimed (3), #⋅149 ⋅ unit-utility, (analogous Output). An apparatus utility,
1; wherein; facilitating the method processing of the image acquired, the method as set forth in claimed (2), #⋅146 ⋅ unit-utility, generating the bounding nodes of eight children centered with the unit-utility-47 ⋅, and further comprising the method as set forth in claimed (3), #⋅149 ⋅ unit-utility, the third part of FIG. 3 illustration (Output), implemented at least in part by a computing device, an application comprising instructions to a method and means unit-utility-function-110 ⋅, comprising of receiving a list of code segments, for outputting the holomorphic-100 ⋅, dimensional pixel.
2; wherein; implement graphic Driver-116 ⋅, display-output, the dimensional pixel in accordance with one or more embodiments of the invention.

4. The method as set forth in claimed (1), #⋅15 ⋅ unit-utility, wherein, the method of claim; implemented in part by a computing device,
1; further comprising; the method comprising receiving a novice source unit-utilities-#code that comprises of Segments providing a desired level of quality code;
1; wherein comprising; analyzing the source unit-utilities-#code;
2; wherein comprising; and assigning a level of code coverage to each of the desired level of quality and the complexity measures of, a unit-utilities-#.

5. The method as set forth in claimed (1), #⋅15 ⋅ unit-utility, wherein the method of claim; the assigning relies on a relationship between a unit-utilities-#code quality, complexity and coverage.

6. The method as set forth in claimed (1), #⋅15 ⋅ unit-utility, wherein, the method of claim; a unit-utilities-#relationship comprises with a prior version of the source a unit-utilities-#code subjective.

7. The method as set forth in claimed (1), #⋅15 ⋅ unit-utility, wherein the method of claim; a unit-utilities-#relationship comprises with results from other test cases written for the source unit-utilities-#code.

8. The method as set forth in claimed (1), #⋅15 ⋅ unit-utility, wherein the method of claim, the unit-utility relationship comprises with results from test cases executed on the source a unit-utilities-#relationship code.

9. The method as set forth in claimed (1), #⋅15 ⋅ unit-utility, wherein the method of claim; a unit-utilities-#relationship comprises with an object-oriented programming language.

10. The method as set forth in claimed (1), #⋅15 ⋅ unit-utility, wherein the method of claim; a unit-utilities-#relationship comprises with code in an intermediate language.

11. The method as set forth in claimed (1), #⋅15 ⋅ unit-utility, wherein the method of claim; a unit-utilities-#relationship comprises with code written in a mark-up language.

12. The method as set forth in claimed (1), #⋅15 ⋅ unit-utility, wherein the method of claim; further analyzing, acquiring, defining a quality assessment value based on a unit-utilities-#code complexity and code coverage.

13. The method as set forth in claimed (1), #⋅15 ⋅ unit-utility, wherein the method is implemented at least in part by a computing device, receiving source code that comprises a unit-utility code segment and/or segments, furthering the method of/as set forth in claimed (1), #⋅15 ⋅, steps of facilitating the processing of the image acquired by;
1; further comprising pleadable-26 ⋅ as, conditional expectation,
2; further comprising semantics-68 ⋅ as [expression-69 ⋅; collectivity-73 ⋅](artifact-70 ⋅)
1 . . . where; subset to/as set forth in claimed (1), #⋅15 ⋅ unit-utility, preparation-44 ⋅; derivatives-74 ⋅; phrase-71 ⋅; meaning of a word, phrase, sentence, or text are the paraphrase of only to the related matter of, the method comprising of receiving a list of unit-utility/Function code segment and/or segments, of an application comprising instructions for: —generating more unit-utility/Function code
1 . . . where; further comprising—the principles-83 ⋅; description here-in commonly used as a statement that represents something in words,
3; further comprising: of source a unit-utilities-#code segments; analyzing the source unit-utilities-#code to assign a complexity measure,
1 . . . where further comprising method as set forth in preparation-44 ⋅ comprising the steps of: a unit-utility code segment and/or segments apparatus for processing an image, comprising;
2 . . . where an image acquirer for acquiring the image and for converting the acquired image to unit-utility code segment and/or segments representing the acquired image, a computer readable medium comprising software including instructions for directing a reprogrammable unit-utility code manipulating the image acquirer in accordance with the results desired to be obtained, regarding the acquired image and defined in the inclusive illustrations.

14. The method as set forth in claimed (3), #⋅149 ⋅ unit-utility, where in-part as, an analogous (Output⋅/⋅Display/Print/Preview) unit-utility-47 ⋅; outputting the dimensional pixel, in accordance with one or more embodiments of the invention.

14. CLAIM LISTING and METHODS, (“methods” aka, unit-utilities-#)

15. The method of what is claimed (1), #⋅15 ⋅ unit-utility, (Source Input). An apparatus utility,
1; wherein; an application comprising instructions to a method and means apparatus novice unit-utility-function-110 ⋅; (Input), computing of predictive and adaptive techniques of an “information processing system apparatus”, processing information and performing calculations of the programme to perform sequences of mathematical and logical operations, the method comprising of receiving a list of code segments, (unit-utilities), of an application comprising instructions for, —newPlane-97 ⋅ as, display, layer, dpixel value-94 ⋅, geometry of 2-dimensional figures inherent with spatiotemporal-81 ⋅, coherence-82 ⋅, property having dimensions/time/mass/cognitive content.
2; where, comprising the steps of—in-part; the FUNCTION methods, what differs is the executable novice architectures and methods for dpix-utility Driver-112 ⋅,
1 . . . where, further comprising of a unit-utilities-16 ⋅, of the dpix-utility Driver-112 ⋅; herein the pleadable OS for the assets unit-utility-function-110 ⋅,
3; wherein; facilitating the method processing of the image acquired comprising the first part of FIG. 1 illustration (Input), implemented at least in part by a computing device, an application comprising instructions to a method and means apparatus novice unit-utility-function-110 ⋅; (Input).

16. The method of/as set forth in claimed (1), #⋅15 ⋅, further comprising of a unit-utilities-#, apparatus novice, dpix-utility Driver-112 ⋅; —[semantics-68 ⋅; phrase-71 ⋅; collectivity-73 ⋅]—further comprising: in-part referenced as regarding the acquired image;
1; wherein further comprising; dpix-93 ⋅; dpixelens-142 ⋅;
“mark-48 ⋅/doppler-49 ⋅/shift-50 ⋅”, collectivity-73 ⋅;
2; wherein further comprising; without an added edit graphic utility program/app,
3; wherein further comprising; the method of/as set forth in claimed (1), #⋅15 ⋅, and an embodiment of the invention application unit-utility-function-110 ⋅; (displays “useful” as a formal requirement, having only the “mere scintilla” of usefulness),
4; wherein further comprising; the method of/as set forth in claimed (1), #⋅15 ⋅, and a unit-utilities-#: thereof, as would be understood by one skilled in the art, as distinctive for the dpix-93 ⋅; dpixel value-94 ⋅; of the capture original-plane-121 ⋅; with the assembly in accordance with the embodiment of the invention,
5; wherein further comprising; the method of/as set forth in claimed (1), #⋅15 ⋅, and a unit-utilities-#: the subsequent part of this document, statement or matter adhering to Computing—development of software achieve virtual object in a digital environment of specified formats as well as determine the arrangement of datum, (data), for storage and display (in computer science) as related to computability,
6; wherein further comprising; the method of/as set forth in claimed (1), #⋅15 ⋅, and a unit-utilities-#: include third party format as/like (UML), Unified Modeling Language, executable—(Source Input) induced to—(Source Output), and adhering to Computing—artifact-70 ⋅; (software development), —execute-Driver-117 ⋅; of novice architectures,
7; wherein further comprising; the method of/as set forth in claimed (1), #⋅15 ⋅, and methods securing a (Source Input), capture-input-119 ⋅, newPlane-97 ⋅ to a newPlaneXsphere-101 ⋅, equates dpixel-quadrant-99 ⋅; (Source Output), embodiment of the invention is specific oriented,
8; wherein further comprising; using part or all the, expression-69 ⋅, compliments the artifact-70 ⋅; (software development), of novice architectures,
9; wherein further comprising; and methods securing the method of a—apparatus novice, dpix-utility Driver-112 ⋅; in relation to surroundings or circumstances, of the venue, dpix-93 ⋅;
10; wherein further comprising; inclusive with the principles-83 ⋅; . . . the method as set forth in claimed (1), #⋅15 ⋅ unit-utility, (Source Input), capture-input-119 ⋅, newPlane-97 ⋅ to a newPlaneXsphere-101 ⋅, equates dpixel-quadrant-99 ⋅; method as set forth in claimed (2), #⋅146 ⋅ unit-utility, (Source Output) of the embodiment, —newPlane-97 ⋅; as, [display, layer, dpixel value-94 ⋅],
11; wherein further comprising; . . . the method as set forth in claimed (1), #⋅15 ⋅ (Source Input) to (Source Output) . . . the method as set forth in claimed (2), #⋅146 ⋅, and/or composition-72 ⋅; induced from “target {output} or request {input}”, ‘source’, Import/Load/Open will display the functional action taken by capture retrieve-plane-122 ⋅, regarding the acquired image;
13; wherein further comprising; upon request of/for the—apparatus novice, dpix-utility Driver-112 ⋅; through the (I/O), the CPU physical hardware, or memory storage device . . . ,

17. The method of/as set forth in claimed (1), #⋅15 ⋅, and unit-utilities-#code:
1; wherein; furthering the method of/as set forth in claimed (1), steps, Σ(∇ƒ⇒)Π-17 ⋅;
1 . . . where; pleadable-26 ⋅; principles-83 ⋅; conditional expectation composition-72 ⋅; as, [apparatus novice, dpix-utility Driver-112 ⋅]—[semantics-68 ⋅; phrase-71 ⋅; collectivity-73 ⋅]—composition-72 ⋅; (principles-83 ⋅), —derivatives-74 ⋅; [!Important—calculus-43 ⋅], regarding the acquired image,

18. The method of/as set forth in claimed (1), #⋅15 ⋅, and unit-utilities-#code:
1; wherein; furthering the method of/as set forth in claimed (1), steps, pleadable-26 ⋅;
1 . . . where; [extrapolation]; herein the pleadable-26 ⋅; invention text embodiment for understanding human language technology and/or natural language information . . . ,

19. wherein; furthering claimed (1), #⋅15 ⋅; the unit-utility for understanding, extrapolation implies or equates the/a datum information point derived, technology-111 ⋅;

20. wherein; furthering claimed (1), #⋅15 ⋅; the unit-utility the/a datum information point derived, is the subject of the composition-72 ⋅;

21. wherein; furthering claimed (1), #⋅15 ⋅; the unit-utility the subject of the composition-72 ⋅; and the expression-69 ⋅, regarding an acquired image of inference-75 ⋅, a droplet of water, H₂O, and therefore are represented by a group of dpix-93 ⋅; derivatives-74 ⋅; collectivity-73 ⋅;

22. which; differs from the following, unit-utilities-#s, 23 ⋅, 24 ⋅, 25 ⋅,

23. wherein selecting; the unit-utility of claimed (1), #⋅15 ⋅, unit-utility, the subject of the composition-72 ⋅; and the regarding an acquired image of inference-75 ⋅, table salt and barium oxide, are NaCl and BaO. respectively, and therefore are differently represented by a group of dpix-93 ⋅; derivatives-74 ⋅; collectivity-73 ⋅;

24. however; collectivity-73 ⋅;

25. wherein; furthering claimed (1), #⋅15 ⋅; in-part, [the understanding], understanding human language technology and/or natural language information . . . , regarding an acquired image of inference-75 ⋅, the/a datum information point derived, regarding the acquired image, H₂O, and NaCl and BaO, could therefore represent salt water by a single or group of dpix-93 ⋅; derivatives-74 ⋅; collectivity-73 ⋅; a ‘pertaining’ that is derived from another ‘pertaining’, composition-72 ⋅; regarding the acquired image,

26. wherein; furthering claimed (1), #⋅15 ⋅, and . . . the method as set forth in claimed (2), #⋅146 ⋅, and unit-utilities-#: —pleadable-26 ⋅; as, conditional expectation, a ‘pertaining’ that is derived from another ‘pertaining’, composition-72 ⋅; as, [apparatus novice, dpix-utility Driver-112 ⋅], —derivatives-74 ⋅; collectivity-73 ⋅; created by arranging several things to form a unified whole, that which something is composed, the spatial property resulting from the arrangement of parts in relation to each other and to the whole/part/in-part derivatives-74 ⋅; and where as, in-part referenced as, means mark-up and index, used in-part reference, further, in-part referenced as, conditional where †⋅ and †⋅####references, regarding the acquired image, and/or
1; wherein; cross references indexed numbers/numerics/words that bears the same “meaning” subjective . . . , includes errors and omissions attributed to the pleadable's the method of/as set forth in claimed (1), representation where errors and omissions would precieve misrepresentation those specifically enumerated included in core pleadable-26 ⋅; of this patent abstract to the third-party interpretation
2; wherein; unit-utilities-#the process of conceiving, specifying, designing, programming, documenting, testing, and bug fixing involved in creating and maintaining applications, frameworks, or other components, regarding the acquired image,
1 . . . where; Software of unit-utilities-#development is a process of writing and maintaining the source unit-utilities-#code, but in a broader sense, it includes all that is involved between the conception of the desired software through to the final manifestation of the software, sometimes in a planned and structured process. Therefore, software development may include research, new development, prototyping, modification, reuse, re-engineering, maintenance, or any other activities that result in software products,
2 . . . where; Software of unit-utilities-#can be developed for a variety of purposes of a specific case with custom software, to meet a perceived need of some set of potential embedded software development, that is, used for controlling required development process to be integrated with the development of the controlled physical product, in the act of describing the unit-utility;
3 . . . where; dpix-93 ⋅; dpixelens-142 ⋅; and, system software underlies applications
4 . . . where; and the programming process itself, and is often developed separately, regarding the acquired image.
3; wherein; unit-utilities-#: Critical core pleadable-26 ⋅; of this patent abstract is the output visual tangable-91 ⋅; in the pleadable-26 ⋅; act of describing a process to be integrated with the development of the controlled physical product, regarding the acquired image;
4; wherein; furthering claimed (1), #⋅15 ⋅; of unit-utilities-#; dpix-93 ⋅; dpixelens-142 ⋅; collectivity-73 ⋅;
1 . . . wherein; furthering claimed (1), #⋅15 ⋅, and . . . the method as set forth in claimed (2), #⋅146 ⋅,
1 . . . where; dpix-93 ⋅; as, [dpix-93 ⋅; dpixel-92 ⋅; dpixelive-92 ⋅; dspixel-92 ⋅] as unit-utility-92 ⋅; collectivity-73 ⋅; as, [!Important—calculus-43 ⋅], thus,
2 . . . where; unit-utility output visual tangable-91 ⋅; as,
. . . 1 . . . where; inclusive; dpix-93 ⋅; collectivity-73 ⋅; in-part referenced as, in the pleadable act of describing, regarding the acquired image;
. . . 1. wherein; furthering claimed (1), #⋅15 ⋅; the the unit-utility dpix-93 ⋅; dpixelens-142 ⋅; collectivity-73 ⋅;
3 . . . wherein; unit-utility; Σ(∇ƒ=⇒)Π-17 ⋅; as, analyzing the source a unit-utilities-#code to assign a complexity measure conditional expectation composition-72 ⋅; [inclusive; apparatus novice, dpix-utility Driver-112 ⋅], as, (principles-83 ⋅),

27. wherein; furthering claimed (1), #⋅15 ⋅, and . . . the method as set forth in claimed (2), #⋅146 ⋅; unit-utility—Σ(∇ƒ=⇒)Π-17 ⋅; as, conditional expectation; [a ‘pertaining’ that is derived from another ‘pertaining’], composition-72 ⋅;

28. wherein; furthering claimed (1), #⋅15 ⋅, and . . . the method as set forth in claimed (2), #⋅146 ⋅; Σ; implies; Σ sigma summation—sum of all values in range of series; expression-69 ⋅, Σxi=x1+x2+ . . . +xn

29. wherein; furthering claimed (1), #⋅15 ⋅, and . . . the method as set forth in claimed (2), #⋅146 ⋅; [ ]; implies; brackets calculate expression-69 ⋅; inside first; expression-69 ⋅, [(1+2)*(1+5)]=18

30. wherein; furthering claimed (1), #⋅15 ⋅, and . . . the method as set forth in claimed (2), #⋅146 ⋅; ( ); implies; parentheses calculate expression-69 ⋅; inside first; expression-69 ⋅, 2*(3+5)=16

31. wherein; furthering claimed (1), #⋅15 ⋅, and . . . the method as set forth in claimed (2), #⋅146 ⋅; V; implies; nabla/del gradient/divergence operator; expression-69 ⋅, ∇ƒ(x,y,z)

32. wherein; furthering claimed (1), #⋅15 ⋅, and . . . the method as set forth in claimed (2), #⋅146 ⋅; ƒ; implies; ƒ function of (x) maps values of x to ƒ(x), ƒ(x)=3×+5 or ƒ(x) probability density function (pdf) P(a≤x≤b)=∫ƒ(x) dx

33. wherein; furthering claimed (1), #⋅15 ⋅, and . . . the method as set forth in claimed (2), #⋅146 ⋅; ⇒; implies; implied conditional expectation

34. wherein; furthering claimed (1), #⋅15 ⋅, and . . . the method as set forth in claimed (2), #⋅146 ⋅; Π; implies; capital pi product—product of all values in range of series; expression-69 ⋅, Πxi=x1+x2+ . . . +xn . . . ,

35. wherein; furthering claimed (1), #⋅15 ⋅, and . . . the method as set forth in claimed (2), #⋅146 ⋅, of unit-utilities-35 ⋅;
1; wherein comprising; [“infinity-36 ⋅ ( [symbol] )-37 ⋅ infimum-38 ⋅” ]-35 ⋅; [dpix-93 ⋅]; [“mark-48 ⋅ doppler-49 ⋅ shift-50 ⋅” ]-47 ⋅; [non-zero dimension]; regarding the acquired image,
1 . . . where; inclusive as derivatives-74 ⋅; [collectivity-73 ⋅], [!Important unit-utility—calculus-43 ⋅] as, pleadable-26 ⋅; further; “infinity-36 ⋅ ( [symbol] )-37 ⋅ infimum-38 ⋅” as, [mark-48 ⋅; ( [symbol] )-37 ⋅; [symbol] -baseline-primal-52 ⋅; [symbol]
—dspixel-92 ⋅; /sphere-55 ⋅; collectivity-73 ⋅]—
[‘fore’·>(“infinity-36 ⋅ ( [symbol] )-37 ⋅ infimum-38 ⋅”)<·‘aft’]—object/objective [symbol]
-baseline horizon±(primal-52 ⋅; [symbol] -∠) [symbol]
1 . . . where; inclusive as unit-utility dpix-93 ⋅; [!Important unit-utility—calculus-43 ⋅],

36. wherein; furthering claimed (1), #⋅15 ⋅, and . . . the method as set forth in claimed (2), #⋅146 ⋅; the unit-utility infinity-36 ⋅; as, line of sight/site-51 ⋅;

37. wherein; furthering claimed (1), #⋅15 ⋅, and . . . the method as set forth in [symbol] claimed (2), #⋅146 ⋅; unit-utility ( [symbol] )-37 ⋅; as, [symbol] -baseline—primal-52 ⋅; [symbol] -dspixel-92 ⋅; /sphere-55 ⋅; inferential-76 ⋅; reasoning principles-83 ⋅; metric-45 ⋅; orb-like-39 ⋅; subset-42 ⋅; calculus-43 ⋅; collectivity-73 ⋅; (dspixel-92 ⋅; geographical area of the sphere-55 ⋅) dpix-intracellular-98 ⋅; [‘fore’·>(“infinity-36 ⋅ ( [symbol] )-37 ⋅ infimum-38 ⋅”)<·‘aft’]-object/objective [symbol] -baseline horizon±(primal-52 ⋅; [symbol] -∠)—“mark-48 ⋅ doppler-49 ⋅ shift-50” a [symbol] -baseline, primal-52 ⋅; and a sphere-55 ⋅; inclusive with a zenith and nadir divided by a horizon line,

38. wherein; furthering claimed (1), #⋅15 ⋅, and . . . the method as set forth in claimed (2), #⋅146 ⋅; unit-utility infimum-38 ⋅; as, the greatest element of the containing set that is smaller or equal to all elements of the subset-42 ⋅; further comprising, a unit-utilities-#

39. wherein; furthering claimed (1), #⋅15 ⋅, and . . . the method as set forth in claimed (2), #⋅146 ⋅; comprising the unit-utility orb-like-39 ⋅; as, [spherical-56 ⋅; (ball)], object/objective mark-48 ⋅;

40. wherein; furthering claimed (1), #⋅15 ⋅, and . . . the method as set forth in claimed (2), #⋅146 ⋅; comprising the unit-utility orb-40 ⋅; as, [spherical-56 ⋅; (ball)], object/objective to; subset-42 ⋅;

41. wherein; furthering claimed (1), #⋅15 ⋅, and . . . the method as set forth in claimed (2), #⋅146 ⋅; comprising the unit-utility orb-fluency-41 ⋅; as, [spherical-56 ⋅; (trajectory)], object/objective to; subset-42 ⋅;

42. wherein; furthering claimed (1), #⋅15 ⋅, and . . . the method as set forth in claimed (2), #⋅146 ⋅; comprising the unit-utility subset-42 ⋅; as, [dpixel-92 ⋅; metric-45 ⋅; (calculus-43 ⋅)] member set within another set,

43. wherein; furthering claimed (1), #⋅15 ⋅, and . . . the method as set forth in claimed (2), #⋅146 ⋅; comprising the unit-utility calculus-43 ⋅; as, [(subset-42 ⋅)—(metric-45 ⋅)] with limits, differentiation and integration of functions preparation-44 ⋅;

44. wherein; furthering claimed (1), #⋅15 ⋅, and . . . the method as set forth in claimed (2), #⋅146 ⋅; comprising the unit-utility preparation-44 ⋅; as, [(“infinity-36 ⋅ ( [symbol] )-37 ⋅ infimum-38 ⋅”)—(metric-45 ⋅)] is performed according to an order of operations, as, dpixel-92 ⋅; metric-45 ⋅; (subset-42 ⋅) calculus-43 ⋅;

45. wherein; furthering claimed (1), #⋅15 ⋅, and . . . the method as set forth in claimed (2), #⋅146 ⋅; comprising the unit-utility metric-45 ⋅; as, a system of related measures that facilitates the quantification of a calculus-43 ⋅; wherein the [dpix-93 ⋅; dpixel-92 ⋅; dpixelive-92 ⋅; dspixel-92 ⋅]-92 ⋅; particular characteristic is composed software coding, decoding methods,

46. wherein; furthering claimed (1), #⋅15 ⋅, and . . . the method as set forth in claimed (2), #⋅146 ⋅; comprising the unit-utility metric-fluency-46 ⋅; as, a system of related measures that facilitates the quantification of a calculus-43 ⋅; wherein the [dpix-93 ⋅; dpixel-92 ⋅; dpixelive-92 ⋅; dspixel-92 ⋅]-92 ⋅; particular characteristic is composed software coding, decoding methods of unconstrained, flowing smoothly in movement within an orb/orb-like-39 ⋅; subset-42 ⋅; calculus-43 ⋅; thus a subjective metric is a system of related measures that facilitates the quantification of some particular characteristic,

47. wherein; furthering claimed (1), #⋅15 ⋅, and . . . the method as set forth in claimed (2), #⋅146 ⋅; comprising the unit-utility-47 ⋅ as; in-part, further comprising claimed (2), #⋅146 ⋅, outputting the dimensional pixel ([“mark-48 ⋅ doppler-49 ⋅ shift-50 ⋅” ]-47 ⋅); [semantics-68 ⋅; phrase-71 ⋅; collectivity-73 ⋅]—[non-zero dimension]; further as, [inclusive; “mark-48 ⋅ doppler-49 ⋅ shift-50 ⋅” ]—[non-zero dimension]—(for mark-up and index formatting, attach a tag or label to, detect and remember), collectivity-73 ⋅;
1; wherein inclusive; “mark-48 ⋅ doppler-49 shift-50⋅” as, [to the acronym: ( [symbol] )-37 ⋅; [symbol] -baseline, primal-52 ⋅; [symbol] , sphere-55 ⋅] (orb-like-39 ⋅; ball), objective [symbol] -baseline mark-48 ⋅; via zenith and nadir; (primal-52 ⋅; [symbol] )=zenith-nadir—by a horizon line: or/if as, a focal-plane-126 ⋅; therefore (360°/180°) or/if as, orb-like-39 ⋅; therefore spherical angle (∠=AOB=180°)

48. wherein; furthering claimed (1), #⋅15 ⋅, and . . . the method as set forth in claimed (2), #⋅146 ⋅; the unit-utility mark-48 ⋅; as, non-zero dimension—(for mark-up and index formatting, attach a tag or label to, detect and remember)—as, primal-52 ⋅; [symbol] ∠; zenith-nadir÷by a horizon; equates the/a datum information point derived measurement or research assignment of an address.

49. wherein; furthering claimed (1), #⋅15 ⋅, and . . . the method as set forth in claimed (2), #⋅146 ⋅; the unit-utility doppler-49 ⋅; as, [mark-48 ⋅; ( [symbol] )-37 ⋅; [symbol] -baseline—primal-52 ⋅; [symbol] -dspixel-92 ⋅/sphere-55 ⋅]—[acronym: ( [symbol] )-37 ⋅]—[ [symbol] -doppler-49 ⋅; shift-50 ⋅; [symbol] , [symbol] -baseline, primal-52 ⋅; sphere-55 ⋅] off-set from primal-52 ⋅; [symbol] site-51 ⋅; progressive for “non-zero dimension”, (for mark-up and index formatting, attach a tag or label to, detect and remember), “mark-48 ⋅ doppler-49 ⋅ shift-50 ⋅”; ontologies: (computing) a rigorous and exhaustive organization of dpixel-92 ⋅; knowledge domain that usually corresponds to the index hierarchical and contains all the relevant entities and their relations that comprises the external attributes mapping the variable datum item ID that can later be used as—Output:
1; wherein the set best for “mark-48 ⋅ doppler-49 ⋅ shift-50 ⋅”; field attributes, that comprises the external attributes, (the acronym; doppler; the datum point that scans the geographical area of the sphere-55 ⋅; for subset-42 ⋅; members and those members within other subsets of a sphere-55 ⋅; of the geographical area),

50. wherein; furthering claimed (1), #⋅15 ⋅, and . . . the method as set forth in claimed (2), #⋅146 ⋅; the unit-utilities-#shift-50 ⋅; as, attributes mapping the variable datum item ID field attributes that comprises attributes that are used as an off-set from the primal-52 ⋅; site-51 ⋅;
1; wherein comprising, unit-utilities-#'s

51. wherein; furthering claimed (1), #⋅15 ⋅, and . . . the method as set forth in claimed (2), #⋅146 ⋅; comprising the unit-utility 4-site-51 ⋅; as, primal's-52 ⋅; physical position in relation to the surroundings,

52. wherein; furthering claimed (1), #⋅15 ⋅, and . . . the method as set forth in claimed (2), #⋅146 ⋅; comprising the unit-utility primal-52 ⋅;_; as, serving as an essential component, in an original stage/state,

53. wherein; furthering claimed (1), #⋅15 ⋅, and . . . the method as set forth in claimed (2), #⋅146 ⋅; comprising the unit-utility vertex-53 ⋅; ∠; as, point/node of intersection of lines,

54. wherein; furthering claimed (1), #⋅15 ⋅, and . . . the method as set forth in claimed (2), #⋅146 ⋅; comprising the unit-utility tri-vertex-54 ⋅; ∠; as, node ∠-3 pt-perspective component—manifolds;
1; wherein A set of node-points such as those of a closed surface or an analogue in three or more dimensions,
2; wherein comprising; node combine or increase several or many times,

55. wherein; furthering claimed (1), #⋅15 ⋅, and . . . the method as set forth in claimed (2), #⋅146 ⋅ comprising the unit-utility sphere-55 ⋅; as, (dspixel-92 ⋅; dimensional in shape—spherical-56 ⋅; (orb-like-39 ⋅; ball), object/objective to mark-48 ⋅), [dpixel-92 ⋅; metric-45 ⋅; (calculus-43 ⋅)] that includes the sphere-55 ⋅; and everything inside the sphere-55 ⋅; suggestively;
1; wherein further comprising; infer-axiom, all points with a distance equates less than −φ·π·r·—(radians, radius, radii) from the given point,
1 . . . where the fore-implied as a focal-plane-126 ⋅; image,
1 . . . where; except as otherwise annotate,
. . . 1 . . . where; inclusive, geographical area of the sphere-55 ⋅;

56. wherein; furthering claimed (1), #⋅15 ⋅, and . . . the method as set forth in claimed (2), #⋅146 ⋅ comprising the unit-utility spherical-56 ⋅; dspixel-92 ⋅; dimensional in shape, sphere-55 ⋅; (orb-like-39 ⋅; ball)

57. wherein; furthering claimed (1), #⋅15 ⋅, and . . . the method as set forth in claimed (2), #⋅146 ⋅ comprising the unit-utility sphericity-57 ⋅; as, dspixel-92 ⋅; geographical area of the sphere-55 ⋅; and geographical area sphericity-57 ⋅; [set, mark, draw, boundaries]

58. wherein; furthering claimed (1), #⋅15 ⋅, and . . . the method as set forth in claimed (2), #⋅146 ⋅ comprising the unit-utility-58 ⋅; as, [variable condition non-defined]; —[inclusive] as, prelude to Trade Secret doppler “mark-48 ⋅ doppler-49 ⋅ shift-50 ⋅”;

59. wherein; furthering claimed (1), #⋅15 ⋅, and . . . the method as set forth in claimed (2), #⋅146 ⋅ comprising the unit-utility-59 ⋅; as, [define—translucent-lase-59 ⋅; doppler-49 ⋅]

60. wherein; furthering claimed (1), #⋅15 ⋅, and . . . the method as set forth in claimed (2), #⋅146 ⋅ comprising the unit-utility lase-60 ⋅; as, acronym for light amplification by stimulated emission, in the act of describing; dpix-93 ⋅; dpixelens-142 ⋅;

61. wherein; furthering claimed (1), #⋅15 ⋅, and . . . the method as set forth in claimed (2), #⋅146 ⋅ comprising the unit-utility symmetry-61 ⋅; as, [sphere-55 ⋅], reflection of a primal-52 ⋅; [symbol] , reflection of opposite sides of a primal-52 ⋅; [symbol] , subset-42 ⋅; from within/without, or reflective (<· from/to ·>) as “back to back”,

62. wherein; furthering claimed (1), #⋅15 ⋅, and . . . the method as set forth in claimed (2), #⋅146 ⋅ comprising the unit-utility symmetry·pri-62 ⋅; as, [ . . . with divergence]-moving away from a common point in an infinite series to;
mark-48 ⋅ (<· from/to ·>) mark-48 ⋅, primal-52 ⋅; [symbol] ,

63. wherein; furthering claimed (1), #⋅15 ⋅, and . . . the method as set forth in claimed (2), #⋅146 ⋅ comprising the unit-utility symmetry-dc-63 ⋅; as, [ . . . with divergence/convergence]—moving away/to a point in an infinite series resiling to the original position; mark-48 ⋅ (<· from/to ·>) mark-48 ⋅, primal-52 ⋅; sphericity-57 ⋅; doppler-49 ⋅; shift-50 ⋅;

64. wherein; furthering claimed (1), #⋅15 ⋅, and . . . the method as set forth in claimed (2), #⋅146 ⋅ comprising the unit-utility symmetry·geo-64 ⋅; as, [geographical area sphericity-57 ⋅]—moving from a point in an infinite series resiling to the original position; mark-48 ⋅ (<· from/to ·>) mark-48 ⋅, primal-52 ⋅; sphericity-57 ⋅; doppler-49 ⋅; shift-50 ⋅;

65. wherein; furthering claimed (1), #⋅15 ⋅, and . . . the method as set forth in claimed (2), #⋅146 ⋅ comprising the unit-utility symmetry·outshpr-65 ⋅; as, [outer-sphere area sphericity]—moving from a point in an infinite series resiling to the original position; mark-48 ⋅ (<· from/to ·>) mark-48 ⋅, primal-52 ⋅; sphericity-57 ⋅; doppler-49 ⋅; shift-50 ⋅;

66. wherein; furthering claimed (1), #⋅15 ⋅, and . . . the method as set forth in claimed (2), #⋅146 ⋅ comprising the unit-utility symmetry-inshpr-66 ⋅; as, [inner-sphere area sphericity]—moving away a point in an infinite series resiling to the original position; mark-48 ⋅ (<· from/to ·>) mark-48 ⋅, primal-52 ⋅; sphericity-57 ⋅; doppler-49 ⋅; shift-50 ⋅;

67. wherein; furthering claimed (1), #⋅15 ⋅, and . . . the method as set forth in claimed (2), #⋅146 ⋅ comprising the unit-utility [semantics-68 ⋅]-67 ⋅; [expression-69 ⋅; collectivity-73 ⋅] (artifact-70 ⋅)—preparation-44 ⋅; derivatives-74 ⋅; phrase-71 ⋅;

68. wherein; furthering claimed (1), #⋅15 ⋅, and . . . the method as set forth in claimed (2), #⋅146 ⋅ comprising the unit-utility semantics-68 ⋅; as, [expression-69 ⋅; collectivity-73 ⋅] (artifact-70 ⋅)—preparation-44 ⋅; derivatives-74 ⋅; phrase-71 ⋅; meaning of a word, phrase, sentence, or text are the paraphrase of only to the related matter of—the principles-83 ⋅; description here-in commonly used as a statement that represents something in words,
1; wherein comprising; and/or with math formulation, in the act of describing; dpix-93 ⋅; dpixelens-142 ⋅;
2; wherein further comprising; and, more particularly, to the executable novice architectures and methods of/for dpix-utility Driver-112 ⋅; execute-Driver-117 ⋅;
3; wherein further comprising; adhering to Computing—artifact-70 ⋅; (software development), one of many kinds of tangible by-products produced during the development of software achieve virtual artifact-70 ⋅; computability,
4; wherein further comprising; with an object in a digital environment design of software modeling—computability, include third party format as/like (UML), Unified Modeling Language, executable—execute-Driver-117 ⋅;

69. wherein; furthering claimed (1), #⋅15 ⋅, and . . . the method as set forth in claimed (2), #⋅146 ⋅ comprising the unit-utility expression-69 ⋅; as, [phrase-71 ⋅; phrase(d)-71 ⋅] (artifact-70 ⋅) group of mathematical formulation statements/words that are considered as a single unit making a mathematical statement,

70. wherein; furthering claimed (1), #⋅15 ⋅, and . . . the method as set forth in claimed (2), #⋅146 ⋅ comprising the unit-utility artifact-70 ⋅; as, [man-made object taken as a whole], adhering to Computing—(software development), one of many kinds of tangible by-products produced during the development of software achieve virtual artifact-70 ⋅; computability, with an object in a digital environment design of software modeling,

71. wherein; furthering claimed (1), #⋅15 ⋅, and . . . the method as set forth in claimed (2), #⋅146 ⋅ comprising the unit-utility phrase-71 ⋅; phrase(d)-71 ⋅; as, whose meanings cannot be inferred from the meanings of the words that make it up, herein, as artifact-70 ⋅; is one of many kinds of tangible by-products produced during the development of software that help describe the function, architecture, and design of software modeling—computability, include third party format as/like (UML), Unified Modeling Language, executable—execute-Driver-117 ⋅;

72. wherein; furthering claimed (1), #⋅15 ⋅, and . . . the method as set forth in claimed (2), #⋅146 ⋅ comprising the unit-utility composition-72 ⋅; as, [collectivity-73 ⋅]-[expression-69 ⋅]—[phrase-71 ⋅; phrase(d)-71 ⋅]; as, ‘pertaining’ that is derived from another ‘pertaining’,

73. wherein; furthering claimed (1), #⋅15 ⋅, and . . . the method as set forth in claimed (2), #⋅146 ⋅ comprising the unit-utility collectivity-73 ⋅; [expression-69 ⋅]-[phrase-71 ⋅; phrase(d)-71 ⋅] inclusive as whole/part/in-part derivatives-74 ⋅; as, all the subjective (logic) reason by deduction to complete actions required involving inference-75 ⋅; principles-83 ⋅; of the implied graphic image—FIG. 2—(Source Output), as, the collective sum; aggregate or mass of anything specifiable,
1; wherein further comprising; expression-69 ⋅: in-part; the expected number of trials needed to collect a complete set of n different objects when picked at random with repetition, using ‘method and means’ as compare progressive for “non-zero dimension” (for mark-up and index formatting), used in-part reference, a mass of storage information accessible by a ‘search’ method supported with . . . , cognition collectivity-73 ⋅; embodiment, applicable for dpixelens-142 ⋅; AI Logic; The novice apparatus unit-utility-function-110 ⋅; (cognition collectivity-73 ⋅; result in perception, learning and reasoning),

74. wherein; furthering claimed (1), #⋅15 ⋅, and . . . the method as set forth in claimed (2), #⋅146 ⋅ comprising the unit-utility derivatives-74 ⋅; [collectivity-73 ⋅]—inclusive as whole/part/in-part, the result of mathematical differentiation; the instantaneous change of one quantity relative to another; df(x)/dx−(derived function/differential coefficient), dpix-93 ⋅; and its derivatives-74 ⋅; inclusive; output visual tangable-91 ⋅; collectivity-73 ⋅; as dpix-93 ⋅;
1; wherein inclusive; result of mathematical differentiation; the instantaneous change of one quantity relative to another; df(x)/dx−(derived function/differential coefficient),
2; wherein inclusive; subjective-derivatives-74 ⋅; within the mind and modified by individual bias;
1 . . . where inclusive, —a ‘pertaining’ that is derived from another ‘pertaining’—(linguistics/derived function/differential coefficient),

75. wherein; furthering claimed (1), #⋅15 ⋅, and . . . the method as set forth in claimed (2), #⋅146 ⋅ comprising the unit-utility inference-75 ⋅; as, [principles-83 ⋅; collectivity-73 ⋅], reasoning involved in drawing a conclusion or making a logical judgment on the basis of circumstantial evidence and prior conclusions rather than on the basis of direct observation,

76. wherein; furthering claimed (1), #⋅15 ⋅, and . . . the method as set forth in claimed (2), #⋅146 ⋅ comprising the unit-utility inferential-76 ⋅; as, [metric-45 ⋅], implies as in,
1; wherein comprising; in-part—[‘fore’·>( [symbol] )-37 ⋅<·‘aft’, line of site-51 ⋅],
1 . . . where; as, in, along or relating to a line of instance of visual perception, must travers through an “infinity-36 ⋅ ( [symbol] )-37 ⋅ infimum-38 ⋅” of ‘fore’ Disturbance and Disturbance ‘aft’, —metric-45 ⋅; |·>|x:y|<· equates (ƒ∘g) function composition-72 ⋅,
2 . . . where; further, [“inferential-76 ⋅; reasoning”, principles-83 ⋅; inference-75 ⋅; collectivity-73 ⋅] reasoning involved in drawing a conclusion or making a logical judgment on the basis of circumstantial evidence and prior conclusions rather than on the basis of direct observation,
3 . . . where; thus a subjective metric is a system of related measures that facilitates the quantification of some particular characteristic,

77. further comprising the unit-utility-77 ⋅; as, —[inference-75 ⋅, condition non-defined]

78. further comprising the unit-utility-78 ⋅; as, —[inference-75 ⋅, condition non-defined]

79. further comprising the unit-utility-79 ⋅; as, —[inference-75 ⋅, condition non-defined]

80. wherein; furthering claimed (1), #⋅15 ⋅, and . . . the method as set forth in claimed (2), #⋅146 ⋅ comprising the unit-utility aberration-80 ⋅; as, [dpix-93 ⋅] markedly different from the norm,

81. wherein; furthering claimed (1), #⋅15 ⋅, and . . . the method as set forth in claimed (2), #⋅146 ⋅ comprising the unit-utility spatiotemporal-81 ⋅; as, [coherence-82 ⋅] relating to space and time together, four-dimensional coordinate system (three dimensions of space and one of time, measured in both resistance and distance) in which physical events are located,

82. wherein; furthering claimed (1), #⋅15 ⋅, and . . . the method as set forth in claimed (2), #⋅146 ⋅ comprising the unit-utility coherence-82 ⋅; as, [spatiotemporal-81 ⋅] logical, orderly, and consistent relation of parts cohering,

83. wherein; . . . the method as set forth in claimed (2), #⋅146 ⋅ comprising the unit-utility principles-83 ⋅; as, [in-part of the embodiment] (Source Input)—newPlaneXsphere-101 ⋅; equates dpixel-quadrant-99 ⋅; (Source Output), as, of conditional expectation composition-72 ⋅; as in, apparatus novice, dpix-utility Driver-112 ⋅; ploys—Σ(∇ƒ=⇒)Π-7 ⋅; as, conditional expectation; [a ‘pertaining’ that is derived from another ‘pertaining’], composition-72 ⋅;

84. where claimed (2), #⋅146 ⋅, Σ; implies—pleadable-26 ⋅; reduplicate here (28 ⋅)

85. where; the unit-utility [ ]; implies—pleadable-26 ⋅; reduplicate here (29⋅)

86. where claimed (2), #⋅146 ⋅, ( ); implies—pleadable-26 ⋅; reduplicate here (30⋅)

87. where claimed (2), #⋅146 ⋅, ∇; implies—pleadable-26 ⋅; reduplicate here (31 ⋅)

88. where claimed (2), #⋅146 ⋅, ƒ; implies—pleadable-26 ⋅; reduplicate here (32 ⋅)

89. where claimed (2), #⋅146 ⋅, ⇒; implies—pleadable-26 ⋅; reduplicate here (33 ⋅)

90. where claimed (2), #⋅146 ⋅, Π; implies—pleadable-26 ⋅; reduplicate here (34 ⋅)

91. further where claimed (2), #⋅146 ⋅, comprising the unit-utility output visual tangable-91 ⋅; as, dpix-93 ⋅; collectivity-73 ⋅; further in-part referenced as, conditional expectation composition-72 ⋅; [inclusive; apparatus novice, dpix-utility Driver-112 ⋅], as, (principles-83 ⋅),

92. further where claimed (2), #⋅146 ⋅, comprising the unit-utility-92 ⋅ as; [dpixel-92 ⋅; dpixelive-92 ⋅; dspixel-92 ⋅]; [semantics-68 ⋅; phrase-71 ⋅; collectivity-73 ⋅]—inclusive; dpixel value-94 ⋅; tangable-91 ⋅;

93. further where claimed (2), #⋅146 ⋅, comprising the unit-utility dpix-93 ⋅; as, [inclusive; dpixel-92 ⋅; dpixelive-92 ⋅; dspixel-92 ⋅] as, transition of the digital pixel aberration convergence as in, dspixel-92 ⋅; dimensional in sphere-55 ⋅; subjective to the term dpix-intracellular-98 ⋅; equates a descriptive value datum,

94. further where claimed (2), #⋅146 ⋅, comprising the unit-utility dpixel value-94 ⋅; as, [the apparatus novice unit-utility-function-110 ⋅; takes a sensor pixel value^{ref}-94 ⋅; (see ref; pixel—Wikipedia), referent and returns—dpixel value-94 ⋅], related to “the viewing ∘ display optic-133 ⋅;”, in digital imaging, a pixel, pel, dots, or picture element is a physical point in a raster image, or the smallest addressable element in an all points addressable display device; so it is the smallest controllable element of a image/picture/display/newPlane-97 ⋅; represented,

95. further comprising the unit-utility-95 ⋅; as, —[inference-75 ⋅, condition non-defined]

96. further comprising the unit-utility-96 ⋅; as, —[inference-75 ⋅, condition non-defined]

97. furthering claimed (1), #⋅15 ⋅, and . . . the method as set forth in claimed (2), #⋅146 ⋅ unit-utility, newPlane-97 ⋅; as,
1; [display, layer, dpixel value-94 ⋅], geometry of 2-dimensional figures inherent with spatiotemporal-81 ⋅; coherence-82 ⋅; property having dimensions/time/mass/cognitive content; range of what has been perceived, discovered, learned, or hypothetical hypothesis,
2; subjective upon execution of the CPU-GPU, output to device, (display optic)—performing logical operations of data, capture sensor optic-123 ⋅,
1 . . . according to programmed instructions in order to obtain the required information of the Source input sensor beam quality to adaptively optimize the optical system at a real time step capture rate-optic-120 ⋅ rate temporarily held in-memory for output to a device,
2 . . . that generally is understood to be a type of memory to monitor that will display the capture sensor optic-123 ⋅ image, followed by refreshing the image until the CPU is instructed to capture sensor optic-123 ⋅ image,
1 . . . generally “executed” by a physical action of a mechanical function, or electronic functional action taken,
2 . . . upon the action “executed”, the captured sensor optic-123 ⋅ image is stored on/within a physical device means and the process is repeated,
. . . 1 . . . which later, the image, can be retrieved upon request to/from (I/O) the CPU physical hardware or other storage device.
3; subjective to cognitive dissonance; conflicting ideas simultaneously, subsequently to capture original optic-118 ⋅; induced from . . . the method as set forth in claimed (1), #⋅15 ⋅ (Source Input) to (Source Output) . . . the method as set forth in claimed (2), #⋅146 ⋅, and/or composition “target {output} or request {input}”, any ‘source’ and/or Import/Load/Open will display the functional action taken by capture retrieve-plane-122 ⋅; upon request of the—unit-utility comprised—apparatus novice, dpix-utility Driver-112 ⋅;
1 . . . through the (I/O), the CPU physical hardware, or memory storage device referred with inferential-76 ⋅; reasoning metric-45 ⋅; (logic) of reasoning;
2 . . . proceeding from general premisses to a necessary and specific conclusion, based on interpretation; with/without acronyms;
1 . . . [dpix-93 ⋅; dpixel-92 ⋅; dpixelive-92 ⋅; dspixel-92 ⋅]-92 ⋅; of the digital pixel aberration-80 ⋅; convergence as in—Xsphere [dimensional in sphere-55 ⋅; shape pixel subjective],
4; to the term dpix-intracellular-98 ⋅; body equates an infinity of a body/bodies inside a body of a body descriptive value datum comprised in-part—newPlaneXsphere-101 ⋅; equates dpixel-quadrant-99 ⋅;
5; where other applied discipline substance subject matter spatial property related to the visual perceivedness rationality dimensional dpix-intracellular-98 ⋅; bodies, as a (ball) sphere-55 ⋅; inclusion, equates dpixel-quadrant-99 ⋅; [cube (quadrant)],
6; will suggest visual perceivedness rationality mark-48 ⋅; dpixel-92 ⋅; datum in one or more methods,

98. furthering claimed (1), #⋅15 ⋅, and . . . the method as set forth in claimed (2), #⋅146 ⋅ comprising the unit-utility dpix-intracellular-98 ⋅; as, infinity of body/bodies inside a body of a body,

99. furthering claimed (1), #⋅15 ⋅, and . . . the method as set forth in claimed (2), #⋅146 ⋅ comprising the unit-utility dpixel-quadrant-99 ⋅; as, newPlane-97 ⋅; (embodiment), Xsphere—[plane versus face, spatial property is added];
1; wherein further comprising; and as, [no matter squared; calculus-43 ⋅; without a descriptive value datum,
2; wherein further comprising; however is a rationality dimensional dpix-intracellular-98 ⋅; body], Xsphere equates dpixel-quadrant-99 ⋅; [dimensional in sphere-55 ⋅],
3; wherein further comprising; to the term dpix-intracellular-98 ⋅; an infinity of a body/bodies inside a body of a body embodiment,
4; wherein further comprising; therefore, the dpixel-quadrant-99 ⋅; newPlane-97 ⋅; (embodiment) foursquare tri-vertex-54 ⋅; (plane rectangle with four equal sides and four tri-vertex-54 ⋅; angles dimensions or aspects;
5; wherein further comprising; giving the dpixel-quadrant-99 ⋅; depth) fractioned by a zenith-nadir÷by a horizon asymptote,

100. furthering claimed (1), #⋅15 ⋅, and . . . the method as set forth in claimed (2), #⋅146 ⋅ comprising the unit-utility holomorphic-100 ⋅; as, newPlaneXsphere-101 ⋅; =sphericity-57 ⋅; (dspixel-92 ⋅; geographical area of the sphere-55 ⋅) dpix-intracellular-98 ⋅; ‘fore’·>(“infinity-36 ⋅ ( [symbol] )-37 ⋅ infimum-38 ⋅”)<·‘aft’, as, complex valued and complex differentiable variables introduce functions of several complex variables;
1; wherein further comprising; functional integrals in definition of a quantum field theorem scalar and gauge observables and correlation approaches to perturbative quantum field theory of a infer-axiom line/lines, perception of a ‘straight line’ within “infinity” vector/tensor/vector generalization of the concept of;
1 . . . where; a straight line segment whose length is magnitude and whose orientation in space is direction,
2 . . . where; a variable quantity that can be resolved into components,
3 . . . where; a chosen course or direction of motion,
4 . . . where; symbolic representation—something visible that by association or convention represents something else that is invisible,
5 . . . where; asymptote—a straight line that is the limiting value of a curve, can be considered as tangent at infinity,
6 . . . where; perturb perturbative—a secondary influence on a system that causes it to deviate slightly, interfere with the usual path, by expression-69 ⋅, of an electron or atom—“the electrons were perturbed by the passing ion”,
7 . . . where; cause a celestial body to deviate from a theoretically regular orbital motion, especially as a result of interposed or extraordinary pull, gravitational pull,
1 . . . where comprising the unit-utility inference-75 ⋅; (The orbits of dpixs are perturbed by the passings of a hypothetic-dimensional metrics dpix-intracellular-98 ⋅ of the body),
8 . . . where; (programming) a hypothetic-dimensional metrics, based primarily on surmise rather than adequate evidence as best calculated . . . , cognition collectivity-73 ⋅; embodiment, applicable for dpixelens-142 ⋅;
1 . . . where; AI Logic; the apparatus novice unit-utility-function-110 ⋅; cognition collectivity-73 ⋅; result in perception, learning and reasoning,

101. furthering claimed (1), #⋅15 ⋅, and . . . the method as set forth in claimed (2), #⋅146 ⋅ comprising the unit-utility newPlaneXsphere-101 ⋅; equates dpixel-quadrant-99 ⋅ as, [no matter squared; calculus-43 ⋅; without a descriptive value datum, however is a rationality dimensional dpix-intracellular-98 ⋅; body];
1; further comprising; as, plane versus face, spatial property as; pertaining to, involving or having the nature of space; and as, newPlaneXsphere-101 ⋅; plane versus face, spatial property as; pertaining to, involving or having the nature of space;
2; further comprising; and as, dpixel-quadrant-99 ⋅; plane versus face, spatial property is added;
3; further comprising; and as, newPlane-97 ⋅; plane versus face, spatial property is added;
4; further comprising; and as, (encompassing), Xsphere; as part of a sphere or territory or in-whole,
5; further comprising; and as, dimensionally perception is a plane, flat, outcome holomorphic-100 ⋅],
6; further comprising; however, with other applied discipline substance subject matter spatial property is related to the visual perceivedness rationality,
7; further comprising; as any dpix-intracellular-98 ⋅; body found within another (characteristic of certain dimensionally perception) as a ball (sphere) inclusion cube (⊕ quadrant).
1 . . . wherein further comprising; A quarter of the circumference of a circle/ball (sphere);
2 . . . wherein further comprising; Any of the four areas into which a plane/cube/circle/ball/sphere, is divided by two orthogonal coordinate axes;
3 . . . wherein further comprising; The area enclosed by two perpendicular radii of a circle/ball (sphere);
4 . . . wherein further comprising; A measuring instrument for measuring altitude of bodies, therefore, mark-48 ⋅; [primal-52 ⋅; [symbol] ∠] zenith-nadir÷by a horizon asymptote, or (glyph symbolic representation (zenith-nadir ⊕ by a horizon asymptote,)
5 . . . wherein further comprising; ‘fore’·>(“infinity-36 ⋅ ( [symbol] )-37 ⋅ infimum-38 ⋅”)<·‘aft’, equates the/a datum information point derived measurement or research assignment of an address to the quadrant,

102. further comprising a Unit-utility-102 ⋅; [varible non-defined] as: ^{†⋅};

103. furthering claimed (1), #⋅15 ⋅, and . . . the method as set forth in claimed (2), #⋅146 ⋅ comprising the unit-utility [ddp-list]-103 ⋅; acronyms; ddp-ac-105 ⋅; ddp-m2m-106 ⋅; ddp-m2m-pri·-107 ⋅; ddp-m2m·1×#⋅108 ⋅;
1; wherein comprising; also common to the ddp-list-104 ⋅; asynchronously or (digital communication) pertaining to a transmission technique that does not require a common clock between the communicating devices; timing signals could be derived from special characters in the data/datum stream itself,

104. furthering claimed (1), #⋅15 ⋅, and . . . the method as set forth in claimed (2), #⋅146 ⋅ comprising the unit-utility ddp-list-104 ⋅; as, collectivity-73 ⋅; ddp-ac-105 ⋅; ddp-m2m-106 ⋅; ddp-m2m-pri·-107 ⋅; ddp-m2m·1×#⋅108 ⋅;
1; wherein comprising; and as, 2⋅transition, meaning in-part, “to⋅transition”, as, transition of the digital pixel aberration convergence as in, dspixel-92 ⋅; dimensional in sphere-shape pixel,

105. furthering claimed (1), #⋅15 ⋅, and . . . the method as set forth in claimed (2), #⋅146 ⋅ comprising the unit-utility ddp-ac-105 ⋅; as, . . . with digital dpixel-analog conversion,

106. furthering claimed (1), #⋅15 ⋅, and . . . the method as set forth in claimed (2), #⋅146 ⋅ comprising the unit-utility ddp-m2m-106 ⋅; as, . . . digital dpixel-pass-through, entity relationship pass-through many-to-many datum-data model,

107. furthering claimed (1), #⋅15 ⋅, and . . . the method as set forth in claimed (2), #⋅146 ⋅ comprising the unit-utility ddp-m2m-pri·-107 ⋅; as, . . . with digital dpixel-convergence, an approach of an infinite series to a finite limit,
mark-48 ⋅ (·> to/from <·) mark-48 ⋅, primal-52 ⋅; [symbol] , symmetry-61 ⋅;

108. furthering claimed (1), #⋅15 ⋅, and . . . the method as set forth in claimed (2), #⋅146 ⋅ comprising the unit-utility ddp-m2m·1×#⋅108 ⋅; as, . . . with digital dpixel-machine to machine, direct communication between composition-72 ⋅;
1; wherein comprising; “target {output} or request {input}”, any ‘source’ and/or Import/Load/Open are interchangeable to a display optic-graphic-134 ⋅; that will display the functional action taken by capture retrieve-plane-122 ⋅;
2; wherein comprising; upon request through the (I/O), the CPU physical hardware, or memory storage device referred, devices, an implementation of Object Management,

109. furthering claimed (1), #⋅15 ⋅, and . . . the method as set forth in claimed (2), #⋅146 ⋅ comprising the unit-utility system embedded technology-109 ⋅; dpixelens-142 ⋅; dpix-utility Driver-112 ⋅; [semantics-68 ⋅; phrase-71 ⋅; collectivity-73 ⋅; derivatives-74 ⋅],

110. furthering claimed (1), #⋅15 ⋅, and . . . the method as set forth in claimed (2), #⋅146 ⋅ comprising the unit-utility apparatus unit-utility-function-110 ⋅; as, [“novice unit-utility-function-110 ⋅;” function] asset value apparatus,
1; wherein comprising; About System Summary/Hardware Resources/Components/Software Environment;
1; wherein further comprising;
1 . . . where; dpix-93 ⋅—Whatis-data,
2 . . . where; dpix-93 ⋅—Whereis-data,
3 . . . where; dpix-93 ⋅—Whois-data . . . , associated/request inf/ini/dpix-getDisplay;
2; upLoad-Driver-137 ⋅; dpix-utility Driver-112 ⋅; execute-Driver-117 ⋅; . . .
1 . . . where; . . . System/System Information/Find system settings drivers/Hardware Resources/Components/Software Environment;
1 . . . where; . . . devices—printers/scanners/PnP-monitors, etc,
3; wherein further comprising; thus, Software Environment/employs all listed system drivers,
4; wherein further comprising; inclusive with OLE Registration Program operative information,
5; wherein further comprising; further, system embedded technology-109 ⋅; Object-Recognition-125 ⋅; Similarity and Matching intersecting points between successive images,
6; wherein further comprising; or herein after (Recognition/Similarity/Matching: aka, RSM-object), may be referenced as ‘RSM-o’,
7; wherein further comprising; using ‘method and means’ as compare progressive for “non-zero dimension” (for mark-up and index formatting, attach a tag or label to, detect and remember)
8; wherein further comprising; “mark-48 ⋅ doppler-49 ⋅ shift-50 ⋅” versus “mark-48 ⋅ doppler-49 ⋅ shift-50 ⋅”, ‘moved tolerance’ architectures . . . the method as set forth in claimed (1), #⋅15 ⋅ (Source Input) to (Source Output) . . . the method as set forth in claimed (2), #⋅146 ⋅, respectively,
9; wherein further comprising; in accordance with one or more embodiments of the invention, regarding the acquired image, as, furthering the method of/as set forth of processing a pixel, facilitating the processing of the image acquired by comprising an image acquirer for acquiring the image and for converting the acquired image to unit-utility code segment and/or segments representing the acquired image, a computer readable medium comprising software including instructions for directing a reprogrammable unit-utility code manipulating the image acquirer in accordance with the results desired to be obtained, regarding the acquired image and defined in the inclusive illustrations

111. wherein; furthering claimed (1), #⋅15 ⋅, and . . . the method as set forth in claimed (2), #⋅146 ⋅ unit-utility, comprising the unit-utility AI Logic system embedded technology-111 ⋅; as, asset dpixelens-142 ⋅; [collectivity-73 ⋅; derivatives-74 ⋅]
1; wherein further comprising; where AI Logic, similarity and matching intersecting points between successive—dpix-intracellular-98 ⋅; images or hereinafter (aka, RSM-object datum, hereinafter may be referenced as ‘RSM-o’) using ‘method and means’ as compare progressive for “non-zero dimension” . . . , . . . (for mark-up and index formatting, attach a tag or label to, detect and remember) “mark-48 ⋅ doppler-49 ⋅ shift-50 ⋅”; versus—“infinity-36 ⋅ ( [symbol] )-37 ⋅ infimum-38 ⋅” ‘moved tolerance’ doppler-49 ⋅; shift-50 ⋅; relevant;
2; wherein further comprising; (having a bearing on or connection with the subject at issue)
3; wherein further comprising; about System Summary/Hardware Resources/Components/Software Environment . . . ,
4; wherein further comprising; [dpix-93 ⋅ Whatis-data/-/dpix-93 ⋅ Whereis-data/-/dpix-93 ⋅ Whois-data . . . ,] associated/request inf/ini/dpix-getDisplay; upLoad-Driver-138 ⋅; dpix-utility Driver-112 ⋅; execute-Driver-117 ⋅; System/System Information/Find system settings drivers/Hardware Resources/Components/Software Environment . . . ,
5; wherein further comprising; devices—printers/scanners/PnP-monitors, etc, thus, Software Environment/employs all listed system drivers, inclusive with OLE Registration Program operative information,

112. wherein; furthering claimed (1), #⋅15 ⋅, and . . . the method as set forth in claimed (2), #⋅146 ⋅ comprising the unit-utility dpix-utility Driver-112 ⋅; as, [apparatus novice unit-utility-function-110 ⋅; dpixel-92 ⋅] capture-input-119 ⋅; [(I/O) interface], “target {output}AND request {input}”, uploaded
1; wherein further comprising; usually from a ROM Drv storage media read-only memory, USB, CD, HD,

113. wherein; furthering claimed (1), #⋅15 ⋅, and . . . the method as set forth in claimed (2), #⋅146 ⋅ comprising the unit-utility dpix-utility sensor-retrieve-113 ⋅; as, [unit-utility-function-110 ⋅; execute-Driver-117 ⋅] sensor optic-123 ⋅; [(I/O) interface], “target {output} AND request {input}”,

114. wherein; furthering claimed (1), #⋅15 ⋅, and . . . the method as set forth in claimed (2), #⋅146 ⋅ comprising the unit-utility dpix-utility screen-retrieve-114 ⋅; as, [unit-utility-function-110 ⋅; execute-Driver-117 ⋅] screen optic-124 ⋅; [(I/O) interface], —composition-72 ⋅;
1; wherein further comprising; “target {output} AND request {input}”, any ‘source’ and/or Import/Load/Open are interchangeable to a display optic-graphic-134 ⋅; that will display the functional action taken by capture retrieve-plane-122 ⋅; as requested through the (I/O), the CPU physical hardware, or memory storage device referred as “target {output} AND request {input}”, —focal-plane-126 ⋅;

115. wherein; furthering claimed (1), #⋅15 ⋅, and . . . the method as set forth in claimed (2), #⋅146 ⋅ comprising the unit-utility sensor Driver-115 ⋅; as, [system settings] sensor spec info, (capture-input-119 ⋅),

116. wherein; furthering claimed (1), #⋅15 ⋅, and . . . the method as set forth in claimed (2), #⋅146 ⋅ comprising the unit-utility graphic Driver-116 ⋅; as, [system settings] graphic spec info, (display-output),

117. wherein; furthering claimed (1), #⋅15 ⋅, and . . . the method as set forth in claimed (2), #⋅146 ⋅ comprising the unit-utility execute-Driver-117 ⋅; as, [dpix-utility Driver-112 ⋅], layer-captured-plane-127 ⋅;

118. wherein; furthering claimed (1), #⋅15 ⋅, and . . . the method as set forth in claimed (2), #⋅146 ⋅ comprising the unit-utility capture original optic-118 ⋅; as, [source input]—Image implied captured,

119. wherein; furthering claimed (1), #⋅15 ⋅, and . . . the method as set forth in claimed (2), #⋅146 ⋅ comprising the unit-utility capture-input-119 ⋅; as, [source input]-implied hardware/softwareAmage,

120. wherein; furthering claimed (1), #⋅15 ⋅, and . . . the method as set forth in claimed (2), #⋅146 ⋅ comprising the unit-utility capture rate-optic-120 ⋅; as, [1/1 still; 10/1 motion; 32+/1×#vid] captured,

121. wherein; furthering claimed (1), #⋅15 ⋅, and . . . the method as set forth in claimed (2), #⋅146 ⋅ comprising the unit-utility capture original-plane-121 ⋅; as, [source input—(original)]—Image implied,

122. wherein; furthering claimed (1), #⋅15 ⋅, and . . . the method as set forth in claimed (2), #⋅146 ⋅ comprising the unit-utility capture retrieve-plane-122 ⋅; as, [source input—(retrieve)]—Image implied—original-121 ⋅; any ‘source’—Import/Load/Open, any induced plane, focal-plane-126 ⋅;

123. wherein; furthering claimed (1), #⋅15 ⋅, and . . . the method as set forth in claimed (2), #⋅146 ⋅ comprising the unit-utility capture sensor optic-123 ⋅; as, [focal-plane-126 ⋅; pixel imaging sensor],

124. wherein; furthering claimed (1), #⋅15 ⋅, and . . . the method as set forth in claimed (2), #⋅146 ⋅ comprising the unit-utility capture screen optic-124 ⋅; as, [focal-plane-126 ⋅; graphics processor],

125. wherein; furthering claimed (1), #⋅15 ⋅, and . . . the method as set forth in claimed (2), #⋅146 ⋅ comprising the unit-utility [optic]—[“novice unit-utility-function-110 ⋅;” function] compose, [collectivity-73 ⋅] Object-Recognition-125 ⋅; hereinafter; aka, RSM-object datum, may be referenced as ‘RSM-o’;

126. wherein; furthering claimed (1), #⋅15 ⋅, and . . . the method as set forth in claimed (2), #⋅146 ⋅ comprising the unit-utility focal-plane-126 ⋅; [capture original optic-118 ⋅]—an original image archived as “background”—implies presuppose—
1; wherein further comprising; a source input to an Image Sensor and/or Graphic Processor source input output values and/or any ‘source’ and/or Import/Load/Open, of an induced plane used
2; wherein further comprising; by methods, apparatus and systems including at least one hardware processor,
3; wherein further comprising; at least one tangible storage medium (memory), and at least one input/output (I/O) interface of the ‘optical computing system’,
4; wherein further comprising; prior to; upLoad-Driver-138 ⋅; (I/O port)—Run/driver/Utility/sensor/display/output . . . , capture original-plane-121 ⋅;

127. wherein; furthering claimed (1), #⋅15 ⋅, and . . . the method as set forth in claimed (2), #⋅146 ⋅ comprising the unit-utility layer-captured-plane-127 ⋅; [execute-Driver-117 ⋅]

128. wherein; furthering claimed (1), #⋅15 ⋅, and . . . the method as set forth in claimed (2), #⋅146 ⋅ comprising the unit-utility layer-captured-display-128 ⋅; [display unit-utility-function-110 ⋅; output]—display plane

129. wherein; furthering claimed (1), #⋅15 ⋅, and . . . the method as set forth in claimed (2), #⋅146 ⋅ comprising the unit-utility layer-display retrieve-129 ⋅; [source] (inclusive of; Import/Load/Open),

130. wherein; furthering claimed (1), #⋅15 ⋅, and . . . the method as set forth in claimed (2), #⋅146 ⋅ comprising the unit-utility layer-display optic-Layer-1-130 ⋅, (aka; —Layer-1); the monitor area—optic display (brand name) monitor with an original image archived as “background”; . . . the method as set forth in claimed (2), #⋅146 ⋅ unit-utility,
(Source Output)
1; wherein further comprising; herein implies—(Layer-1), —capture screen optic-124;
2; wherein further comprising; (Layer-1), expression-69 ⋅ in pixel measurement where; (1941×1101) resolution of a monitor display (Layer-1) with 4/90° vertex-53; ∠: —(X0,Y0)-(XH,Y0)-(X0,YV)-(XH,YV) . . . ,
3; wherein further comprising; composition-72 ⋅
4; wherein further comprising; (Layer-2), expression-69 ⋅, in pixel measurement where; (1101×1101) resolution of a ‘(new-Plane—radii)’ (Layer-2)-(XA,Y0)—(XB,Y0)-(XA,YV)-(XB,YV),

131. wherein; furthering claimed (1), #⋅15 ⋅, and . . . the method as set forth in claimed (2), #⋅146 ⋅ comprising the unit-utility layer-display optic-Layer-2-131 ⋅, (aka; —Layer-2); layer-composed “new-Plane—radii”—(Layers-1-2), —layer-captured-display-128 ⋅;
1; wherein further comprising; (Layer-2), expression-69 ⋅ in pixel measurement where; (1101×1101) resolution of a ‘(new-Plane—radii)’ (Layer-2)-(XA,Y0)-(XB,Y0)-(XA,YV)-(XB,YV), composed capture—with 4/90° tri-vertex-54 ⋅; node ∠, inclusive with a radii sphericity-57 ⋅; geographical area, output,—
1 . . . wherein comprising; (Layers-1-2)—radii),

132. further comprising herein implies . . . the method as set forth in claimed (2), #⋅146 ⋅ unit-utility, (analogous Output), further comprising Unit-utility layer-display optic-Layer-3-132 ⋅, (aka; —Layer-3); layer-captured-plane-127 ⋅; ‘new-Plane’—herein implies . . . the method as set forth in claimed (2), #⋅146 ⋅ unit-utility, (Source Output)—(Layers-1-2), layer-captured-display-128 ⋅;
1; wherein further comprising; (Layer-3), —expression-69 ⋅ in pixel measurement where; (1101×1101) resolution of a, ‘new-Plane’—(Layer-2)-(XA,Y0)-(XB,Y0)-(XA,YV)-(XB,YV) . . . , composed capture—with 4/90° tri-vertex-54 ⋅; node Z,
2; wherein further comprising; inclusive within the geographical area sphericity-57 ⋅; is the subset-42 ⋅; subjectively pre-comprised;
3; wherein further comprising from the method of/as set forth in
claimed (1), #⋅15 ⋅ unit-utility, (Source Input), (Input-Output), a silhouette digit pixel person, and projected through to claimed (2), #⋅146 ⋅ unit-utility, (Source Output), (Layer-3)—captured, similarity of any/all source input output values Graphic Processor and/or Image Sensor and/or any ‘source’ of an induced plane display (output)
1 . . . wherein comprising; (Source Output)

133. wherein; furthering claimed (1), #⋅15 ⋅, and . . . the method as set forth in claimed (2), #⋅146 ⋅ comprising the unit-utility display optic-133 ⋅; as, focal-plane-126 ⋅; to a novice, dpix-93 ⋅; display-default

134. wherein; furthering claimed (1), #⋅15 ⋅, and . . . the method as set forth in claimed (2), #⋅146 ⋅ comprising the unit-utility display optic-graphic-134 ⋅; as, focal-plane-126 ⋅; to a display-default

135. wherein; furthering claimed (1), #⋅15 ⋅, and . . . the method as set forth in claimed (2), #⋅146 ⋅ comprising the unit-utility display optic-monitor-135 ⋅; as, focal-plane-126 ⋅; to a monitor-default

136. wherein; furthering claimed (1), #⋅15 ⋅, and . . . the method as set forth in claimed (2), #⋅146 ⋅ comprising the unit-utility display optic-printer-136 ⋅; as, focal-plane-126 ⋅; to a printer-default

137. wherein; furthering claimed (1), #⋅15 ⋅, and . . . the method as set forth in claimed (2), #⋅146 ⋅ comprising the unit-utility upLoad-Driver-137 ⋅; system embedded technology-109 ⋅;
1; wherein further comprising; as a novice unit-utility-function-110 ⋅; function, compose, [collectivity-73 ⋅] dpix-utility Driver-112 ⋅; inclusive to unit-utility-function-110 ⋅; function asset value apparatus, dpixelens-142 ⋅;

138. wherein; furthering claimed (1), #⋅15 ⋅, and . . . the method as set forth in claimed (2), #⋅146 ⋅ comprising the unit-utility upLoad-Driver-138 ⋅; as, [(I/O) interface] prior to; upLoad-Driver-137 ⋅; (I/O port)—Run/driver/Utility/sensor/display/output—(Source output)

139. wherein; furthering claimed (1), #⋅15 ⋅, and . . . the method as set forth in claimed (2), #⋅146 ⋅ comprising the unit-utility in-part referenced as in the pleadable act of describing-139 ⋅; dpix-93 ⋅; dpixelens-142 ⋅; collectivity-73 ⋅;

140. wherein; furthering claimed (1), #⋅15 ⋅, and . . . the method as set forth in claimed (2), #⋅146 ⋅ comprising the unit-utility optic-140 ⋅; [“novice unit-utility-function-110 ⋅;” function] compose, [collectivity-73 ⋅] Object-Recognition-125 ⋅; hereinafter; aka, RSM-object datum, may be referenced as ‘RSM-o’;

141. wherein; furthering claimed (1), #⋅15 ⋅, and . . . the method as set forth in claimed (2), #⋅146 ⋅ comprising the unit-utility [dpixelens-142 ⋅; AI Logic; an apparatus novice, dpix-utility Driver-112 ⋅]-141 ⋅; [semantics-68 ⋅; phrase-71 ⋅; collectivity-73 ⋅], (artifact-70 ⋅)—preparation-44 ⋅; derivatives-74 ⋅;
1; wherein further comprising; (annotate; replace lens with dpixelens-142 ⋅; is not a requirement of this apparatus unit-utility-function-110 ⋅; dpix-utility Driver-112 ⋅; but is suggestive as a source input instrument asset to further enhance this apparatus unit-utility

142. wherein; furthering claimed (1), #⋅15 ⋅, and . . . the method as set forth in claimed (2), #⋅146 ⋅ comprising the unit-utility dpixelens-142 ⋅; as, AI Logic; an asset value apparatus, novice unit-utility, detailed for measuring, recording, and controlling, as needed, expressed in terms of fundamental quantities like time, mass and length—implies—a source input instrument—capture original optic-118 ⋅; the image sensor/GPU source input output values, function,
1; wherein further comprising; alternatively in a certain way related to “the viewing ∘ display optic-133 ⋅;”—
1 . . . wherein further comprising; the dpixelens-142 ⋅; point2point, doppler-49 ⋅; shift-50 ⋅; ddp-m2m-pri·-107 ⋅; in preparation-44 ⋅; of dissonance, for AI Logic, conflict opinions, actions/characters, fixed (one conflict) v (motion) unfixed (repeat conflict), through a predetermined cashe and/or page swap file, repeat,
1 . . . wherein further comprising; image implied, . . . /as set forth in claimed (1), #⋅15 ⋅, (Source Input), (Input-Output), spherical aberration-80 ⋅; prism, replace with dpixelens-142 ⋅;
. . . 1 . . . wherein further comprising; annotate; replace lens with dpixelens-142 ⋅; is not a requirement of this apparatus unit-utility-function-110 ⋅; dpix-utility Driver-112 ⋅; but is suggestive as a source input instrument asset to further enhance this apparatus unit-utility, where in-part, (Source Input), (Input-Output), is the subject of novelty of capture (retrieve) plane,
. . . 1 . . . where; further comprised as, capture retrieve-plane-122 ⋅;

143. wherein; furthering claimed (1), #⋅15 ⋅, and . . . the method as set forth in claimed (2), #⋅146 ⋅ inclusive-143 ⋅; apparatus unit-utility-function-110 ⋅; as, [“novice unit-utility-function-110 ⋅;” function] asset value; apparatus,

144. wherein; furthering claimed (1), #⋅15 ⋅, and . . . the method as set forth in claimed (2), #⋅146 ⋅ inclusive-144 ⋅; system embedded technology-109 ⋅; as, dpixelens-142 ⋅; [collectivity-73 ⋅]—AI Logic], Object-Recognition-125 ⋅; with—[non-zero dimension] mark-48 ⋅; up links,

145. wherein; furthering claimed (1), #⋅15 ⋅, and . . . the method as set forth in claimed (2), #⋅146 ⋅ inclusive-145 ⋅; dpixelens-142 ⋅; as, doppler-49 ⋅; an asset value; apparatus. There are factors that algorithms cannot measure, for better or worse, that are enhanced with the doppler-49 ⋅; asset value; apparatus offering some relief from the term, GSP dependance,
1; wherein further comprising; the unit-utilities-#steps with outputting the holomorphic-100 ⋅, dimensional pixel of methods and claims, in accordance with one or more embodiments of the invention.

146. The method of what is claimed (2), #⋅146 ⋅ unit-utility, (Source Output). An apparatus utility,
1; where, comprising the steps of in-part, bounding nodes of eight children centered with the unit-utility-47 ⋅,
2; wherein; facilitating the method processing of the image acquired, the method as set forth in claimed (1), #⋅15 ⋅ unit-utility, further comprising the method as set forth in claimed (2), #⋅146 ⋅ unit-utility, second part of FIG. 2 illustration (Input), implemented at least in part by a computing device, an application comprising instructions to a method and means unit-utility-function-110 ⋅; (Output).
3; wherein; in a preferred embodiment, computing of predictive and adaptive techniques of an “information processing system apparatus”, processing information and performing calculations of the programme to perform sequences of mathematical and logical operations, the method comprising of receiving a list of code segments, of an application comprising instructions for: —generating the bounding nodes of eight children centered with the unit-utility-47 ⋅.

147. further comprising the unit-utility-147 ⋅; as, —[inference-75 ⋅, condition non-defined]

148. wherein; furthering claimed (2), #⋅146 ⋅, the unit-utility-148 ⋅; —[apparatus novice, upLoad-Driver-138 ⋅]-148 ⋅; [semantics-68 ⋅; phrase-71 ⋅; collectivity-73 ⋅; semantics-68 ⋅; phrase-71 ⋅]—
1; wherein further comprising; hereinafter, the subsequent part of this document, statement or matter adhering to Computing—development of software achieve virtual object in a digital environment of specified formats as well as determine the arrangement of (data) for storage and display (in computer science) as related to drawings computability, include third party format as/like (UML), Unified Modeling Language, executable—FIG. 1—(Source Input), induced to FIG. 2—(Source Output),
2; wherein further comprising; and adhering to Computing—artifact-70 ⋅; (software development), —execute-Driver-117 ⋅; of novice architectures and methods securing a (Source Input), newPlaneXsphere-101 ⋅; equates dpixel-quadrant-99 ⋅; (Source Output), embodiment of the invention is specific oriented, using part or all the, verbiage intent ⋅define, compliments the artifact-70 ⋅; (software development),
1 . . . wherein further comprising; of novice architectures and methods securing the apparatus novice, dpix-utility Driver-112 ⋅; in relation to surroundings or circumstances, of the venue, dpix-93 ⋅;
3; wherein further comprising; the unit-utilities-#steps with outputting the dimensional pixel, in accordance with one or more embodiments of the invention.

149. The method of, what is claimed (3), #⋅149 ⋅ unit-utility, (analogous Output). An apparatus utility,
1; wherein; facilitating the method processing of the image acquired, the method as set forth in claimed (2), #⋅146 ⋅ unit-utility, generating the bounding nodes of eight children centered with the unit-utility-47 ⋅, and further comprising the method as set forth in claimed (3), #⋅149 ⋅ unit-utility, the third part of FIG. 3 illustration (Output), implemented at least in part by a computing device, an application comprising instructions to a method and means unit-utility-function-110 ⋅, comprising of receiving a list of code segments, for outputting the holomorphic-100 ⋅, dimensional pixel.
2; wherein; implement graphic Driver-116 ⋅, display-output, the dimensional pixel in accordance with one or more embodiments of the invention.

150. wherein; furthering claimed (3), #⋅149 ⋅, the method of unit-utility-150 ⋅; the Method (Process) Embodiments with facilitating the processing of the captured image as comprised, (analogous);

151. as, (Source Input); capture-input-119 ⋅;

152. as, (Source Output); doppler-49 ⋅; shift-50 ⋅;

153. as, (analogous Output); graphic Driver-116 ⋅;

154. as, inclusive with Exclusive Proprietary Property or/and Proprietary Privilege of/as the holomorphic-100 ⋅, dimensional pixel of methods, means and claims of unit-utility-150 ⋅; that link with the in-part here; (154: 1-3),
1; wherein; inclusive to the ‘Founder’ the Inventor, as per “spherical-56 ⋅, “infinity-36 ⋅ ( [symbol] )-37 ⋅ infimum-38 ⋅”/“mark-48 ⋅ doppler-49 ⋅ shift-50 ⋅”, dpix-93 ⋅, dpixel value-94 ⋅ plane with a zenith and nadir divided by a horizon line.”
1 . . . where; is NOT composed using a graphic dimensional value program as CAD, 3D, or AR (Augmented Reality), VR (Virtual Reality) and/or grid in 3-dimensional methods or pixel maps of patterns, (suggestive as scanned),
2; wherein; in contrast, the apparatus novice unit-utility takes a pixel value^{ref}-94 ⋅ referent and returns a dpixel value-94 ⋅ of/as the holomorphic-100 ⋅, dimensional pixel of methods, as a sphere-55 ⋅—orb-like-39 ⋅,
“infinity-36 ⋅ ( [symbol] )-37 ⋅ infimum-38 ⋅”, related to “the viewing/display optic”,
1 . . . where; while the novice unit-utility described in detail embodiments of the invention, it is not limited to such disclosed embodiments but may be modified to incorporate any number of variations, alterations, substitutions or equivalent arrangements not heretofore described,
3; wherein; but which are commensurate with the spirit and scope of the invention,
